(19) United States
(12) Patent Application Publication
(10) Pub. No.: US 2012/0221678 A1
(43) Pub. Date: Aug. 30, 2012

(54) COMPUTER-READABLE RECORDING MEDIUM STORING TRANSMISSION CONTROL PROGRAM, COMMUNICATION DEVICE AND TRANSMISSION CONTROL METHOD

(75) Inventor: Ryuta TANAKA, Kawasaki (JP)

(73) Assignee: Fujitsu Limited, Kawasaki-shi (JP)

(21) Appl. No.: 13/398,303

(22) Filed: Feb. 16, 2012

(30) Foreign Application Priority Data
Feb. 24, 2011 (JP) 2011-038973

(51) Int. Cl. G06F 15/16

(52) U.S. Cl. 709/217

(57) ABSTRACT

A computer-readable medium storing a program causing a computer to execute a process, the program includes, receiving a first request for requesting transmission of particular information from a request node belonging to a logical network to which the computer belongs, directly without depending on the topology of the logical network, or through one or more other nodes on a path that comes into a node equivalent to the computer in the topology of the logical network; selecting one or more responsible nodes relating to transmission of the particular information; correlating partial particular information that is a portion or all portions of the particular information with each of the responsible nodes; transmitting, in the event that the computer has been selected as the responsible node; and transmitting, in the event that there is a responsible child node selected as the responsible node of the one or more child nodes.

### CROSS-REFERENCE TO RELATED APPLICATION

This application is based upon and claims the benefit of priority of the prior Japanese Patent Application No. 2011-38973, filed on Feb. 24, 2011, the entire contents of which are incorporated herein by reference.

### FIELD

The embodiments to be disclosed here relates to communication control technology.

### BACKGROUND

With regard to network communication, various studies have been performed from viewpoints such as “how to handle loss of data”, “how to distribute load within a network”, and so forth. For example, as for loss of data, Forward Error Correction (FEC), and Automatic repeat-request (ARQ) have been familiar. FEC is a technique wherein loss data is restored from successfully received data (specifically including successfully received data and pre-appended redundant data of data originally transmitted) by a predetermined calculation. Also, ARQ is a technique for obtaining loss data by retransmission.

Also, network communication is constrained due to available bandwidth. If too much data is transmitted as to available bandwidth, concentration in load, occurrence of congestion, loss of data, further traffic occurrence for retransmission, and so forth may occur. Therefore, it is desirable for a communication system to take available bandwidth into consideration.

For example, communication of contents according to a method disclosed in PCT Japanese Translation Patent Publication No. 2004-516693 typically includes to automatically determine available bandwidth between the reception side and the supply side. Based on determined available bandwidth, content to be communicated between the reception side and the supply side is selected. Next, the content is communicated between the supply side and the reception side. The available bandwidth may automatically be determined using at least one-time repetition including transmitting predetermined amount of data to the reception side. Time used for receiving predetermined amount of data at the reception side is monitored, and available bandwidth is calculated based on the predetermined amount of data, and time used for receiving data by the reception side.

### SUMMARY

In accordance with an aspect of the embodiments, a computer-readable medium storing a program causing a computer to execute a process, the program includes, receiving a first request for requesting transmission of particular information from a request node belonging to a logical network to which the computer belongs, directly without depending on the topology of the logical network, or through one or more other nodes on a path that comes into a node equivalent to the computer in the topology of the logical network; selecting one or more responsible nodes relating to transmission of the particular information by prioritizing out of one or more child nodes logically connected to the computer by an edge that comes out from the node equivalent to the computer in the topology of the logical network, and the computer, the one or more child nodes over the computer; correlating partial particular information that is a portion or all portions of the particular information with each of the responsible nodes; transmitting, in the event that the computer has been selected as the responsible node, the partial particular information correlated with the computer to the request node; and transmitting, in the event that there is a responsible child node selected as the responsible node of the one or more child nodes, a second request for requesting transmission of the partial particular information correlated with the responsible child node to the request node, to the responsible child node.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

These and/or other aspects and advantages will become apparent and more readily appreciated from the following description of the embodiments, taken in conjunction with the accompanying drawing of which:

FIG. 1 is a diagram illustrating an example of retransmission control for realizing load distribution;

FIG. 2 is a diagram illustrating the topology of the logical network in FIG. 1;

FIG. 3 is a diagram illustrating an example of a physical network;

FIG. 4 is a hardware configuration diagram of a computer;

FIG. 5 is a block configuration diagram of a communication device;

FIG. 6 is a flowchart of processing that a management server executes with reception of a control packet as a trigger;

FIG. 7 is a diagram indicating an example of node management information that the management server holds;

FIG. 8 is a diagram indicating detection and notification of change in transmittable total bandwidth;

FIG. 9 is a diagram indicating an example of node information;

FIG. 10 is a flowchart of processing that the communication device executes with reception of a control packet other than a retransmission request as a trigger;

FIG. 11 is a flowchart of processing to be executed with reception of a data packet as a trigger;

FIG. 12 is a diagram indicating an example of a retransmission request packet;

FIG. 13 is a diagram indicating a model of buffering and a retransmission deadline;

FIG. 14 is a flowchart of processing for calculating a retransmission deadline;

FIG. 15 is a diagram schematically illustrating a specific example of retransmission control;

FIG. 16 is a flowchart (first half) of processing that the communication device executes with reception of a retransmission request as a trigger;

FIG. 17 is a flowchart (second half) of processing that the communication device executes with reception of a retransmission request as a trigger;

FIG. 18 is a diagram for describing an example wherein whether or not a constraint condition regarding an acquisition deadline is satisfied is determined using a first approximate model;

FIG. 19 is a diagram for describing an example wherein whether or not a constraint condition regarding an acquisition deadline is satisfied is determined using a second approximate model;

FIG. 20 is a flowchart (first half) of processing that the communication device executes with reception of a retransmission request as a trigger with another embodiment;

FIG. 21 is a flowchart (second half) of processing that the communication device executes with reception of a retransmission request as a trigger with another embodiment;

FIG. 22 is a diagram exemplifying transmission of a data packet assigned according to a bit rate;

FIG. 23 is a diagram illustrating an example of a mesh-type topology logical network.

### DESCRIPTION OF EMBODIMENTS

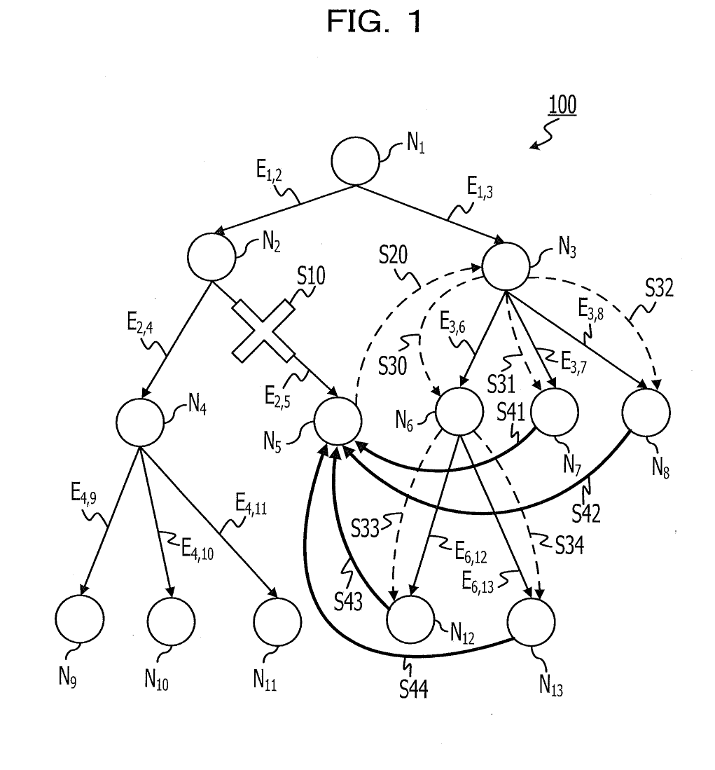

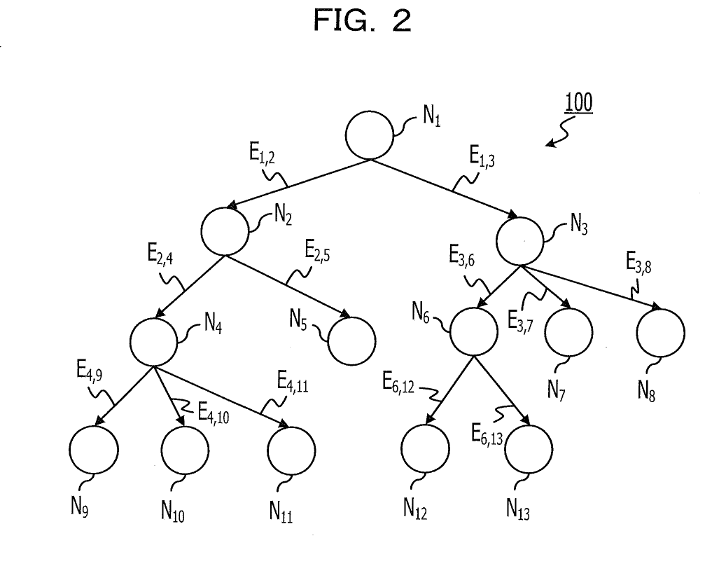

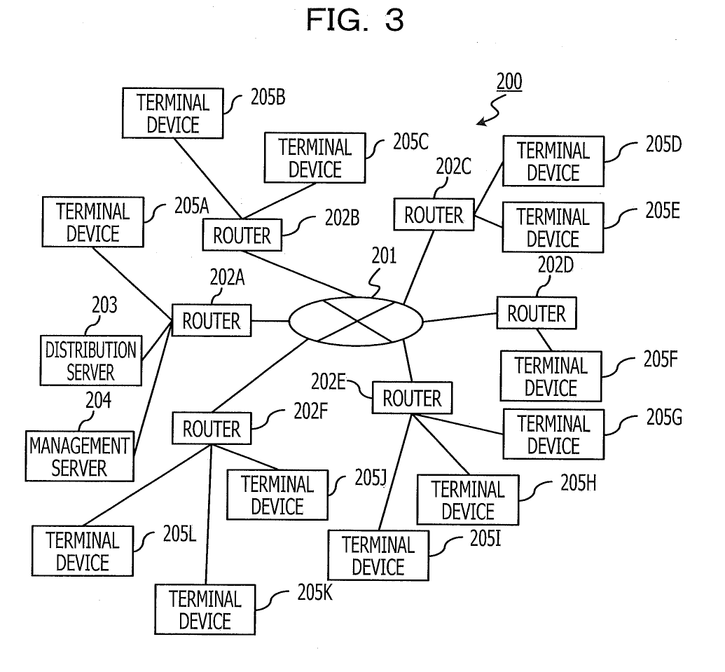

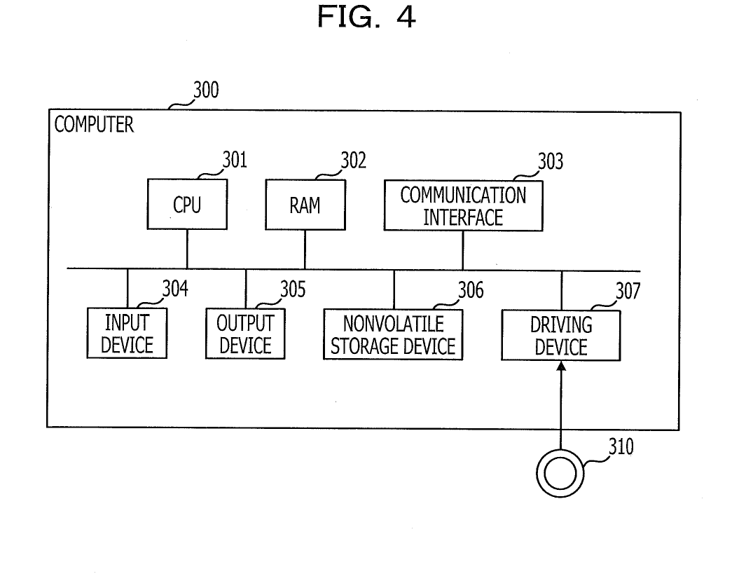

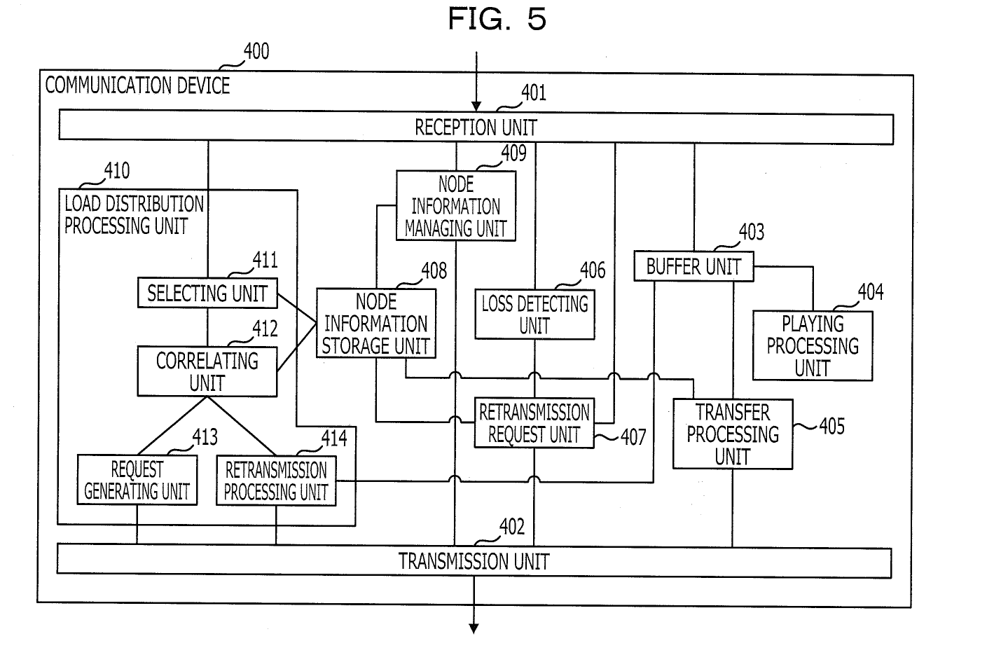

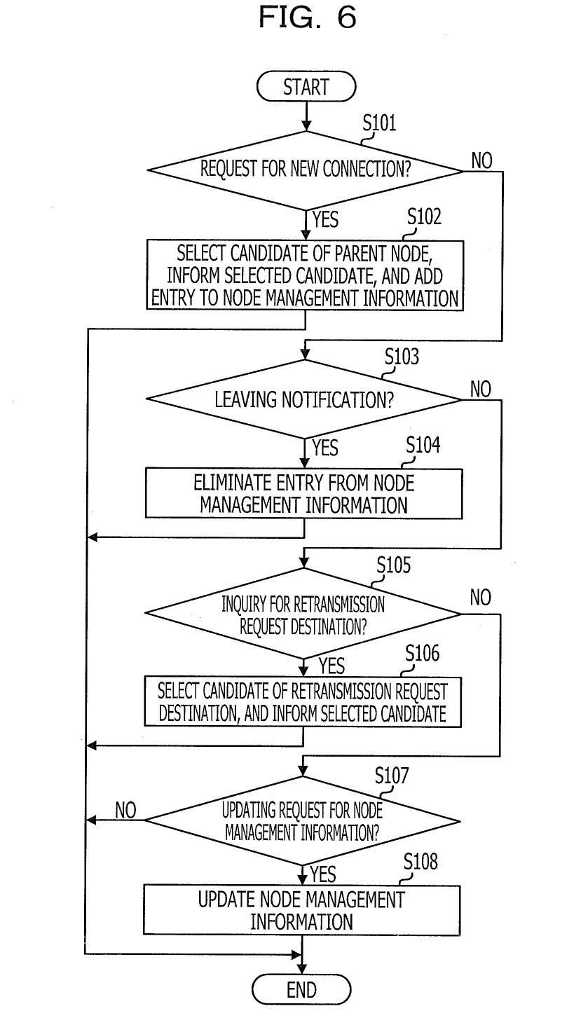

First, an embodiment relating to load distribution in a peer-to-peer (P2P) type data distribution system will be described with reference to FIG. 1 through FIG. 19. Note that FIG. 1 is a diagram for describing overview, FIG. 2 and FIG. 3 are diagrams illustrating an example of a network, FIG. 4 and FIG. 5 are diagrams illustrating the configuration of a device, and FIG. 6 through FIG. 19 are diagrams for describing the contents of detailed processing, and information to be used for the processing.

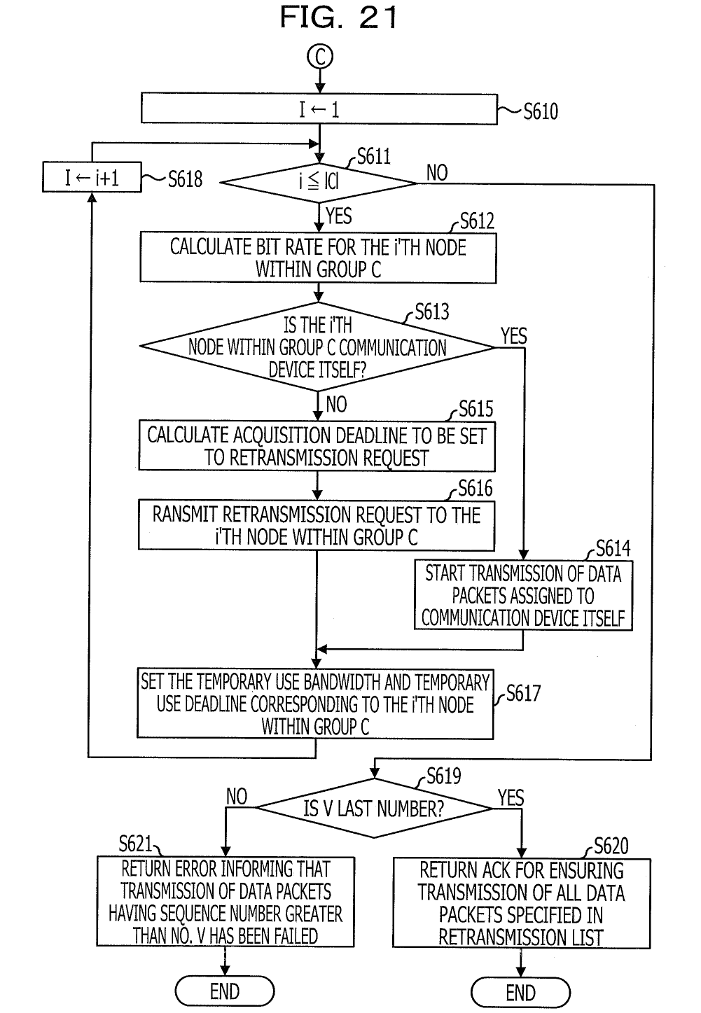

Thereafter, other embodiments and modifications will be described in order with reference to FIG. 21 through FIG. 23. Various modifications may be combinable as appropriate.

Now, FIG. 1 is a diagram illustrating an example of retransmission control for realizing load distribution. Also, FIG. 2 is a diagram illustrating the topology of the logical network in FIG. 1.

The present embodiment may be applied to the logical networks of various topologies, but for convenience of description, a specific logical network 100 is illustrated in FIG. 1 and FIG. 2 as an example. As shown in FIG. 1 and FIG. 2, the logical network 100 is a tree-type network including nodes N₁ through N₁₃. Also, each of the nodes N₁ through N₁₃ is a computer.

The logical network 100 is specifically a logical network built as a distribution tree in application layer multicast (ALM). ALM is also referred to as overlay multicast. That is to say, the logical network 100 is an example of an overlay network.

With an existing client server type data distribution system, in accordance with the number of client terminal devices for receiving data increasing, load is placed on a distribution server in proportion to the number of client terminal devices. Therefore, with a client server type large scale system, measures are necessary such as providing multiple distribution servers, reinforcing a network infrastructure, or the like, which leads to increase in distribution costs.

Therefore, application of P2P technology to data distribution has recently attracted attention. The logical network 100 in FIG. 1 and FIG. 2 is built as a distribution tree in the P2P type data distribution system.

With the P2P type data distribution system (e.g., distribution system for streaming data), a terminal device which has received data relays the received data to another terminal device. Accordingly, the data is relay-distributed within the network, and accordingly, large scale simultaneous multiple address distribution may also be performed by the P2P type data distribution system. Further, the P2P type data distribution system has a great advantage wherein increase in the distribution load of the distribution server is relatively moderate or mostly suppressed as to increase in the number of terminal devices.

There are various types of P2P type data distribution systems, any of which is common in that data distribution on a physical network but on a logical network where a link between terminal devices (i.e., between peers) is formed. The present embodiment is suitable for retransmission control in a P2P type data distribution system.

As shown in FIG. 1 and FIG. 2, the topology of the logical network 100 may be represented as a graph (more specifically, directed acyclic graph (DAG)). The directions of the edges in a graph indicating the topology of the logical network 100 indicate the directions where contents are distributed.

Specifically, the logical network 100 includes 12 edges as shown in the following (A-1) through (A-12). The edges are, in other words, communication links for logically connecting between adjacent two nodes.

(A-1) edge E_{1, 2} from Node N₁ to Node N₂

(A-2) edge E_{1, 3} from Node N₁ to Node N₃

(A-3) edge E_{2, 4} from Node N₂ to Node N₄

(A-4) edge E_{2, 5} from Node N₂ to Node N₅

(A-5) edge E_{3, 6} from Node N₃ to Node N₆

(A-6) edge E_{3, 7} from Node N₃ to Node N₇

(A-7) edge E_{3, 8} from Node N₃ to Node N₈

(A-8) edge E_{4, 9} from Node N₄ to Node N₉

(A-9) edge E_{4, 10} from Node N₄ to Node N₁₀

(A-10) edge E_{4, 11} from Node N₄ to Node N₁₁

(A-11) edge E_{6, 12} from Node N₆ to Node N₁₂

(A-12) edge E_{6, 13} from Node N₆ to Node N₁₃

As may be seen from the above (A-1) through (A-12), the Node N₁ of which the input degree is 0 is the root node of the distribution tree. Also, the Nodes N₅, and N₇ through N₁₃ of which the output degrees are 0 are leaf nodes. The other Nodes N2 trough N4, and N6 are nodes other than the root node and leaf nodes (hereafter, referred to as “relay nodes”).

Distribution of data (e.g., streaming data) is performed over the logical network 100. However, part of data may be lost depending on the states of the network. For example, a part of packets may be lost due to a cause such as congestion in a physical network, the failure of a router, or the like.

With the P2P type data distribution system, UDP (User Datagram Protocol) is frequently used as the transport layer protocol rather than TCP (Transmission Control Protocol). This is because the UDP excels in rapidity, and accordingly suitable for streaming of video, audio, and so forth where real time nature is considered to be important. Conversely speaking, the UDP is small in protocol overhead as compared to the TCP, but instead, does not have an error correction function such as that of the TCP.

Therefore, in the event of the UDP being used, countermeasures for error correction (specifically, restoration of a loss packet) are provided by a mechanism other than the transport layer protocol. Specific examples of the countermeasures are the above FEC and ARQ. However, the ARQ is used together in a practical system even in a case where the FEC is used.

Redundant information for error correction (e.g., FEC packet) may be added to data to be distributed, or error correction using redundant information (i.e., restoration of a loss packet) may be performed. However, a packet loss rate whereby error correction may be performed using an FEC packet has an upper limit according to a percentage where FEC packets are inserted.

Accordingly, when the packet loss rate is high, even if an FEC packet has been used, a part of loss packets may not be restored. In this case, in order to obtain the loss data, retransmission of data is necessary. Accordingly, with many practical systems, the ARQ is employed.

With the following description, for simplification of description, description regarding the FEC will be omitted, description will be made simply assuming that retransmission is requested in the event that data is lost. However, it goes without saying that an embodiment where the FEC is used may also be performed. That is to say, even when a trigger where retransmission is requested is such as loss of data, detection of a situation where there is data that has not been restored even with the FEC, retransmission control according to the present embodiment may be applied to.

FIG. 1 also illustrates overview of the retransmission control according to the present embodiment. In FIG. 1, a thin solid-line arrow indicates normal data distribution, a dashed dotted arrow indicates a retransmission request, and heavy solid-line arrow indicates data transmission to be performed according to a retransmission request.

For example, the Node N₁ transmits data to the Nodes N₂ and N₃, and the Node N₂ transmits data to the Nodes N₄ and N₅. However, as shown in Operation S10, at least part of data may be lost on the edge E_{2, 5} from the Node N₂ to Node N₅ due to some sort of a cause such as occurrence of congestion. The Node N₅ may detect loss of data, for example, with a sequence number as a clue, and also recognize which portion of the data has been lost (i.e., what number to what number of data packets have been lost out of a series of data packets).

With Operation S20, the node N₅ then requests transmission of the lost data. Though detailed description will be made later, which node the Node N₅ requests from is optional according to embodiments. With the example in FIG. 1, the Node N₅ requests transmission from the Node N₃.

Hereafter, information to be requested for transmission will also be referred to as “particular information”. The particular information is specifically, as described above, of distribution information to be distributed within the logical network 100, a portion lost at the edge E_{2, 5}. Also, a node for requesting transmission of the particular information (Node N₅ in the example in FIG. 1) will also be referred to as “request node”.

The request transmitted from the Node N₅ in the Operation S20 as described above is received at the Node N₃. Here, with the topology of the logical network 100, for the Node N₃, the Node N₅ is not an adjacent node connected to the Node N₃ itself by the edge. That is to say, a request for transmission of the particular information may be received from a node other than adjacent nodes directly without passing through the topology of the logical network 100.

Next, the Node N₃ which has received the request for transmission of the particular information selects one or more nodes (hereafter, referred to as “responsible node”) relating to transmission of the particular information. Note that the Node N₃ selects one or more responsible nodes out of the child node of the Node N₃ and the Node N₃ itself by prioritizing the child node over the Node N₃ itself.

The responsible nodes may be involved in transmission of the particular information by actually transmitting part or all of the particular information. Also, each of the responsible nodes may be involved in transmission of the particular information by requesting transmission of part or all of the particular information to the child node of this responsible node. Each of the above selected one or more responsible nodes involves in transmission of the particular information, and accordingly, transmission of the entire particular information is ensured. Accordingly, if we say from a certain viewpoint that each of the responsible nodes is also a node to be selected for ensuring transmission of the particular information.

With a directed graph indicating the topology of the logical network 100, when there is an edge E_{j, k} from a certain Node Nⱼ to another Node Nₖ, the Node Nₖ is the child node of the Node and the Node Nⱼ is the parent node of the Node Nₖ. With the example in FIG. 1, the Node N₃ has three child Nodes N₆ through N₈.

Accordingly, the Node N₃ selects the child Nodes N₆ through N₈ as responsible nodes by prioritizing over the Node N₃ itself. That is to say, first, the Node N₃ selects the child Nodes N₆ through N₈ as responsible nodes. Thereafter, the Node N₃ determines whether or not it is sufficient with only the child nodes selected as the responsible nodes to ensure transmission of the entire particular information. In the event that the determination result as “insufficient” has been obtained, the Node N₃ selects the Node N₃ itself as a responsible node.

Note that, according to a situation such as the amount of the particular information, the Node N₃ may select only a part of the child Nodes N₆ through N₈ (e.g., only the Node N₆) as responsible nodes. Conversely, according to a situation, the Node N₃ may select the Node N₃ itself in addition to all of the child Nodes N₆ through N₈.

Also, though detailed description will be made later, the Node N₃ may take a certain kind of constraint condition into consideration at the time of selection of a responsible node. Consequently, the Node N₃ may select a part of the child nodes and the Node N₃ itself as responsible nodes depending on constraint conditions.

For example, first, the Node N₃ determines based on a constraint condition whether or not the child Nodes N₆ through N₈ may be selected, and actually selects a selectable child node as a responsible node. The Node N₃ then determines whether or not it is sufficient with only the child nodes selected as the responsible nodes to ensure transmission of the entire particular information. In the event that it is insufficient with only the child nodes selected as the responsible nodes to ensure transmission of the entire particular information, the Node N₃ may further select the Node N₃ as a responsible node.

A node which has received the request may select this node itself as a responsible node, for example, such as a case where the amount of the particular information is great, a case where there is no child node, a case where there are child nodes but the number thereof is a few, or the like.

FIG. 1 illustrates a case where the Node N₃ has selected the three child Nodes N₆ through N₈ as responsible nodes, as an example. Note that, hereafter, a child node selected as a responsible node will also be referred to as “responsible child node”.

The Node N₃ not only selects a responsible node but also correlates each of the responsible nodes with partial particular information that is part or all of the particular information. That is to say, the Node N₃ assigns the partial particular information to each of the one or more responsible nodes.

For example, let us say that the particular information is specifically 20 packets of which the sequence numbers are No. 201 to No. 220. For example, the Node N₃ may correlate the Node N₆ with 10 packets of which the sequence numbers are No. 201 to No. 210 as partial particular information. That is to say, the N₃ may ensure the N₆ to transmit the 10 packets to the request Node N₅. Similarly, the Node N₃ may correlate the Node N₇ with 5 packets of which the sequence numbers are No. 211 to No. 215 as partial particular information, and correlate the Node N₈ with 5 packets of which the sequence numbers are No. 216 to No. 220 as partial particular information.

In the event that there is a responsible child node, the Node N₃ transmits a request for requesting transmission of the partial particular information correlated with this responsible child node from the request Node N₅, to this responsible child node.

That is to say, with Operation S30, the Node N₃ transmits a request for requesting transmission of the partial particular information correlated with the Node N₆ (e.g., 10 packets of which the sequence numbers are No. 201 to No. 210 in the above example) of the particular information from the Node N₅, to the Node N₆.

Similarly, with Operation S31, the Node N₃ transmits a request for requesting transmission of the partial particular information correlated with the Node N₇ (e.g., 5 packets of which the sequence numbers are No. 211 to No. 215 in the above example) of the particular information from the Node N₅, to the Node N₇.

Further, with Operation S32, the Node N₃ transmits a request for requesting transmission of the partial particular information correlated with the Node N₈ (e.g., 5 packets of which the sequence numbers are No. 216 to No. 220 in the above example) of the particular information from the Node N₅ to the Node N₈.

In other words, the Node N₃ transfers the request received from the request Node N₅ to the child Nodes N₆ through N₈ while rewriting a portion of the contents of the request (specifically, instructions to be transmitted to the Node N₅). Note that the execution sequence of the Operations S30 through S32 may optionally be switched.

Each of the Nodes N₆ through N₈ receives the request, and performs operation similar to the Node N₃ in response to reception of the request. Specifically, the operation is as follows.

For the Node N₆, particular information of which the transmission to the Node N₅ is requested is information specified from the Node N₃. For example, with the above example, the particular information for the Node N₃ is 20 packets of which the sequence numbers are No. 201 to No. 220, but the particular information for the Node N₆ is 10 packets of No. 201 to No. 210 of the sequence numbers thereof.

Also, the Node N₆ does not receive a request directly from the request node N₅ regardless of the topology of the logical network 100 such as the Node N₃. The Node N₆ receives the request from the request Node N₅ via another or other more nodes over a (incoming) path that comes into the Node N₆ in the topology of the logical network 100. Specifically, the Node N₆ receives the request from the request Node N₅ via the Node N₃ over a path from the Node N₃ to the Node N₆ (i.e., path made up only the edge E_{3, 6}).

However, whichever node the direct transmission source of a request is, any of nodes which have received the request selects a responsible node as with the Node N₃. For example, with the example in FIG. 1, the Node N₆ has the two child Nodes N₁₂ and N₁₃, and accordingly, the Node N₆ selects a responsible node by prioritizing the child Nodes N₁₂ and N₁₃ over the Node N₆ itself. As a result thereof, for example, both of the Nodes N₁₂ and N₁₃ have been selected as responsible nodes.

Also, the Node N₆ correlates partial particular information that is part or all of the particular information with the responsible nodes. For example, as described above, let us say that the particular information for the Node N₆ is 10 packets of which the sequence numbers are No. 201 to No. 210. In this case, the Node N₆ may correlate 4 packets of which the sequence numbers are No. 201 to No. 204 with the Node N₁₂ as partial particular information, and correlate 6 packets of which the sequence numbers are No. 205 to No. 210 with the Node N₁₃ as partial particular information.

With Operation S33, the Node N₆ transmits a request for requesting transmission of the partial particular information correlated with the Node N₁₂ of the particular information from the Node N₅, to the Node N₁₂. Similarly, with Operation S34, the Node N₆ transmits a request for requesting transmission of the partial particular information correlated with the Node N₁₃ of the particular information from the Node N₅, to the Node N₁₃. Note that the execution sequence of the Operations S33 and S34 may be switchable.

Incidentally, the Node N₇ which has received the request from the Node N₃ in the above Operation S31 selects a responsible node in the same way as with the Node N₃. However, while the Node N₃ has child nodes, the Node N₇ has no child nodes. That is to say, there are no nodes to be selected as responsible nodes in a manner prioritized over the Node N₇ itself, and consequently, the Node N₇ selects the Node N₇ itself as the only responsible node.

Accordingly, the Node N₇ consequently correlates all of the particular information for the Node N₇ (5 packets of which the sequence numbers are No. 211 to No. 215 in the above example) with the Node N₇ itself that is a responsible node as partial particular information. As with the Node N₇, a node which has selected itself as a responsible node transmits the partial particular information correlated with itself of the particular information to the request node. That is to say, with Operation S41, the Node N₇ transmits the particular information to the Node N₅.

Note that, as described above, the logical network 100 is an overlay network built as the distribution tree of the ALM. Accordingly, distribution information is also distributed to the Node N₇. That is to say, the particular information assigned to the Node N₇ by the Node N₃ is part of the distribution information distributed to and stored in the Node N₇. Accordingly, the Node N₇ may read out the particular information assigned to the Node N₇ by the Node N₃ from a storage device provided to the Node N₇, and transmit to the Node N₅.

Similarly, with Operation S42, the Node N₈ transmits the particular information for the Node N₈ (5 packets of which the sequence numbers are No. 216 to No. 220 in the above example) to the Node N₅. Note that the Operations S41 and S42 may be executed in parallel. Also, the Operations S41 and S42 may be executed in parallel with the Operations S33 and S34.

Further, similarly, with Operation S43, the Node N₁₂ which is a leaf node similar to the Nodes N₇ and N₈ also transmits the particular information for the Node N₁₂ (4 packets of which the sequence numbers are No. 201 to No. 204 in the above example) to the Node N₅. Also, similarly, with Operation S44, the Node N₁₃ also transmits the particular information for the Node N₁₃ (6 packets of which the sequence numbers are No. 205 to No. 210 in the above example) to the Node N₅.

Note that the Operations S43 and S44 may be executed in parallel. Also, the Operations S43 and S44 may be executed in parallel with the Operations S41 and S42.

As described above, the request Node N₅ may receive the particular information of which the transmission has been requested. Note that, with the example in FIG. 1, a request node receives part of the particular information of which the transmission has been requested at a time. However, a request node may receive all of the particular information of which the transmission has been requested from one node depending on situations such as the topology of the logical network, the amount of the particular information, and so forth.

Also, the retransmission control as described above may prevent deterioration in load bias within the logical network 100, and realize suitable load distribution. This reason is as follows.

With the logical network 100 built as the distribution tree of the ALM, the root node generates or obtains distribution information (e.g., streaming data), and distributes distribution information. Also, a relay node not only receives and plays the distribution information but also transfers the distribution information. On the other hand, a leaf node simply receives and plays the distribution information. Accordingly, in general, the load of a leaf node is low as compared to the root node and a relay node.

Also, even in the event of comparing between relay nodes, a relay node closer to the root node may be higher in load than a relay node distant from the root node depending on construction algorithms of the distribution tree of the ALM. Note that, with the following description, the distance from the root node is the length of a path from the root node (i.e., the number of edges included in a path),

For example, with a certain kind of a construction algorithm, in order to reduce relay delay, the closer to the root node a node is, the more prioritized manner this node is selected as the parent node of a new node to be joined to the distribution tree. As a result thereof, with the built distribution tree, there is a tendency wherein the closer to the root node a relay node is, the more this relay node has child nodes as compared to between relay nodes.

The more child nodes a relay node has, the greater the load to transfer of the distribution information is. Accordingly, a relay node closer to the root node may have a greater load than the load of a relay node distant from the root node, depending on built algorithms for a distribution tree.

That is to say, load due to processing other than retransmission is biased to the root node and a relay node within the logical network 100, and the load of a leaf node is low. Also, as compared to between relay nodes, load due to processing other than retransmission is apt to be biased toward a relay node relatively closer to the root node depending on built algorithms for a distribution tree.

Accordingly, in order to suitably distribute comprehensive load regarding retransmission processing and processing other than retransmission, load caused due to retransmission processing is desired to be assigned so as to cancel out load bias due to processing other than retransmission. The retransmission control according to the present embodiment as shown in FIG. 1 then realizes such an assignment.

This is because if a node which has been requested for transmission of the particular information to a request node has a child node, this node preferentially selects the child node as a responsible node. Processing for preferentially selecting a child node as a responsible node is then recursively performed within the logical network 100, and accordingly, the following (B-1) and (B-2) hold.

(B-1) Leaf nodes are apt to be nodes for actually performing transmission of the particular information to a request node as compared to the root node and relay nodes.

(B-2) A node distant from the root node is apt to be a node for actually performing transmission of the particular information to a request node as compared to a node closer to the root node.

Also, according to the above (B-1) and (B-2), a node of which the load due to processing other than retransmission is low is apt to be a node for actually performing transmission of the particular information to a request node as compared to a node of which the load due to processing other than retransmission is high. Accordingly, the load due to retransmission processing is assigned so as to cancel out load bias due to processing other than retransmission.

That is to say, the retransmission control according to the present embodiment may prevent deterioration in load bias, and realize suitable load distribution within the logical network 100. Also, the advantage of the present embodiment as described above is more apparent as compared to the following two comparative examples.

With the first comparative example, a node which has detected loss of data simply requests retransmission of the data from the parent node. The parent node which has been requested for retransmission then retransmits the data by itself without transferring a retransmission request to another node.

That is to say, with the first comparative example, only the root node and relay nodes may be requested for retransmission. As described above, the root node and relay nodes are high in load due to processing other than retransmission as compared to leaf nodes. Accordingly, with the first comparative example, load is increasingly concentrated on the root and relay nodes which have great load.

If a packet loss ratio is extremely high, or packet loss consecutively massively occurs, it goes without saying that load of retransmission also increases. Depending on circumstances, only load of retransmission may reach unignorable amount.

Also, according to the present embodiment as shown in FIG. 1, multiple nodes transmit a portion of the particular information at a time. Accordingly, even if the amount of the particular information is great, the transmission load of each of the nodes is not so high. However, with the first comparative example, one node (i.e., the parent node of a node which has detected packet loss) transmits the entirety of data that has been requested for retransmission. Accordingly, when the amount of data that has been requested for retransmission is great, the transmission load of the parent node extremely becomes high.

With the first comparative example, great load due to retransmission is concentrated on the root node and relay nodes which are high in load due to processing other than retransmission as described above. Accordingly, the present embodiment is apparently excellent as compared to the first comparative example in the light of securing fairness of processing load between nodes, and in the light of improving processing efficiency as the whole of the network by load distribution.

Also, in order to conquer the faults of the comparative example, with the second comparative example, a certain management server intensively manages the topology of the logical network. Accordingly, the management server can realize leaf nodes that perform no relay, and accordingly inform a leaf node selected as appropriate as a retransmission request destination.

For example, when requesting retransmission of data (or beforehand), each of the nodes inquires of the management node a retransmission request destination. The management node which has received the inquiry then replies with a leaf node selected as appropriate as a retransmission request destination.

Load of retransmission is then applied to a leaf node having less load due to processing other than retransmission. Accordingly, as compared to the first comparative example, the second comparative example excels in load distribution between nodes. However, this second comparative example has a default such as lack of scalability as to the number of nodes.

Specifically, the greater the number of nodes is, the more the load of the management server for recognizing the topology, and also replying to inquiry of a retransmission request destination increases. Also, with the second comparative example, the management server may become SPoF (Single Point of Failure).

On the other hand, with the present embodiment, a later-described management server 204 in FIG. 3 may be used, but the management server 204 does not have to recognize the topology of the entire logical network 100. The management server 204 should simply select any one out of the nodes included in the logical network 100 (e.g., random one) as a retransmission request destination.

Accordingly, the load of the management server 204 according to the present embodiment is apparently lighter than the load of the management server according to the second comparative example which needs recognition of topology. Accordingly, the management server 204 according to the present embodiment does not readily become SPoF as compared to the management server according to the second comparative example.

Also, with the present embodiment, multiple nodes transmit part of the particular information at a time depending on situations. Accordingly, even if the amount of the particular information is great, the transmission load of each of the nodes is not so high. However, with the second comparative example, one node (i.e., the leaf node selected by the management node) transmits the entirety of data that has been requested for retransmission. Accordingly, when the amount of data that has been requested for retransmission is great, the selected leaf node may fall into an overloaded state.

Further, with the present embodiment, a node informed from the management server 204 as a retransmission request destination may be the root node, or may be a relay node relatively closer to the root node. In spite thereof, according to the present embodiment, as described regarding FIG. 1, load for actually transmitting requested data is preferentially applied to a node more distant from the root node. Also, in the event that the load is great, with the present embodiment, the load is distributed into multiple nodes. Therefore, according to the present embodiment, there may be realized both of suitable load distribution, and improvement in scalability by reducing the load of the management server 204 as compared to the second comparative example.

Also, though detailed description will be made later, the present embodiment may be modified so as not to use the management server 204 for recognizing a retransmission request destination. Such a modification further excels in scalability as compared to the second comparative example.

As described above, the retransmission control according to the present embodiment excels as compared to both of the first comparative example and second comparative example. Also, as may be apparent from description regarding FIG. 1, the retransmission control according to the present embodiment is autonomous distributed control, and accordingly, even in the event that a retransmission request frequently occurs, a particular node does not fall into a situation wherein the node becomes SPoF, and a retransmission request becomes overflow.

Incidentally, the logical network 100 shown in FIG. 1 and FIG. 2 differs from a physical network. Specifically, with the logical network 100, adjacent nodes which are directly connected by an edge may physically have long distance between both. Conversely, separated nodes within the logical network 100 may physically have short distance between both.

FIG. 3 is a diagram illustrating an example of a physical network. The logical network 100 shown in FIG. 1 and FIG. 2 may be, for example, an overlay network over the physical network 200 in FIG. 3.

The physical network 200 includes a core network 201, and routers 202A through 202F mutually connected via the core network 201. Also, the physical network 200 includes a distribution server 203, a management server 204, and terminal devices 205A through 205L.

As shown in FIG. 3, the distribution server 203, management server 204, and terminal device 205A are connected to the router 202A. Also, the terminal devices 205B and 205C are connected to the router 202B, and the terminal devices 205D and 205E are connected to the router 202C. The terminal device 205F is then connected to the router 202D, the terminal devices 205G through 205I are connected to the router 202E, and the terminal devices 205J through 205L are connected to the router 202F.

Note that, in FIG. 3, the routers and terminal devices are directly connected by cable. However, between the routers and terminal devices may be connected via a network device such as a switching hub, wireless LAN (Local Area Network) access point, or the like.

The distribution server 203 generates or obtains a content (e.g., streaming data) as distribution information to be distributed to the terminal devices 205A through 205L, and distributes this content. Also, the management server 204 is a server for managing nodes belonging to the distribution tree.

That is to say, FIG. 3 including the management server 204 illustrates an example of not a pure P2P system but a hybrid P2P system. However, it goes without saying that the present embodiment may be applied to a pure P2P (detailed description will be made later).

Also, with the example in FIG. 3, the distribution server 203 and management server 204 are separated, but one server may include both of the functions of the distribution server 203 and management server 204. Alternatively, there may be multiple management servers 204.

The terminal device 205A through 205L may be any computer as long as predetermined ALM application software has been installed into the computer. Specific examples of the terminal devices 205A through 205L include PCs (Personal Computers), work stations, STBs (Set Top Box) having a network communication function, smart phones, and tablet type terminals.

Description will be made below regarding a case where the logical network 100 in FIG. 1 and FIG. 2 is an overlay network over the physical network 200 in FIG. 3. In the event that the logical network 100 is an overlay network over the physical network 200, the distribution server 203 is equivalent to the root Node N₁ in the logical network 100. Also, the management server 204 is not included in the logical network 100 built as the distribution tree.

Which of the terminal devices 205A through 205L of the physical network 200 the Nodes N₂ through N₁₃ other than the root Node N₁ in the logical network 100 are equivalent to respectively varies depending on cases. Two examples of the correspondence relations between the logical network 100 and the physical network 200 will be shown below.

The first example of the correspondence relations between the logical network 100 and the physical network 200 is as the following (C-1) through (C-13).

(C-1) The Node N₁ is the distribution server 203.

(C-2) The Node N₂ is the terminal device 205L.

(C-3) The Node N₃ is the terminal device 205B.

(C-4) The Node N₄ is the terminal device 205K.

(C-5) The Node N₅ is the terminal device 205H.

(C-6) The Node N₆ is the terminal device 205C.

(C-7) The Node N₇ is the terminal device 205F.

(C-8) The Node N₈ is the terminal device 205G.

(C-9) The Node N₉ is the terminal device 205J.

(C-10) The Node N₁₀ is the terminal device 205A.

(C-11) The Node N₁₁ is the terminal device 205I.

(C-12) The Node N₁₂ is the terminal device 205D.

(C-13) The Node N₁₃ is the terminal device 205E.

With the first example shown in the above (C-1) through (C-13), examples of a cause where data loss occurs in the transmission from the Node N₂ to the Node N₅ as shown in Operation S10 in FIG. 1 include the following (D-1) through (D-3).

(D-1) Failure or congestion in the router 202F

(D-2) Failure or congestion over a route connecting the router 202F and router 202E within the core network 201

(D-3) Failure or congestion in the router 202E

If the Node N₅ simply requests retransmission from the parent Node N₂ itself as with the above first comparative example, the data lost due to the cause (D-1) or (D-2) is extremely low in expectancy of restoration. However, according to the retransmission control in FIG. 1, actual retransmission is performed from the terminal devices 205F, 205G, 205D, and 205E over the physical network 200 distant from the terminal device 205L equivalent to the parent Node N₂ over the logical network 100 of the Node N₅. Therefore, according to the retransmission control in FIG. 1, the Node N₅ may obtain the data lost due to the cause (D-1) or (D-2) in the Operation S10.

Note that, in the case of the cause (D-3), even if data has been retransmitted from which node (i.e., even if whatever has been performed as retransmission control), the Node N₅ (i.e., terminal device 205H) may not receive the retransmitted data with high risk. For example, the retransmission request itself from the Node N₅ may be lost at the router 202E with high risk. Or, even if the retransmission request has not been lost, and also data has been retransmitted from the Node N₇ (i.e., terminal device 205F) as with the Operation S41 in FIG. 1, the retransmitted data may be lost at the router 202E before reaching the Node N₅ with high risk.

Also, the second example of the correspondence relations between the logical network 100 and the physical network 200 is as the following (E-1) through (E-13).

(E-1) The Node N₁ is the distribution server 203.

(E-2) The Node N₂ is the terminal device 205D.

(E-3) The Node N₃ is the terminal device 205C.

(E-4) The Node N₄ is the terminal device 205J.

(E-5) The Node N₅ is the terminal device 205E.

(E-6) The Node N₆ is the terminal device 205B.

(E-7) The Node N₇ is the terminal device 205K.

(E-8) The Node N₈ is the terminal device 205I.

(E-9) The Node N₉ is the terminal device 205G.

(E-10) The Node N₁₀ is the terminal device 205A.

(E-11) The Node N₁₁ is the terminal device 205H.

(E-12) The Node N₁₂ is the terminal device 205L.

(E-13) The Node N₁₃ is the terminal device 205F.

With the second example shown in the above (E-1) through (E-13), the Nodes N2 and N5 are connected to the same router 202C. Accordingly, the cause of lost as with the Operation S10 in FIG. 1 is principally failure or congestion at the router 202C. In this case, as with the cause (D-3) in the above first example, even if data has been retransmitted from which node, the Node N₅ (i.e., terminal device 205E) may not successfully receive the retransmitted data with high risk.

As shown in the above first and second examples of correspondence relations, the retransmission control according to the present embodiment excels as compared to the retransmission control according to the first comparative example. Specifically, under a particular situation such that congestion or failure has occurred at a device closer to a request node over the physical network 200, expectancy is low even with the present embodiment and first comparative example wherein lost data may be obtained by retransmission, and accordingly, there is no difference depending on how to perform retransmission control. However, under another situation, while expectancy is extremely low with the first comparative example wherein lost data may be obtained by retransmission, expectancy is high with the present embodiment wherein lost data may be obtained by retransmission. Accordingly, the present embodiment excels even in respect of a recovery rate according to retransmission of lost data as compared to the first comparative example.

Incidentally, the distribution server 203, management server 204, and terminal devices 205A through 205L shown in FIG. 3 are specifically computers having a network communication function, and the computers include various types of hardware as shown in the hardware configuration diagram in FIG. 4, for example.

The computer 300 in FIG. 4 includes a CPU (Central Processing Unit) 301, RAM (Random Access Memory) 302, a communication interface 303, an input device 304, an output device 305, a nonvolatile storage device 306, and a driving device 307 of a portable storage medium 310. The units within the computer 300 are mutually connected by a bus 308.

The CPU 301 loads a program into the RAM 302, and executes the program while using the RAM 302 as a work area. The program may be stored in the nonvolatile storage device 306 beforehand. Or, the program may be downloaded from the network via the communication interface 303 and copied to the nonvolatile storage device 306.

Or, the program may be provided by being stored in the portable storage medium 310 and read by the driving device 307. The program read from the portable storage medium 310 by the driving device 307 may directly be loaded into the RAM 302, or temporarily copied into the nonvolatile storage device 306 and loaded from the nonvolatile storage device 306 to the RAM 302. As for the portable storage medium 310, optical discs such as CD (Compact Disc) or DVD (Digital Versatile Disk), magneto-optical disks, magnetic disks, nonvolatile semiconductor memory cards are available.

Also, the communication interface 303 is, for example, a cable LAN interface, a wireless LAN interface, or a combination thereof. The input device 304 is, for example, buttons, a keyboard, a pointing device such as a mouse or touch panel, a microphone, or a combination thereof. The output device 305 is, for example, a display, a speaker, or a combination thereof. The display may be a touch screen.

The nonvolatile storage device 306 is, for example, semiconductor memory such as ROM (Read Only Memory) or flash memory, a hard disk drive, or a combination thereof. Note that any of the RAM 302, nonvolatile storage device 306, and portable storage medium 310 is an example of a computer-readable storage medium. These computer-readable storage media are tangible storage media, and not transitory media such as signal carriers.

Incidentally, the terminal devices 205A through 205L in FIG. 3 having the hardware as shown in FIG. 4 are leaf nodes or relay nodes within the logical network 100. Any of the leaf nodes and relay nodes is a device for performing the retransmission control according to the present embodiment described with reference to FIG. 1. FIG. 5 is a block configuration diagram of a communication device used as a leaf node and a relay node of the logical network 100.

The communication device 400 in FIG. 5 includes a reception unit 401, a transmission unit 402, a buffer unit 403, a playing processing unit 404, a transfer processing unit 405, a loss detecting unit 406, a retransmission request unit 407, a node information storage unit 408, a node information managing unit 409, and a load distribution processing unit 410. Also, the load distribution processing unit 410 includes a selecting unit 411, a correlating unit 412. a request generating unit 413, and a retransmission processing unit 414.

The reception unit 401 receives packets from another device, and the transmission unit 402 transmits packets to another device. The reception unit 401 and transmission unit 402 are realized by the communication interface 303, for example. Note that, hereafter, a packet including a content to be distributed within the logical network 100 (i.e., distribution information) at the payload will be referred to as “data packet”, and a packet including a message for control will be referred to as “control packet”.

Also, the reception unit 401 outputs, according to the kind of the received packet, the packet (or the value of a part of fields included in the packet) as appropriate. A function for the reception unit 401 determining the type of the packet is realized by the CPU 301, for example.

The buffer unit 403 continues to hold the data packet received by the reception unit 401 for a certain period of time. The buffer unit 403 is realized by the RAM 302, nonvolatile storage device 306, or a combination thereof, for example.

The playing processing unit 404 plays a content using the data packets held by the buffer unit 403. The playing processing unit 404 is realized by the CPU 301 for executing the program, and an output device 305 for outputting a playing result, for example.

The transfer processing unit 405 performs control for transferring the data packets received by the reception unit 401 and stored in the buffer unit 403 to another communication device 400 equivalent to a child node of the communication device 400. Note that the transfer processing unit 405 recognizes whether or not there is a child node serving as a transfer destination, and the address of the child node in the event that there is a child node by referencing the node information storage unit 408. The transfer processing unit 405 is realized by the CPU 301.

The loss detecting unit 406 detects packet loss. With the present embodiment, upon receiving a data packet, the reception unit 401 not only stores the data packet in the buffer unit 403 but also extracts a sequence number included in the data packet and informs the sequence number to the loss detecting unit 406. Accordingly, the loss detecting unit 406 may detect packet loss based on the sequence number informed from the reception unit 401.

More specifically, the loss detecting unit 406 recognizes the range of the sequence numbers of the loss data packets. In the event of detecting packet loss, the loss detecting unit 406 then informs the range of the recognized sequence numbers to the retransmission request unit 407.

In response to this, the retransmission request unit 407 generates a retransmission request for requesting retransmission of the data packets having a sequence number of the range informed from the loss detecting unit 406. The retransmission request unit 407 then outputs the generated retransmission request to the transmission unit 402. As a result thereof, the transmission unit 402 transmits the retransmission request.

Note that the transmission request is specifically a kind of control packets. Also, the retransmission request unit 407 determines the transmission destination of the retransmission request with reference to the node information storage unit 408.

Note that the loss detecting unit 406 and retransmission request unit 407 are realized by the CPU 301, for example. Also, the node information storage unit 408 is realized by the RAM 302, nonvolatile storage device 306, or a combination thereof.

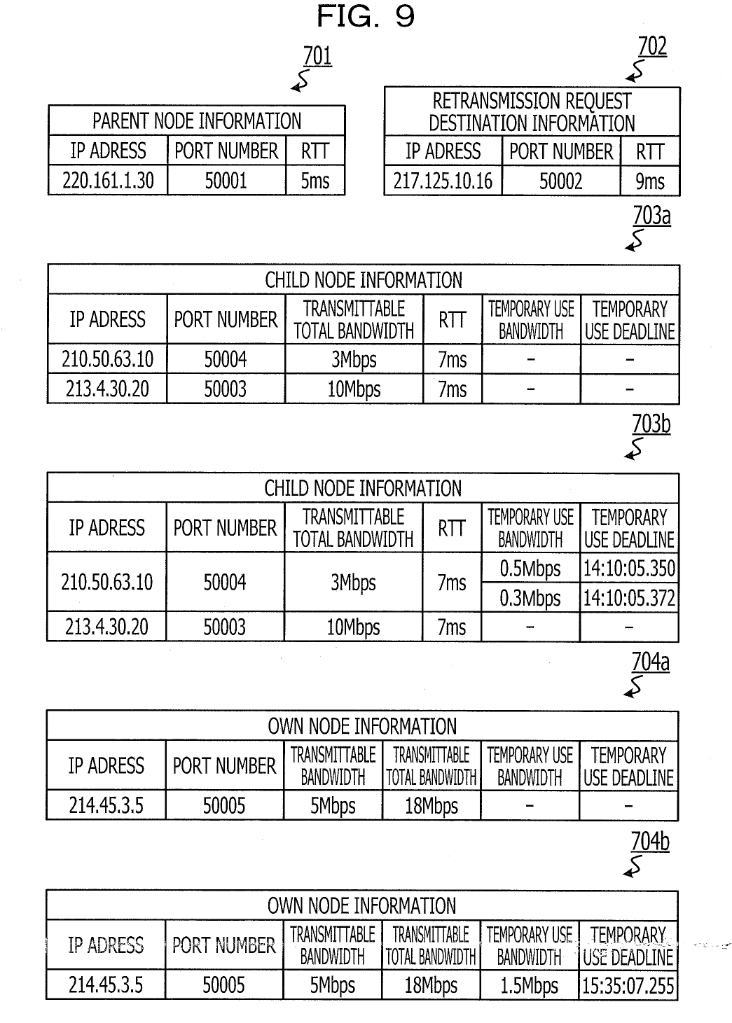

The node information storage unit 408 stores, for example, information such as the following (F-1) through (F-4). The details of the information that the node information storage unit 408 stores will be described later along with FIG. 9.

(F-1) Information relating to the communication device 400 itself, for example, such as the IP (Internet Protocol) address of the communication device 400, and bandwidth that the communication device 400 may use for retransmission.

(F-2) Information relating to another communication device 400 equivalent to the parent node of the communication device 400 within the logical network 100, for example, such as the IP address of the parent node.

(F-3) Information relating to another communication device 400 equivalent to a child node of the communication device 400 within the logical network 100, for example, such as the IP address of a child node, and summation of bandwidth that the nodes included in a partial tree with this child node as the root in the logical network 100 may use for retransmission.

(F-4) Information relating to a destination where the retransmission request unit 407 transmits a retransmission request, for example, such as the IP address of the destination.

Also, the node information managing unit 409 updates information within the node information storage unit 408 as appropriate according to the control packet received by the reception unit 401. Further, the node information managing unit 409 generates a suitable control packet at suitable timing, and outputs the generated control packet to the transmission unit 402. In response to this, the transmission unit 402 transmits the control packet.

A specific example of the control packet that the node information managing unit 409 processes will be described later. Note that the node information managing unit 409 is realized by the CPU 301, for example.

Also, upon receiving the retransmission request, the reception unit 401 outputs the retransmission request to the load distribution processing unit 410. In response to the retransmission request, the load distribution processing unit 410 executes processing such as described regarding FIG. 1. Note that the load distribution processing unit 410 may be realized, for example, by the CPU 301, and the units within the load distribution processing unit 410 operates as follows.

The selecting unit 411 selects one or more responsible nodes by prioritizing a child node over the communication device 400 itself. At the time of selection, the selecting unit 411 references the node information storage unit 408.

Also, the correlating unit 412 correlates each of the responsible nodes with a part or all of one or multiple packets (i.e., particular information) requested by the retransmission request. At the time of correlation, the correlating unit 412 may reference the node information storage unit 408. Also, the correlating unit 412 may update information on the node information storage unit 408 according to a correlation result.

In the event that there is one or more responsible child nodes, the request generating unit 413 generates a retransmission request from the responsible child nodes, and outputs the generated retransmission request to the transmission unit 402. In response to this, the transmission unit 402 transmits the retransmission request.

Also, in the event that the selecting unit 411 has selected the communication device 400 as a responsible node, the retransmission processing unit 414 reads out the payload of the data packet correlated with the communication device 400 by the correlating unit 412. The retransmission processing unit 414 then generates a suitable header for transmitting the data packet addressed to a request node, and outputs the data packet including the generated header and read payload to the transmission unit 402. In response to this, the transmission unit 402 transmits the data packet.

Incidentally, the distribution server 203 in FIG. 3 is the same as the communication device 400 in FIG. 5 in that the retransmission control in FIG. 1 is performed as the root node of the logical network 100. Specifically, the distribution server 203 also includes the load distribution processing unit 410 for performing retransmission control with reception of the retransmission request from another node as a trigger in the same way as with the communication device 400 equivalent to the terminal devices 205A through 205L.

Also, the distribution server 203 also includes the reception unit 401, transmission unit 402, buffer unit 403, node information storage unit 408, and node information managing unit 409. However, the distribution server 203 does not have to include a playing processing unit 404, transfer processing unit 405, loss detecting unit 406, and retransmission request unit 407.

Note that the distribution server 203 includes an unshown generating unit for generating the data of a content to be distributed and outputting to the buffer unit 403, or an unshown obtaining unit for obtaining the data of a content from an external device such as a camera and outputting to the buffer unit 403. The generating unit may be realized, for example, by the CPU 301, and the obtaining unit may be realized, for example, an interface connecting an external device and the distribution server 203.

Further, the distribution server 203 includes an unshown distribution processing unit for performing control for transmitting the data generated or obtained by the generating unit or obtaining unit and stored in the buffer unit 403. The distribution processing unit performs, in the same way as with the transfer processing unit 405, control for recognizing a child node with reference to the node information storage unit 408, and transmitting the data stored in the buffer unit 403 to the child nodes.

As described above, the distribution server 203 also includes a configuration similar to the communication device 400 in FIG. 5. Therefore, with the following description, in the event that there is no fear of misunderstanding in particular, devices including a communication device modified for the distribution server 203 as described above will sometimes be referred to as “communication device 400”.

Next, description will be made in detail regarding the operation of the communication device 400 equivalent to the nodes within the logical network 100 (specifically, the distribution server 203 or the terminal devices 205A through 205L), and the operation of the management server 204.

The distribution server 203 equivalent to the root Node N₁ in the logical network 100 performs processing of the following (G-1) through (G-7).

(G-1) Processing for registering, when receiving a request for requesting to register as a child of the distribution server 203 from a terminal device, this terminal device as a child node of the distribution server 203. This processing in (G-1) is processing to be performed in an event-driven manner at random in conjunction with participation of a new terminal device to the logical network 100 or reconstruction of a distribution tree.

(G-2) Processing for eliminating, when receiving a notification to inform leaving form the logical network 100 from a child node of the distribution server 203, the information of this child node. This processing in (G-2) is processing to be performed in an event-driven manner at random.

(G-3) Processing for recording, when change occurs in the total value of bandwidth that a node included in the tree (i.e., logical network 100) with the distribution server 203 as the root node may use for retransmission, this change.

(G-4) Processing for detecting change in bandwidth that the distribution server 203 itself may use for retransmission. This processing in (G-4) may be periodical monitoring processing, or may be processing for detecting an event that occurs at random.

(G-5) Processing for generating or obtaining a content to be distributed within the logical network 100, packetizing the content, and transmitting the data packet to a child node at suitable timing (e.g., periodically with a suitable interval according to a sampling rate). Note that the distribution server 203 continues to hold the data packet at the buffer unit 403 for a certain period of time after transmission in preparation for retransmission.

(G-6) Aging processing for eliminating older data packets from the buffer unit 403. This processing in (G-6) may periodically be called up, for example, by a timer interrupting signal.

(G-7) Processing for responding to the retransmission request from the distribution server 203 itself, or causing a child node of the distribution server 203 to ensure retransmission when receiving a retransmission request from any node within the logical network 100. This processing in (G-7) is processing to be performed in an event-driven manner at random.

Also, the leaf nodes in the logical network 100 (Nodes N₅, N₇ through N₁₃ in the example in FIG. 1 and FIG. 2) perform the following processing in (H-1) through (H-13).

(H-1) Processing for querying the management server 204 a suitable node as a parent node when newly participating in the logical network 100. This processing in (H-1) is processing for initial settings.

(H-2) Processing for requesting registration as a child node at to a node to which the management server 204 has replied to the inquiry in the above (H-1). This processing in (H-2) is also processing for initial settings.

(H-3) Processing for recording, when change occurs in bandwidth that this leaf node itself may use for retransmission, the change, and also for informing the change to the parent node.

(H-4) Processing for detecting change in bandwidth that this leaf node itself may use for retransmission. This processing in (H-4) may be periodical monitoring processing, or may be processing for detecting an event that occurs at random.

(H-5) Processing for detecting whether or not there is packet loss with reception of a data packet as a trigger, and transmitting a retransmission request according to need. Note that the communication device 400 equivalent to a leaf node continues to hold the received data packet at the buffer unit 403 for a certain period of time in preparation for a case where a retransmission request is received from another node.

(H-6) Aging processing for eliminating older data packets from the buffer unit 403. This processing in (H-6) may periodically be called up, for example, by a timer interrupting signal.

(H-7) Processing for playing a content (e.g., moving image or audio or the like) using the received data packet.

(H-8) Processing for responding to the retransmission request when receiving a retransmission request from any node within the logical network 100. This processing in (H-8) is processing to be performed in an event-driven manner at random.

(H-9) Processing for querying the management server 204 a suitable node as the transmission destination of the retransmission request in the above processing in (H-5). The timing when this processing in (H-9) is performed is optional. For example, this processing in (H-9) may first be performed along with the above processing in (H-1), and thereafter may further repeatedly be performed.

(H-10) Processing for transmitting, when receiving NACK (Negative ACKnowledgment) to the effect that in the event that a retransmission request has been transmitted in the above processing in (H-5), this retransmission request is not accepted, the retransmission request to another node again.

(H-11) Processing for informing, when leaving from the logical network 100, this leaving to the parent node and management server 204.

(H-12) Processing for requesting, in the event of receiving a notification to inform a candidate of a new parent node, registration as a child node as to the informed candidate. The notification from the parent node in this processing in (H-12) is performed, for example, in the event that the parent node so far leaves from the logical network 100, or the like.

(H-13) Processing for requesting, in the event that the situation represented by information that this leaf node has ever informed to the management server 204 has been changed, the management server 204 to update the information thereof.

Also, the relay nodes in the logical network 100 (Nodes N₂ through N₄ and N₆ in the example in FIG. 2) perform the following processing in (I-1) through (I-14).

(I-1) Processing for querying the management server 204 a suitable node as a parent node when newly participating in the logical network 100. This processing in (I-1) is processing for initial settings.

(I-2) Processing for requesting registration as a child node at to a node to which the management server 204 has replied to the inquiry in the above (I-1). This processing in (I-2) is also processing for initial settings.

(I-3) Processing for registering, when receiving a request for requesting to register as a child from another terminal device, this terminal device as a child node. This processing in (I-3) is processing to be performed in an event-driven manner at random in conjunction with participation of a new terminal device to the logical network 100 or reconstruction of a distribution tree.

(I-4) Processing for eliminating, when receiving a notification to inform leaving from the logical network 100 from a child node, the information of this child node. This processing in (I-4) is processing to be performed in an event-driven manner at random.

(I-5) Processing for recording, when change occurs in the total value of bandwidth that a node included in the tree (i.e., a partial tree of logical network 100) with this relay node itself as the root node may use for retransmission, this change, and also informing this change to the parent node.

(I-6) Processing for detecting change in bandwidth that this relay node itself may use for retransmission. This processing in (I-6) may be periodical monitoring processing, or may be processing for detecting an event that occurs at random.

(I-7) Processing for detecting whether or not there is packet loss with reception of a data packet as a trigger, transmitting a retransmission request according to need, and transferring the successfully received data packet to a child node. Note that the communication device 400 equivalent to a relay node continues to hold the received data packet at the buffer unit 403 for a certain period of time in preparation for a case where a retransmission request is received from another node.

(I-8) Aging processing for eliminating older data packets from the buffer unit 403. This processing in (I-8) may periodically be called up, for example, by a timer interrupting signal.

(I-9) Processing for playing a content (e.g., moving image or audio or the like) using the received data packet.

(I-10) Processing for responding to the retransmission request when receiving a retransmission request from any node within the logical network 100. This processing in (I-10) is processing to be performed in an event-driven manner at random.

(I-11) Processing for querying the management server 204 a suitable node as the transmission destination of the retransmission request in the above processing in (I-7). The timing when this processing in (I-11) is performed is optional. For example, this processing in (I-11) may first be performed along with the above processing in (I-1), and thereafter may further repeatedly be performed.

(I-12) Processing for transmitting, when receiving a NACK to the effect that in the event that a retransmission request has been transmitted in the above processing in (I-7), this retransmission request is not accepted, the retransmission request to another node again.

(I-13) Processing for informing, when leaving from the logical network 100, this leaving to the parent node and management server 204, and also informing the parent node of this relay node itself to each of the child nodes as a candidate of a new parent node of this child node. For example, when the relay Node N₆ in FIG. 2 attempts to leave the logical network 100, the Node N₆ informs this leaving to the parent Node N₃ and management server 204. Further, the relay Node N₆ informs the parent Node N₃ of the Node N₆ itself as a candidate of a new parent node of the Node N₁₂ to the child Node N₁₂. Similarly, the Node N₆ informs the Node N₃ to the child Node N₁₃ as a candidate of a new parent node of the Node N₁₃.

(I-14) Processing for requesting, in the event that the situation represented by information that this relay node has ever informed to the management server 204 has been changed, the management server 204 to update the information thereof.

The management server 204 performs the following processing in (I-1) through (J-4). Any of the processing in (J-1) through (J-4) is processing to be performed in an event-driven manner with reception of a control packet as a trigger.

(J-1) Processing for responding to, in the event of having received an inquiry regarding which node should be selected as a parent node from a terminal device which attempts to participate in the logical network 100, this inquiry, i.e., the inquiries of the above (H-1) and (I-1).

(J-2) Processing for responding to, in the event of having received an inquiry regarding which node a retransmission request should be transmitted from a relay node or leaf node with in the logical network 100, this inquiry, i.e., the inquiries of the above (H-9) and (I-11).

(J-3) Processing for updating, in the event of having received from one of the nodes within the logical network 100 a request for requesting updating of information that the management server 204 manages regarding this node, the information according to the request, i.e., processing for responding to the requests of the above (H-13) and (I-14).

(J-4) Processing for eliminating, in the event of having received a notification of leaving from a node which attempts to leave the logical network 100, information that the management server 204 manages regarding this node, i.e., processing for eliminating unnecessary information according to the notifications of the above (H-11) and (I-13).

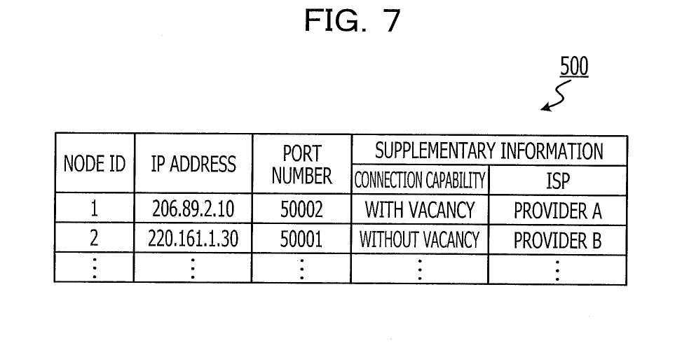

First, description will be made below regarding the processing in (J-1) through (J-4) using the management server 204 with reference to FIG. 6 and FIG. 7 for convenience of description.

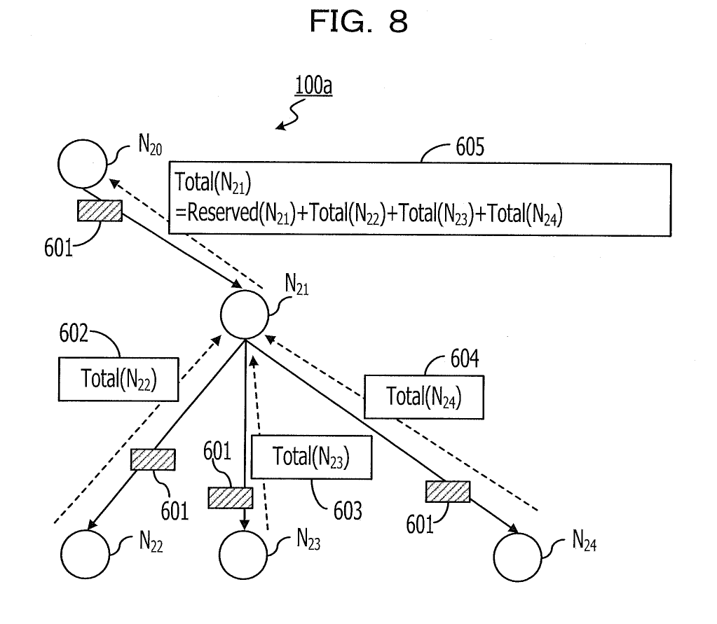

Thereafter, description will be made regarding the detection processing in (G-4), (H-4), and (I-6) common to the nodes within the logical network 100, and the processing in (G-3), (H-3), and (I-5) in the event that change in bandwidth that may be used for retransmission has been detected by the detection processing, with reference to FIG. 8.

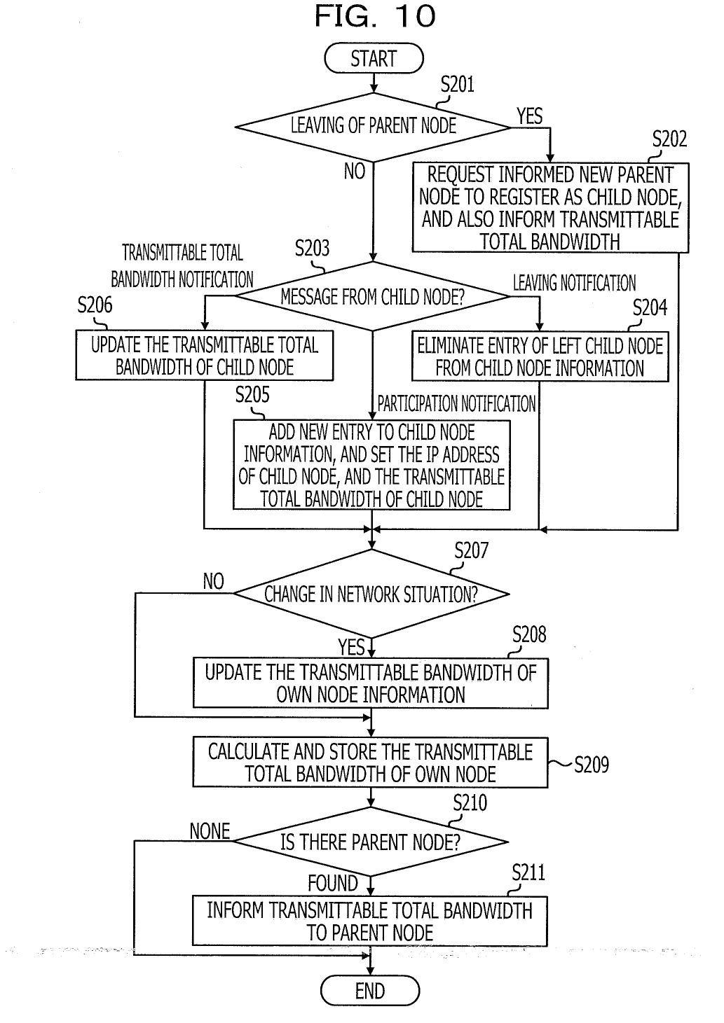

Note that the processing in (G-3) and (I-5) is performed, for example, with reception of a control packet as a trigger. Therefore, subsequently, description will be made regarding the processing in (G-1) through (G-3), (-12), and (I-3) through (I-5) to be performed with reception of a control packet other than a retransmission request as a trigger, with reference to FIG. 9 and FIG. 10.

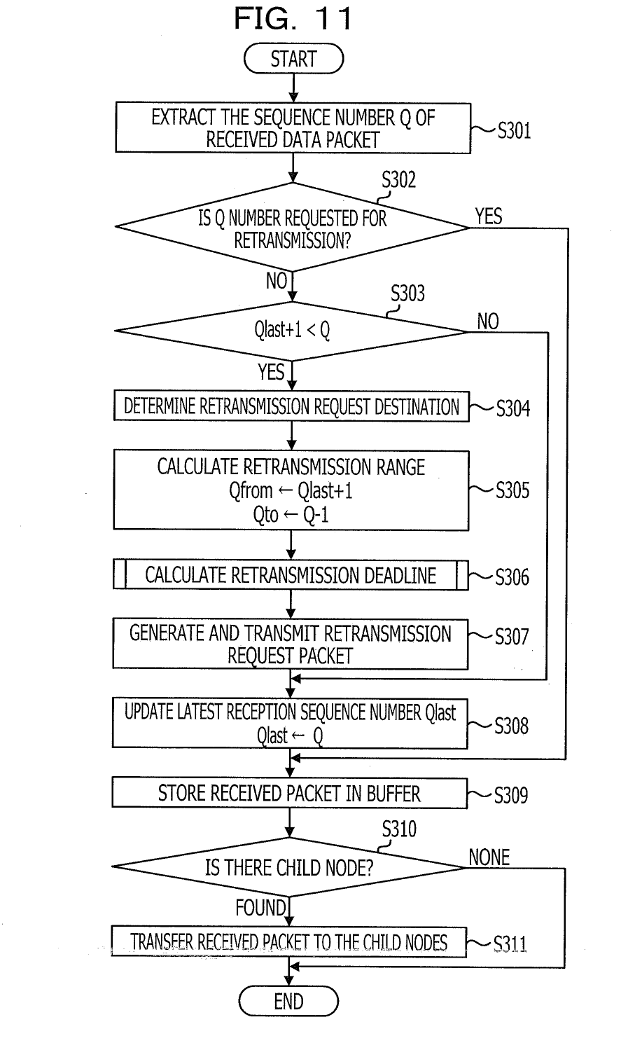

Thereafter, description will be made regarding the processing in (G-5), (H-5), (H-7), (I-7), and (I-9) relating to transmission/reception of data packets, with reference to FIG. 11 through FIG. 14.

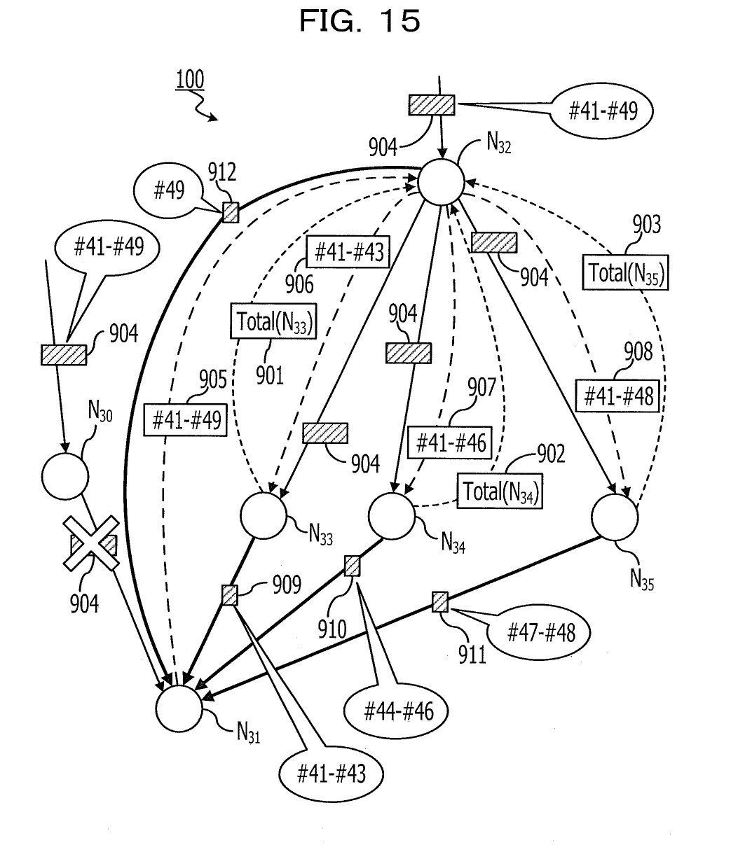

Further, thereafter, description will be made regarding the processing in (G-7), (H-8), (H-10), (I-10), and (I-12) to be performed with reception of a retransmission request as a trigger, with reference to FIG. 15 through FIG. 19.

Now, FIG. 6 is a flowchart regarding the processing in (J-1) through (J-4) that the management server 204 performs. That is to say, FIG. 6 is a flowchart of the processing that the management server 204 executes with reception of a control packet as a trigger. Also, FIG. 7 is a diagram illustrating an example of the node management information 500 that the management server 204 holds.

Upon receiving a control packet from one of the existing nodes within the logical network 100, or a node which attempts to newly participate in the logical network 100, the management server 204 starts the processing in FIG. 6.

Next, in Operation S101, the management server 204 determines whether or not the received control packet is a request for new connection. Note that, here, “request for new connection” means a participation request from a new terminal device which has not participated yet in the logical network 100. With the present embodiment, the types of various control packets may be distinguished by the value of a type field within the header.

In the event that the control packet received by the management server 204 is a request for new connection, the processing proceeds to Operation S102. Also, in the event that the control packet received by the management server 204 is another type of message, the processing proceeds to Operation S103.

In Operation S102, the management server 204 selects a candidate of the parent node of the terminal device of the transmission source of a request for new connection (hereafter, referred to as “new node” as appropriate). The management server 204 then informs the selected candidate to the new node. Also, the management server 204 adds a new entry to the node management information 500 in FIG. 7, and sets the field of the new entry to a suitable value. Note that the number of candidates that the management server 204 selects may be one or two, but for simplification of description, let us assume that the number of candidates is one.

Now, the node management information 500 that the management server 204 holds will be described with reference to FIG. 7. With the node management information 500, the entries of the node management information 500 including one or more entries correspond to the nodes included in the logical network 100.

Also, the entries of the node management information 500 according to the present embodiment include fields such as “node ID (identification)”, “IP address”, “port number”, “connection capability”, and “ISP (Internet Service Provider)”.

The “node ID” field indicates an ID that the management server 204 has assigned to this node. The “IP address” field indicates the IP address of this node. The “port number” field is the reception port number of this node.

Also, the connection capability and ISP are an example of supplementary description relating to a node. For example, the “connection capability” field indicates whether or not this node has a vacant bandwidth whereby a child node may newly be held, and the “ISP” field indicates the ISP to which this node is connected.

The first entry in the example in FIG. 7 indicates the node of which the node ID is 1. According to the first entry, with the node of which the node ID is 1, the IP address is 206.89.2.10, and the port number is 50002. Also, according to the first entry, with the node of which the node ID is 1, the connection capability is “with vacancy” (i.e., a new child node is acceptable), and this node is connected to a provider A.

Also, the second entry indicates the node of which the node ID is 2. According to the second entry, with the node of which the node ID is 2, the IP address is 220.161.1.30, and the port number is 50001. Also, according to the second entry, with the node of which the node ID is 2, the connection capability is “without vacancy” (i.e., a new child node is unacceptable), and this node is connected to a provider B.

Note that the node management information 500 in the initial state is set beforehand so as to include one entry corresponding to the distribution server 203. Also, the node ID of the distribution server 203 is a predetermined value (e.g., 1). The number of entries of the node management information 500 is changed according to construction or reconstruction of a distribution tree.

Also, depending on embodiments, the node management information 500 may not include port numbers. For example, in the event that the port numbers are determined to be unique constants by ALM software, the port number field may be omitted. Also, the supplementary description is optional information, and accordingly may be omitted according to an embodiment.

Now, description will return to FIG. 6. The terminal device which attempts to participate in the logical network 100 transmits a request for new connection to the management server 204. Upon receiving the request for new connection, the management server 204 performs the processing in Operation S102 as described above. The request for new connection is a message for querying the management server 204 a suitable node as the parent node as described in the above (H-1) and (I-1). Also, the request for new connection includes a notification regarding the IP address, port number, connection capability, and ISP of a new node (i.e., the terminal device of the requested transmission source) itself.

Accordingly, in Operation S102, the management server 204 specifically performs the following processing.

The management server 204 issues a new node ID for the new node. The management server 204 then selects the node corresponding to an optional entry of which the connection capability is “with vacancy” as a candidate of the parent node of the new node. Note that, in the event that there is no entry of which the connection capability is “with vacancy”, the management server 204 may select the distribution server 203.

The management server 204 then informs the node ID, IP address, port number, and issued new node ID of the node selected as a candidate of the parent node to the new node.

Further, in Operation S102, the management server 204 adds the new entry to the node management information 500. The management server 204 then sets, with the added entry, the “node ID” field to the value of the issued new node ID, and copies the values included in the request for new connection to the fields of the “IP address”, “connection capability”, and “ISP”, respectively.

Note that the management server 204 may preferentially select the entry having the same ISP as the ISP included in the request for new connection as a candidate of the parent node. Alternatively, the management server 204 may preferentially select the node having an IP address having the same octets as the IP address included in the request for new connection as much as possible when comparing from the most significant octet, as a candidate of the parent node.

Also, the connection capability of the node management information 500 may be represented with a numeric value such as the number of acceptable child nodes instead of a binary of “with vacancy” and “without vacancy”. The management server 204 may use an evaluation function with the connection capability represented with a numeric value, and the ISP as arguments to select a node having the highest evaluation as a candidate of the parent node of the new node.

Upon a series of processing in Operation S102 being ended as described above, the processing in FIG. 6 is also ended.

On the other hand, in the event that determination is made by the management server 204 in Operation S101 that a control packet other than the request for new connection has been received, the processing in Operation S103 is subsequently performed. Specifically, in Operation S103, the management server 204 determines whether or not the received control packet is the leaving notification from the logical network 100 (i.e., notification in (H-11) or (I-13)).

In the event that the control packet that the management server 204 has received is a leaving notification, the processing proceeds to Operation S104. Also, in the event that the control packet that the management server 204 has received is another type of message, the processing proceeds to Operation S105.

In Operation S104, the management server 204 eliminates the entry corresponding to the node of the transmission source of the leaving notification from the node management information 500. The leaving notification includes the IP address of the node to be left from the logical network 100, whereby the management server 204 may determine the entry to be eliminated with the IP address as a key. After elimination of the entry, the processing in FIG. 6 is also ended.

Also, in Operation S105, the management server 204 determines whether or not the received control packet is the inquiry of the transmission request destination (i.e., inquiry in (H-0) or (I-11)).

Note that a leaf node or relay node within the logical network 100 may transmit inquiry of the transmission request destination to the management server 204 in preparation for a future retransmission request. A leaf node or relay node may repeatedly transmit the inquiry of the retransmission request destination of the management server 204 at optional timing (e.g., periodically with a relatively long interval).

In the event that the control packet that the management server 204 has received is the inquiry of the retransmission request, the processing then proceeds to Operation S106. Also, in the event that the control packet that the management server 204 has received is another type of message, the processing proceeds to Operation S107.

In Operation S106, the management server 204 selects the node corresponding to one optional entry of the existing entries of the node management information 500 as a candidate of the retransmission request destination. For example, the management server 204 may simply select one entry at random.

The management sever 204 then informs the selected candidate (more specifically, the node ID, IP address, and port number of the selected candidate) to the node of the inquiry transmission source. After this notification, the processing in FIG. 6 is also ended.

Also, in Operation S107, the management server 204 determines whether or not the received control packet is the updating request of the node management information 500 (i.e., the request in (H-13) or (I-14)).

For example, a leaf node with the logical network 100 may monitor the connection capability of itself, or when the connection capability is changed, may transmit the request in (I-13). A relay node may transmit the request in (I-14) in the same way. For example, the connection capability may be changed according to change in a bandwidth that an application other than content distribution uses.

In the event that the control packet that the management server 204 has received is the updating request of the node management information 500, the processing proceeds to Operation S108. Also, in the event that the control packet that the management server 204 has received is not the updating request of the node management information 500, the processing in FIG. 6 ends.

In Operation S108, the management server 204 searches the entry corresponding to the node of the transmission source of the updating request of the node management information 500, and updates the contents of the entry found as a result of search according to the received updating request. Note that the updating request may be a request for requesting updating of a value other than the connection capability. For example, in the event that the supplementary information further includes an additional item other than the connection capability and ISP, the updating request may be a request for requesting updating of this additional item. After updating of the node management information 500, the processing in FIG. 6 ends.

Next, description will be made regarding the detection processing in (G-4), (H-4), and (I-6) common to the nodes within the logical network 100, and the processing in (G-3), (H-3), and (I-5) in the event that change in bandwidth that may be used for retransmission has been detected by the detection processing. With the present embodiment, detection and notification of change in bandwidth that may be used for retransmission to improve the reliability of retransmission.

Hereafter, the bandwidth that a certain Node Nⱼ may be used for retransmission of data packets will be referred to as “transmittable bandwidth” of the Node Nⱼ. In other words, the transmittable bandwidth is bandwidth to be reserved for retransmission.

Also, the summation of the transmittable bandwidth of all nodes included in a subgraph with the Node Nⱼ as the root node will be referred to as “transmittable bandwidth” of the Node Nⱼ. According to a definition, with a leaf node, the transmittable bandwidth is equal to the transmittable total bandwidth. Also, according to the above definition, the transmittable total bandwidth may be represented such as Expression (1).

$$Total ( {N}_{j} ) = Reserved ( {N}_{j} ) + {\sum }_{{N}_{k} ∈ Child ( {N}_{j )}} Total ( {N}_{k} ) \qquad ( 1 )$$

Note that, in Expression (1), “Reserved (Nⱼ)” is the transmittable bandwidth of the Node Nⱼ. Also, “Total (Nⱼ)” is transmittable total bandwidth of the Node Nⱼ, and “Total (Nₖ)” is transmittable total bandwidth of the Node Nₖ. “Child (Nⱼ)” is a group of the child nodes of the Node Nⱼ.

The transmittable bandwidth may be specified by the user, for example. Alternatively, the data distribution application program (i.e., ALM software) installed into a computer for realizing a node (e.g., the distribution server 203 or communication device 400 such as the terminal devices 205A through 205L may automatically set the transmittable bandwidth. The data distribution application program may dynamically change the transmittable bandwidth based on bandwidth used for not retransmission but the original data distribution, a network environment, bandwidth used by another application program that the same computer is executing, and so forth.

Specifically, the detection processing in (G-4), (H-4), and (I-6) is processing for monitoring occurrence of an event such as the following (K-1) through (K-4), and detecting occurrence of an event that provides change in the transmittable bandwidth. Hereafter, for convenience of description, for example, events such as (K-1) through (K-4) will collectively be referred to as “change in network situation”.

(K-1) The user has set a new value as the transmittable bandwidth.

(K-2) The physical network environment has been changed. For example, in the event that the node to be subjected to the detection processing is specifically the terminal device 205H in FIG. 3, the communication amount according to another terminal 205G or 2051 connected to the same router 202E as with the terminal device 205H may be used has been changed due to this influence. Alternatively, the bandwidth of a line within the core network 201 connected to the router 202E has been changed.

(K-3) With the data distribution application, the bandwidth that is desirable to be secured for processing other than retransmission has been changed. For example, the number of child nodes has been changed.

(K-4) The bandwidth that another application being executed within the same computer uses has been changed.

Incidentally, the reason for the nodes performing detection of change in the transmittable bandwidth is, as described above, to improve the reliability of retransmission (i.e., in order to ensure retransmission in a sure manner).

For example, with the example in FIG. 1, the Node N₆ leaves the retransmission processing to the Node N₁₂ in Operation S33. However, if we say that most of physically available bandwidth has already been occupied by other processing other than retransmission, retransmission from the Node N₁₂ will fail with high risk. That is to say, the Node N₁₂ will fail to ensure retransmission with high risk in spite of having been selected as a responsible node.

Also, the Node N₃ selects the Node N₆ as a responsible node, and leaves retransmission to the Node N₆ in Operation S30 on the premise that retransmission is ensured by one or more optional nodes belonging to a partial group with the Node N₆ as the root node. Accordingly, if we say that the Node N₁₂ fails to ensure retransmission as described above, the premise for selecting a responsible node for the Node N₃ does not hold.

Therefore, in order to ensure retransmission in a sure manner (i.e., in order to realize the premise exemplified above), with the present embodiment, the nodes reserve the transmittable bandwidth for retransmission, and also recognize change in the transmittable bandwidth.

Specifically, as may be apparent from Expression (1), the transmittable total bandwidth Total(Nⱼ) of the Node Nⱼ will be changed for the following reasons in (L-1) through (L-4).

(L-1) The transmittable bandwidth Reserved(Nⱼ) of the Node Nⱼ itself has been changed.

(L-2) The Node Nⱼ has newly selected the Node Nₖ as a child node, and accordingly, the transmittable total bandwidth Total(Nⱼ) of the Node Nⱼ has increased by an amount equivalent to the transmittable total bandwidth Total(Nₖ) of the Node Nₖ.

(L-3) The transmittable total bandwidth Total(Nₖ) of the child Node Nₖ has been changed in the event that the Node Nⱼ has already had the child Node Nₖ.

(L-4) The child Node Nₖ has been left from the logical network in the event that the Node Nⱼ has already had the child Node Nₖ, and accordingly, the transmittable total bandwidth Total(Nⱼ) of the Node Nⱼ has decreased by an amount equivalent to the transmittable total bandwidth Total(Nₖ) of the Node Nₖ.

The change in (L-1) is specifically caused by change in a network situation such as the above (K-1) through (K-4). Also, as may be apparent from (L-3), in the event that the transmittable total bandwidth Total(Nₖ) of the certain Node Nₖ has been changed, the transmittable total bandwidth Total(Nⱼ) of the parent Node Nⱼ of the Node Nₖ has also been changed accordingly.

Accordingly, with the present embodiment, as processing for each of the nodes within the logical network 100 recognizing change in the transmittable total bandwidth of this node itself, a notification informing change in the transmittable total bandwidth is transmitted from a child node to the parent node. As a result thereof, upon a certain node transmitting a notification, the notification is sequentially transmitted in a chain reaction manner tracing edges within the logical network 100 as far back as the root node.

For example, upon the Node N₉ in FIG. 1 detecting change in the transmittable bandwidth Reserved(N₉) of the Node N₉ itself, it goes saying that the transmittable total bandwidth Total(N₉) of the Node N₉ has also been changed. Therefore, the Node N₉ informs the change in the transmittable total bandwidth Total(N₉) to the parent Node N₄.

As a result thereof, the transmittable total bandwidth Total(N₄) of the Node N₄ has also been changed. Accordingly, the Node N₄ informs the change in the transmittable total bandwidth Total(N₄) to the parent Node N₂. In response to this, the transmittable total bandwidth Total(N₂) of the Node N₂ has also been changed, and accordingly, the Node N₂ informs the change in the transmittable total bandwidth Total(N₂) to the parent Node N₁.

In response to this, the transmittable total bandwidth Total(N₁) of the Node N₁ has also been changed. However, the Node N₁ is the root node in the logical network 100, and accordingly, a notification in conjunction with change in the transmittable total bandwidth Total(N₁) does not have to be transmitted.

For example, the nodes within the logical network 100 may recognize the change in the transmittable total bandwidth by a notification in a chain reaction manner as described above. A node which has received a retransmission request then selects a responsible node in the light of the transmittable total bandwidth of a child node, and accordingly, retransmission is ensured in a surer manner, and the reliability of retransmission improves.

Now, description will return to the detection processing in (G-4), (H-4), and (I-6) regarding the transmittable bandwidth. The change in the transmittable total bandwidth due to the above (L-1) may be detected by the detection processing in (G-4), (H-4), and (I-6).

Accordingly, in the event of having detected the change in the transmittable bandwidth by the detection processing in (H-4) and (I-6), a leaf node or relay node calculates transmittable total bandwidth changed due to the change in the transmittable bandwidth, stores the calculation result, and informs the calculation result to the parent node. That is to say, the leaf node performs the notification in (H-3), and the relay node performs the notification in (I-5).

Note that, in the event of having detected the change in the transmittable bandwidth by the detection processing in (G-4), the root node calculates transmittable total bandwidth changed due to the change in the transmittable bandwidth, and stores the calculation result, but does not have to inform the calculation result to other nodes. That is to say, the root node should simply record the change as with (G-3).

Now, FIG. 8 schematically illustrates the detection and notification of the change in the transmittable total bandwidth described above. The logical network 100a in FIG. 8 is a portion extracted a certain logical network. The logical network 100a includes Nodes N₂₀ through N₂₄. Also, the Node N₂₁ is a child node of the Node N₂₀, and the Nodes N₂₂ through N₂₄ are child nodes of the Node N₂₁.

Note that the Node N₂₀ may be the root node or a relay node. Also, the Nodes N₂₂ through N₂₄ may be leaf nodes or relay nodes.

In the same way as with FIG. 1 and FIG. 2, in FIG. 8 as well, a direction where a data packet 601 is distributed is indicated by a solid-line arrow. A dashed-line arrow indicates a direction where a notification for transmittable total bandwidth is transmitted.

As shown in FIG. 8, when requesting the Node N₂₁ to register as a child node, and in the event that the transmittable total bandwidth Total(N₂₂) of the Node N₂₂ has been changed, the Node N₂₂ transmits a notification 602 for transmittable total bandwidth to the Node N₂₁. Similarly, when requesting the Node N₂₁ to register as a child node, and in the event that the transmittable total bandwidth Total(N₂₃) of the Node N₂₃ has been changed, the Node N₂₃ transmits a notification 603 for transmittable total bandwidth to the Node N₂₁. Further, similarly, when requesting the Node N₂₁ to register as a child node, and in the event that the transmittable total bandwidth Total(N₂₄) of the Node N₂₄ has been changed, the Node N₂₄ transmits a notification 604 for transmittable total bandwidth to the Node N₂₁.

Note that the notifications 602 through 604 for transmittable total bandwidth may be transmitted in an optional order, or may be transmitted any number of times according to need. Each time one of the notifications 602 through 604 for transmittable total bandwidth is received, the Node N₂₁ recalculates the transmittable total bandwidth Total (N₂₁), stores the calculation result, and also transmits a notification 605 where the calculation result is recorded to the Note N₂₀. Further, even in the event that the transmittable bandwidth Reserved(N₂₁) of the Node N₂₁ itself has been changed, the Node N₂₁ recalculates the transmittable total bandwidth Total(N₂₁), stores the calculation result, and also transmits the notification 605 where the calculation result is recorded to the Note N₂₀.

Incidentally, in order to inform the transmittable total bandwidth as described above, the node information storage unit 408 of the communication device 400 in FIG. 5 holds the transmittable bandwidth of the communication device 400 itself, and the transmittable total bandwidth of each of the child nodes of the communication device 400 as node information. Also, the notifications 603 through 605 for transmittable total bandwidth exemplified in FIG. 8 are a kind of control packets, but as may be seen from description in FIG. 8, the nodes (i.e., communication device 400) performs various types of processing with reception of a control packet as a trigger.

Therefore, description will be made below regarding an example of the node information that the node information storage unit 408 holds with reference to FIG. 9, and regarding processing for taking reception of a control packet as a trigger with reference to FIG. 10.

As briefly described in the above (F-1) through (F-4), the node information that the node information storage unit 408 of the communication device 400 holds includes several kinds of information. Specifically, the node information includes parent node information 701 regarding the parent node of the communication device 400, retransmission request destination information 702 regarding the node of a retransmission request destination that is a destination where the communication device 400 transmits a retransmission request, child node information regarding a child node of the communication device 400, and the own node information regarding the communication device 400 itself.

Note that, upon the communication device 400 receiving a retransmission request, the child node information and own node information have been changed. Therefore, in FIG. 9, separate reference numerals “703a” and “703b” are appended to the child node information in two states. Similarly, in FIG. 9, separate reference numerals “704a” and “704b” are appended to the own node information in two states.

Also, in FIG. 9. for convenience of drawing, various types of information are exemplified with a table format, but the data format is optional depending on embodiments. For example, a linear list or associative array may be used.

The parent node information 701 includes the IP address of the parent node of the communication device 400, the port number of the parent node (specifically, reception port number), and RTT (Round Trip Time) between the communication device 400 and the parent node. The parent node information 701 may further include the node ID of the parent node. With the example of the parent node information 701 in FIG. 9, the IP address is 220.161.1.30, the port number is 50001, and the RTT is 5 ms.

For example, the node information managing unit 409 measures the RH between the parent node, and writes the measurement result into the parent node information 701. For the measurement of the RH, a “ping” command or the like is available, for example.

Specifically, the node information managing unit 409 generates an echo request packet of ICMP (Internet Control Message Protocol) with the IP address of the parent node being specified as a destination, and the transmission unit 402 transmits the echo request packet. The reception unit 401 then receives the echo response packet form the parent node, and outputs to the node information managing unit 409. In response to this, the node information managing unit 409 recognizes time taken from transmission of the echo request packet to reception of the echo response packet as the RH between the parent node and the communication device 400 itself, and writes the recognized RH into the parent node information 701.

Also, the retransmission request destination information 702 includes the IP address of the retransmission request destination for the communication device 400, the port number of the retransmission request destination (specifically, reception port number), and RH between the communication device 400 and the retransmission request destination. The retransmission request destination information 702 may further include the node ID of the retransmission request destination. With the example of the retransmission request destination information in FIG. 9, the IP address is 217.125.10.16, the port number is 50002, and the RH is 9 ms.

Note that the node information managing unit 409 is desirable to obtain the retransmission request destination information 702 beforehand, and to store this in the node information storage unit 408 in preparation for packet loss and a retransmission request in the future. However, in the event that the loss detecting unit 406 has detected packet loss, the node information managing unit 409 may obtain the retransmission request destination information 702 in accordance with the request from the loss detecting unit 406.

That is to say, the node information managing unit 409 may transmit the inquiry in (H-9) or (I-11) to the management server 204 at optional timing. In response to this, the management server 204 replies to the inquiry in Operation S106 in FIG. 6. The transmission unit 402 then receives the reply and output to the node information managing unit 409.

As a result thereof, the node information managing unit 409 recognizes the IP address and port number of the retransmission request destination. Also, the node information managing unit 409 specifies the recognized IP address of the retransmission request destination to execute the “ping” command at optional timing, whereby the RU between the retransmission request destination and the communication device 400 may be measured. The node information managing unit 409 records the measurement result as the RTT of the retransmission request destination information 702.

The child node information 703a and 703b are examples of the child node information in different two states at different time points. The child node information that the node information storage unit 408 of the communication device 400 stores has entries equivalent to the number of child nodes of the communication device 400.

Also, the entries of the child node information include the IP address of a child node, the port number of a child node (specifically, reception port number), the transmittable total bandwidth of a child node, and RTT between a child node and the communication device 400. The entries of the child node information may further include the node ID of a child node depending on embodiments.

The entries of the child node information further include zero pair, one pair, or multiple pairs of “temporary use bandwidth” and “temporary use deadline”. In FIG. 9, for convenience of drawing, in the event that the number of pairs of the temporary use bandwidth and the temporary use deadline is zero, “-” is displayed on the columns of the temporary use bandwidth and temporary use deadline.

For example, with the child node corresponding to the first entry of the child node information 703a, the IP address is 210.50.63.10, and the port number is 50004. Also, the transmittable total bandwidth of the first entry is exemplified as “3 Mbps”, but this indicates that the node information managing unit 409 has received the same notification for transmittable total bandwidth as with FIG. 8, and 3 Mbps has been recorded in the received notification.

The node information managing unit 409 measures the RH between a child node and the communication device 400 using, for example, the “ping” command or the like at optional timing, and records the measurement result as the RH of the child node information. The node information managing unit 409 may perform measurement of the RTT immediately after registration of a child node, for example. With the first entry of the child node information 703a, for example, a measurement result of 7 ms has been written as the RH.

Also, with the second entry of the child node information 703a, the IP address is 213.4.30.20, the port number is 50003, transmittable total bandwidth is 10 Mbps, and RH is 3 ms.

Note that the child node information 703a in FIG. 9 includes two entries, but both entries do not have a pair of the temporary use bandwidth and temporary use deadline. However, with the child node information 703b, the first entry includes the following pairs of (M-1) and (M-2).

(M-1) A pair of the temporary use bandwidth of 0.5 Mbps, and the temporary use deadline of 14:10:5.350

(M-2) A pair of the temporary use bandwidth of 0.3 Mbps, and the temporary use deadline of 14:10:5.372

The details of the temporary use bandwidth and temporary use deadline will be described later, but an overview thereof is as follows. The pair of the above (M-1) indicates the following (N-1) through (N-3), and the pair of the above (M-2) indicates the following (N-4) through (N-6).

(N-1) The selecting unit 411 has selected the child node corresponding to the first entry in response to the retransmission request that the communication device 400 has ever received, as a responsible node.

(N-2) Of the data packets (i.e., particular information) requested by the retransmission request in the above (N-1), a portion that the correlating unit 412 has correlated with the child node corresponding to the first entry is predicted to consume 0.5 Mbps of 3 Mbps of the transmittable total bandwidth.

(N-3) The transmission of data requested by the retransmission request in the above (N-1) is predicted to be completed by 14:10:5.350. That is to say, after 14:10:5.350, 0.5 Mbps is predicted to be reusable.

(N-4) The communication device 400 has further received a retransmission request different from the retransmission request in the above (N-1), and the selecting unit 411 has selected the child node corresponding to the first entry as a responsible node again.

(N-5) Of the data packets requested by the retransmission request in the above (N-4), a portion that the correlating unit 412 has correlated with the child node corresponding to the first entry is predicted to consume 0.3 Mbps.

(N-6) The transmission of data requested by the retransmission request in the above (N-4) is predicted to be completed by 14:10:5.372. That is to say, after 14:10:5.372, 0.3 Mbps is predicted to be reusable.

That is to say, the child node corresponding to an entry having a pair of the temporary used bandwidth and temporary use deadline is a node selected as a responsible node. Also, at least one node of a subgraph with the child node corresponding to an entry having a pair of the temporary used bandwidth and temporary use deadline as the root node is estimated to be now under the retransmission processing.

Now, the own node information 704a and 704b are examples of the own node information in two states at different time points. The own node information includes the IP address of the communication device 400 itself, the port number of the communication device 400 itself (specifically, reception port number), the transmittable bandwidth of the communication device 400 itself, and the transmittable total bandwidth of the communication device 400. Also, the own node information also includes, in the same way as with the child node information, zero pair, one pair, or multiple pairs of the temporary use bandwidth and temporary use deadline.

With the example of the own node information 704a and 704b, the IP address of the communication device 400 is 214.45.3.5, the port number of the communication device 400 is 50005, and the transmittable bandwidth of the communication device 400 is 5 Mbps. Also, as shown in the child node information 703a and 703b, with the example in FIG. 9, the number of child nodes is 2, and the transmittable total bandwidth informed from the child nodes are 3 Mbps and 10 Mbps. Therefore, according to Expression (1), the transmittable total bandwidth of the communication device 400 is 18 (=5+3+10) Mbps.

The own node information 704a does not include a pair of the temporary use bandwidth and temporary use deadline. On the other hand, the own node information 704b includes one pair of the temporary use bandwidth of 1.5 Mbps, and the temporary use deadline of 15:35:7.255. That is to say, the own node information 704b indicates the following (O-1) through (O-3).

(O-1) The selecting unit 411 has selected the communication device 400 itself as a responsible node in response to the retransmission request that the communication device 400 has ever received.

(O-2) Of the data packets (i.e., particular information) requested by the retransmission request in the above (O-1), a portion that the correlating unit 412 has correlated with the communication device 400 itself is predicted to consume 1.5 Mbps of 5 Mbps of the transmittable bandwidth.

(O-3) The retransmission requested by the retransmission request in the above (O-1) is predicted to be completed by 15:35:7.255. That is to say, after 15:25:7.255, 1.5 Mbps is predicted to be reusable.

Note that the parent node information 701, retransmission request destination information 702, child node information 703a through 703b, and own node information 704a through 704b include a port number, but these pieces of information may not include a port number depending on embodiments. For example, in the event that a fixedly unique port number has been determined by the data distribution application, various types of node information itself may not include a port number.

Now, description will be made next regarding processing that the communication device 400 in FIG. 5 executes with reception of a control packet other than a retransmission request as a trigger, with reference to FIG. 10. Note that the processing for taking reception of a retransmission request as a trigger will be described later along with FIG. 15 through FIG. 19.

Upon receiving a packet, the reception unit 401 of the communication device 400 distinguishes the type of the packet, for example, by referencing the type field of the header. In the event that the distinguished type is one of the control packets other than a retransmission request, the reception unit 401 starts the processing in FIG. 10.

In Operation S201, the reception unit 401 then determines whether or not the received control packet is the leaving notification from the parent node. In the event that the received control packet is the leaving notification from the parent node, the reception unit 401 outputs the received packet to the node information managing unit 409, and the processing proceeds to Operation S202. Also, in the event that another control packet has been received, the processing proceeds to Operation S203.

As shown in the above (I-13), when leaving from the logical network 100, a relay node informs the parent node of this relay node itself to the child nodes as a candidate of a new parent node of this child node. That is to say, the Operation S202 is processing in the child node which has received the notification in (I-13).

Specifically, in Operation S202, the node information managing unit 409 requests a new parent node informed from the parent node so far (i.e., the parent node of the parent node so far) to register the communication device 400 as a child node. Also, the node information managing unit 409 reads the transmittable total bandwidth of the communication device 400 from the own node information of the node information storage unit 408, and informs the transmittable total bandwidth of the communication device 400 to the new parent node.

Note that the request and notification as to the new parent node in Operation S202 may by realized by one control packet, for example. With the present embodiment, let us say that both of request and notification are included in one control packet. Accordingly, in Operation S202, the node information managing unit 409 specifically generates one control packet to be transmitted to the new parent node, and causes the transmission unit 402 to transmit the generated control packet.

Also, the node information managing unit 409 records the IP address and port number of the new parent node in the parent node information 701. The node information managing unit 409 may further measure RTT between the new parent node and the communication device 400 to record the measurement result in the “RTT” field of the parent node information 701. The processing then proceeds to Operation S207.

On the other hand, in the event that the control packet received by the reception unit 401 is not the leaving notification from the parent node, i.e., in the event that the received control packet is a message from an existing or new child node, in Operation S203 the reception unit 401 determines the kind of the message.

In the event that the received control packet is the leading notification from an existing child node, the reception unit 401 outputs the received packet to the node information managing unit 409, and the processing proceeds to Operation S204. Also, in the event that the received control packet is a request for requesting registration as a child node from a node which attempts to newly participate in the logical network 100, the reception unit 401 outputs the received packet to the node information managing unit 409, and the processing proceeds to Operation S205. Alternatively, in the event that the received control packet is a notification of the transmittable total bandwidth from an existing child node, the reception unit 401 outputs the received packet to the node information managing unit 409, and the processing proceeds to Operation S206.

In Operation S204, the node information managing unit 409 eliminates the entry corresponding to the child node which has transmitted the leaving notification from the child node information within the node information storage unit 408. The processing then proceeds to Operation S207. Note that elimination of an entry in Operation S204 is, as described in the above (L-4), one of causes leading to change in the transmittable total bandwidth of the communication device 400 itself.

Also, in Operation S205, the node information managing unit 409 adds the new entry to the child node information within the node information storage unit 408. The node information managing unit 409 sets the “IP address” field of the new entry to the IP address of the node of the request transmission source (i.e., new child node), and sets the “port number” field of the new entry to the port number informed from the new child node. The node information managing unit 409 may further measure RTT between the new child node and the communication device 400 to record the measurement result in the “RTT” field of the new entry.

Note that, as described regarding Operation S202, with the present embodiment, a request for requesting registration as a child node also serves as a notification of the transmittable total bandwidth of a node itself which transmits the request.

It is apparent that a new node which attempts to participate in the logical network 100 from now first becomes a leaf node. Accordingly, the transmittable total bandwidth of the new node is equal to the transmittable bandwidth of the new node itself. That is to say, the new node which attempts to participate in the logical network 100 from now may recognize the transmittable total bandwidth at the point of requesting for participation, and accordingly may inform the recognized transmittable total bandwidth.

Accordingly, in Operation S205, the node information managing unit 409 further sets the “transmittable total bandwidth” field of the added new entry to the transmittable total bandwidth informed from the new node. The processing then proceeds to Operation S207.

Also, in Operation S206, the node information managing unit 409 searches the entry corresponding to the child node which has transmitted a notification of the transmittable total bandwidth at the child node information of the node information storage unit 408. The node information managing unit 409 employs, for example, an IP address as a search key, whereby the entry corresponding to the child node that has transmitted a notification of the transmittable total bandwidth may be determined.

The node information managing unit 409 then rewrites the transmittable total bandwidth of the entry determined as a search result using the informed transmittable total bandwidth. The processing then proceeds to Operation S207.

The detection processing for detecting change in the transmittable bandwidth of the communication device 400 itself due to change in a network situation may be performed by the node information managing unit 409 at optional timing. For example, with the example in FIG. 10, the node information managing unit 409 checks the network situation with reception of a control packet other than a retransmission request as a trigger. However, it goes without saying that the node information managing unit 409 may periodically perform the detection processing regardless of reception of a control packet other than a retransmission request.

In Operation S207, the node information managing unit 409 checks up whether or not the network situation has been changed. In the event that the network situation has been changed, the processing then proceeds to Operation S208, and in the event that the network situation has not been changed, the processing proceeds to Operation S209.

Note that the node information managing unit 409 may also perform the inquiry in Operation S207 using a network band measurement tool, for example, such as “iperf”. For example, the node information managing unit 409 may estimate network bandwidth that the communication device 400 may use employing the network band measurement tool. Let us say that the estimation result has been 20 Mbps for convenience of description.

The node information managing unit 409 optionally determines the maximum value of bandwidth that the data distribution application uses within a range equal to or smaller than the estimated bandwidth (i.e., 20 Mbps). Let us say that the determined maximum value is 15 Mbps for convenience of description.

The node information managing unit 409 further calculates bandwidth that may be used for retransmission (i.e., transmittable bandwidth) by subtracting the bandwidth to be used for the original data distribution from the determined maximum value. For example, if we say that the bandwidth used for the original data distribution is 12 Mbps, the node information managing unit 409 calculates 3 (=15−12) as transmittable bandwidth.

In Operation S207, the node information managing unit 409 may determine whether or not the new transmittable bandwidth thus calculated is equal to the transmittable bandwidth of the own node information currently held in the node information storage unit 408. If the two transmittable bandwidths differ, the node information managing unit 409 determines that the network situation has been changed.

In Operation S208, the node information managing unit 409 records the new transmittable bandwidth according to the change detected in Operation S207. That is to say, the node information managing unit 409 updates the transmittable bandwidth of the own node information within the node information storage unit 408. The processing then proceeds to Operation S209.

In Operation S209, the node information managing unit 409 calculates the transmittable total bandwidth of the own node (i.e., communication device 400 itself), and then stores the calculation result in the “transmittable total bandwidth” field of the own node information. Note that the calculation in Operation S209 is calculation in accordance with Expression (1), and more specifically calculation for adding the transmittable bandwidth of the own node information, and the summation of the transmittable total bandwidth of all entries of the child node information.

Subsequently to Operation S209, in Operation S210 the node information managing unit 409 determines whether or not there is a parent node. Specifically, the node information managing unit 409 determines that there is no parent node if the parent node information 701 is empty, and determines that there is a parent node if the parent node information 701 is not empty. For example, the node information managing unit 409 in the distribution server 203 determines that there is no parent node, and the node information managing units 409 of the terminal device 205A through 205L determine that there is a parent node.

In the event that there is no parent node, the processing in FIG. 10 is also ended. Conversely, in the event that there is a parent node, the processing proceeds to Operation S211.

In Operation S211, the node information managing unit 409 generates a control packet for informing the transmittable total bandwidth calculated in Operation S209 to the parent node, and outputs the generated control packet to the transmission unit 402. In response to this, the transmission unit 402 transmits the control packet to the parent node. The processing in FIG. 10 is also ended.

For example, upon receiving the transmittable total bandwidth notification 603 from the Node N₂₃, the Node N₂₁ in FIG. 8 starts the processing in FIG. 10. The node information managing unit 409 of the Node N₂₁ updates the child node information in Operation S206, and generates the transmittable total bandwidth notification 605 address to the parent Node N₂₀ in Operation S211. As a result thereof, in Operation S211, the transmission unit 402 of the Node N₂₁ transmits the notification 605 to the Node N₂₀.

Now, description will be made next regarding various types of processing relating to distribution of data packets. The distribution server 203 which is the root node of the logical network 100 generates or obtains a content to be distributed, packetizes the content, and transmits the data packets to a child node. Also, a relay node or leaf node execute the processing of FIG. 11 with reception of a data packet as a trigger. Further, with a relay node or leaf node, the playing processing unit 404 reads out the data packets from the buffer unit 403 to perform playing processing in parallel with the processing in FIG. 11.

FIG. 11 is a flowchart of processing to be executed with reception of a data packet as a trigger. Specifically, upon the reception unit 401 of the communication device 400 equivalent to a relay node or leaf node receiving a data packet, the processing in FIG. 11 is started.

In Operation S301, the reception unit 401 extracts the sequence number of the received data packet (hereafter, referred to as “Q”). The reception unit 401 informs the extracted sequence number Q to the loss detecting unit 406. Note that, with the present embodiment, the data packets include a sequence number.

with distribution systems for streaming data, the RTP (Real-time Transport Protocol) is frequently employed. An RTP header includes the field of a sequence number. A sequence number to be used for Operation S301 and another Operation may be a sequence number included in the RTP header, or may be a sequence number included in a portion other than the RTP header.

In the next Operation S302, the loss detecting unit 406 determines whether or not the sequence number Q informed from the reception unit 401 is a number previously requested for retransmission. For example, in the event that the loss detecting unit 406 has ever detected the loss of No. 35 data packet, and this time the reception unit 401 has received the No. 35 data packet, the sequence number Q informed from the reception unit 401 is a number previously requested for retransmission.

In the event that the sequence number Q informed from the reception unit 401 is a number previously requested for retransmission, the processing then proceeds to Operation S309. Conversely, in the even that the sequence number Q informed from the reception unit 401 is not a number previously requested for retransmission, the processing proceeds to Operation S303.

In Operation S303, the loss detecting unit 406 detects whether or not there is packet loss. Here, the sequence number of the latest data packet that the communication device 400 has received will be referred to as “Qlast”, and called “latest received sequence number”. Therefore, the sequence number of a data packet scheduled to be received this time is (Qlast+1). Accordingly, the loss detecting unit 406 detects packet loss when Expression (2) holds.

Qlast+1<Q (2)

Specifically, in Operation S303, the loss detecting unit 406 determines whether or not Expression (2) holds. In the event that Expression (2) holds, the loss detecting unit 406 then determines that a packet has been lost, and the processing proceeds to Operation S304. Conversely, in the event that Expression (2) does not hold, the loss detecting unit 406 determines that no packet has been lost, and the processing proceeds to Operation S308.

Note that the loss detecting unit 406 holds the value of the latest received sequence number Qlast for determination in Operation S303. The initial value of the latest received sequence number Qlast may be, for example, determined to be a particular value such as 0 by the data distribution application, or may be informed by a control packet beforehand.

Also, the loss detecting unit 406 may detect packet loss in an optional known procedure different from Operation S303 depending on embodiments. For example, in the event that switching of the order of data packets is assumed, a more complicated detection procedure than Operation S303 may be employed.

With the loss detecting unit 406, the retransmission control according to the present embodiment may be applied thereto regardless of a procedure for detecting packet loss. In FIG. 11, for simplification of description, a simple detection procedure such as Operation S303 is exemplified.

In Operation S304, the loss detecting unit 406 informs occurrence of packet loss to the retransmission request unit 407. In response to this, the retransmission request unit 407 determines a retransmission request destination.

As described above, the node information managing unit 409 inquires the retransmission request destination as to the management server 204 via the transmission unit 402 beforehand or with detection of packet loss by the loss detecting unit 406 as a trigger. This, in Operation S304, retransmission request destination information 702 exists at the node information storage unit 408. Accordingly, the retransmission request unit 407 may determine the retransmission request destination by referencing the retransmission request destination information 702.

Also, in the next Operation S305, the loss detecting unit 406 calculates a retransmission range, and outputs the calculation result to the retransmission request unit 407. Specifically, the loss detecting unit 406 calculates the range of the sequence numbers of data packets to be retransmitted in accordance with Expressions (3) and (4), and outputs the calculation result to the retransmission request unit 407.

Qfrom=Qlast+1 (3)

Qto=Q−1 (4)

For example, let us say that the data packets up to No. 100 have already been received, and the sequence number of the data packet received this time is No. 110. Thus, Qlast=100 and also Q=110 hold. That is to say, No. 101 through No. 109 data packets have been lost, and accordingly, the retransmission range is No. 101 through No. 109. According to Expression (3), the start number of the retransmission range Qfrom=100+1=101 holds, and according to Expression (4), the end number of the retransmission range Qto=110−1=109 holds.

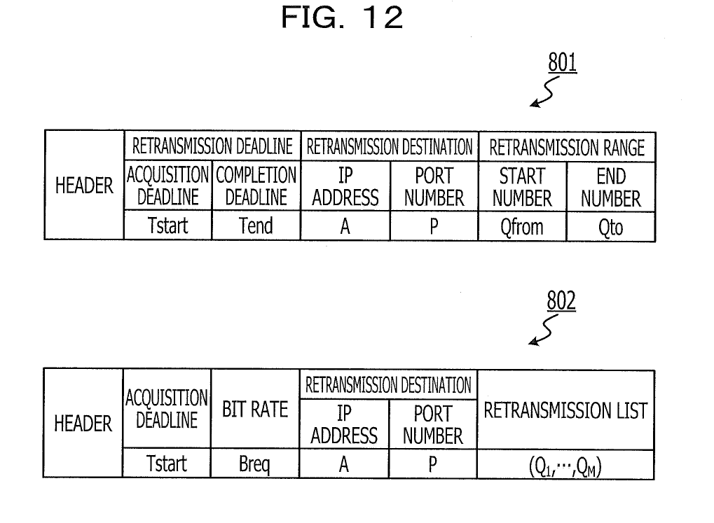

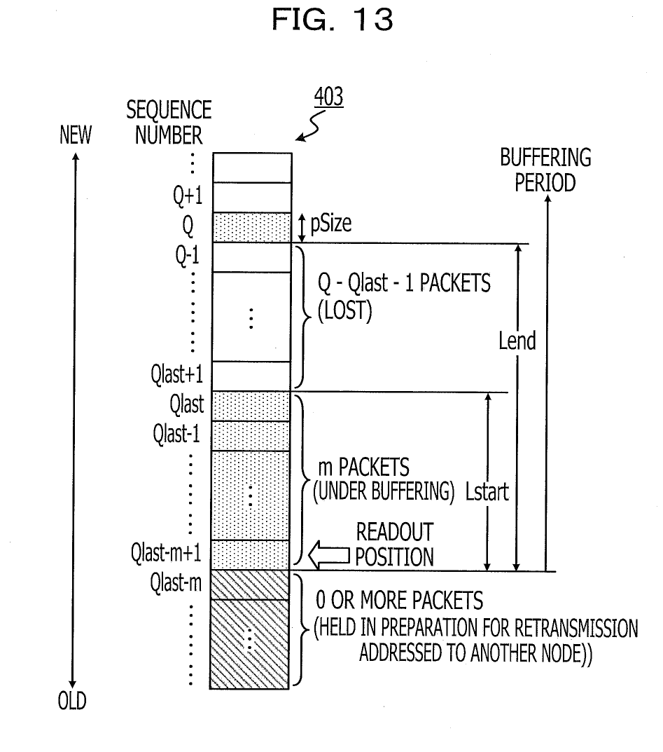

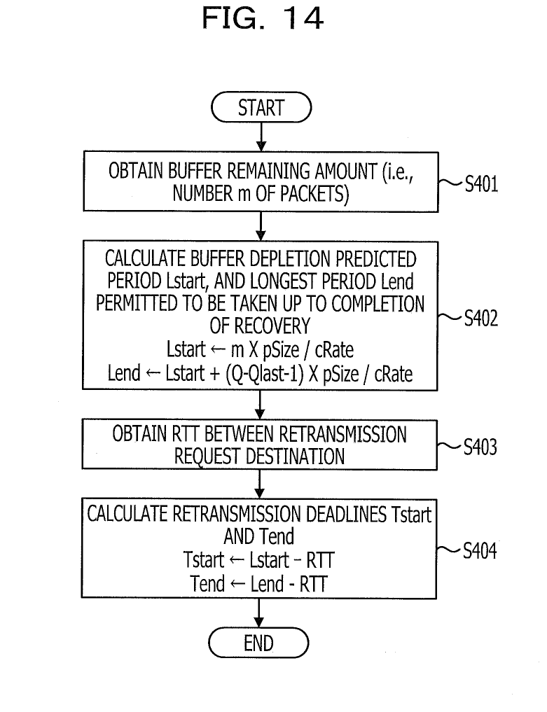

Next, in Operation S306, the retransmission request unit 407 calculates “retransmission deadline” as shown in FIG. 14. Here, the retransmission deadline will be described with reference to FIG. 12 and FIG. 13.

FIG. 12 is a diagram indicating an example of a retransmission request packet. As shown in FIG. 12, a retransmission request packet 801 according to the present embodiment includes a header, two fields indicating a retransmission deadline, and two fields indicating a retransmission destination, and two fields indicating a retransmission range.

The header of the retransmission request packet 801 includes, for example, an IP header and a UDP header. Also, the header of the retransmission request packet 801 may further include the header of an upper layer than the UDP (e.g., RTP header, the original header of the data distribution application, or both thereof). For example, a type field indicating the kind of a packet may be included in the original header of the data distribution application.

The retransmission deadline is specifically represented with a pair of “acquisition deadline” (hereafter, referred to as “Tstart”) and “completion deadline” (hereafter, refereed to as “Tend”).

The acquisition deadline is a deadline derived from a constraint condition regarding when the communication device 400 which has detected packet loss should start obtaining of data packets specified with the retransmission range by. If description will be made from another viewpoint, the acquisition deadline relates to the deadline of transmission start.

Also, the completion deadline is a deadline derived from a constraint condition regarding when the communication device 400 which has detected packet loss should end obtaining of data packets specified with the retransmission range by. If description will be made from another viewpoint, the completion deadline relates to the deadline of transmission end.

The retransmission destination is specifically represented by a pair of an IP address (hereafter, referred to as “A”), and a port number (hereafter, referred to as “P”). That is to say, the IP address A of the communication device 400 which has detected packet loss, and the port number (e.g., UDP port number) P for the communication device 400 which has detected packet loss receiving data packets are set to the retransmission request packet 801 as the retransmission destination.

Also, the retransmission range is represented with a pair of the start number Qfrom and the end number Qto. The retransmission range indicates the range of “particular information” described regarding FIG. 1.

Note that, as described regarding FIG. 1, each time a child node is selected as a responsible node, and retransmission is left to the child node, the range of the particular information is rewritten. For example, the start number Qfrom and end number Qto specified in the retransmission request packet 801 that the communication device 400 which has detected packet loss transmits are as shown in Expressions (3) and (4). However, the start number Qfrom and end number Qto specified in the retransmission request packet 801 addressed to the child node in the event that retransmission is left to a child node are values to be calculated as will be described later.

Note that a format including a field specifying a bit rate (hereafter, referred to as “Breq”) may be employed such as the retransmission request packet 802 depending on embodiments. An embodiment where a format such as the retransmission request packet 802 is employed will be described later.

Also the orders of the fields in the retransmission request packets 801 and 802 are only one instance. It goes without saying that a packet of a suitable format may be employed according to embodiments.

FIG. 13 is a diagram illustrating a model of buffering and the retransmission deadline. The buffer unit 403 in FIG. 5 has a similar configuration to an FIFO (First In First Out) configuration. Specifically, as shown in FIG. 13, the buffer unit 403 stores the received data packets in the order of the sequence numbers. In FIG. 13, each of rectangles indicates a data packet, and the older a data packet is (i.e., the smaller sequence number a data packet has), the lower this data packet is drawn.

The data packet received by the reception unit 401 is temporarily buffered in the buffer unit 403, and read out and played by the playing processing unit 404. FIG. 13 schematically illustrates the state of the buffer unit 403 at the time of packet loss being detected.

Note that a white arrow points to the data packet to be read out by the playing processing unit 404, indicating the readout position pointer. Also, an arrow indicating a period wherein data packets are buffered in the buffer unit 403 is schematically illustrated with a readout position as a reference.

The buffer unit 403 is buffering m (1≦m) data packets that have already received but not played yet. Specifically, m data packets of which the sequence numbers are from No. (Qlast−m+1) to No. Qlast are buffered in the buffer unit 403 in preparation for readout by the playing processing unit 404.

As described along with Operations S303 through S304, let us say that the (Q−Qlast−1) data packets of which the sequence numbers are from No. (Qlast+1) to No. (Q−1) have been eliminated, and the data packet of which the sequence number is No. Q has been received this time.

Note that the buffer unit 403 may store data packets of which the sequence numbers are older than No. (Qlast−m+1) (i.e., data packets already read out by the playing processing unit 404) in preparation for retransmission addressed to another node.

Also, the buffer unit 403 may be realized by the RAM 302 and CPU 301, for example. The RAM 302 holds data packets. The CPU 301 manages the pointer at a readout position, and also performs aging processing for eliminating older data packets. Data packets to be eliminated by the aging processing are, for example, data packets yet older than the data packet the pointer at the readout position that points to (or a predetermined number of latest data packets of the already-read data packets to be held for retransmission).

The longer the buffering period in the buffer unit 403 is, the more the recovery capability according to the retransmission processing improves. However, the longer the buffering period is (in other words, the greater m is), the longer delay time from reception to playing according to the playing processing unit 404 is.

That is to say, the recovery capability and delay time have a trade-off relation. Accordingly, it is desirable to determine the value of m that stipulates the buffering period as appropriate according to embodiments in the light of trade-off.

With the example in FIG. 13, at the time of packet loss being detected with reception of the data packet of which the sequence number is No. Q as a trigger, m data packets of which the sequence numbers are No. (Qlast−m+1) to No. Qlast are buffered in the buffer unit 403. Also, for simplification of description, with the present embodiment, let us say that the data packets have fixed length, and the sizes of the data packets are referred to as “pSize”.

Accordingly, a period taken until all of the data packets remained in the buffer unit 403 are spent and depleted (i.e., a period taken until the playing processing unit 404 has read all of the m data packets) is as shown in “Lstart” in Expression (5). Note that “cRate” in Expression (5) is the buffer consumption rate according to the playing processing unit 404.

Lstart=m×pSize/cRate (5)

That is to say, in order to prevent a content to be played (e.g., moving image or audio) from skipping, storage processing of the data packet of which the sequence number is No. (Qlast+1) as to the buffer unit 403 has to be started at least before the period Lstart elapses. Also, if the playing processing unit 404 continues playing at the buffer consumption rate cRate, a period taken until playing of all of the eliminated (Q−Qlast−1) data packets is completed is as shown in “Lend” in Expression (6).

Lend=Lstart+(Q−Qlast−1)×pSize/cRate (6)

That is to say, the period Lend is a period obtained by adding the periods taken for reading out of all of the eliminated (Q−Qlast−1) data packets to the period Lstart. In other words, the period Lend is the longest period permitted for recovery of packet loss.

The acquisition deadline Tstart and completion deadline Tend in the retransmission request packet 801 in FIG. 12 that the communication device 400 which has detected packet loss transmits are set based on the period Lstart and period Lend, respectively. Specifically, the retransmission request unit 407 performs the processing in FIG. 14 equivalent to Operation S306 in FIG. 11, and accordingly, the acquisition deadline Tstart and completion deadline Tend are calculated. FIG. 14 is a flowchart of processing for calculating retransmission deadline.

First, in Operation S401, the retransmission request unit 407 obtains the remaining amount of the buffer unit 403. Specifically, the retransmission request unit 407 obtains the number m of the data packets that the buffering unit 403 is buffering from the sequence number (Qlast m+1) that the pointer of the readout position of the buffer unit 403 points to, and the latest received sequence number Qlast.

In the next Operation S402, the retransmission request unit 407 then calculates the buffer depletion predicted period Lstart, and the longest period Lend permitted to be taken up to completion of recovery in accordance with the above Expressions (5) and (6).

Also, in the next Operation S403, the retransmission request unit 407 obtains RTT between the retransmission request destination determined in Operation S304 in FIG. 11 and the communication device 400. With the present embodiment, the RTT has already been obtained and stored in the retransmission request destination information 702, whereby the retransmission request unit 407 may obtain the RTT by referencing the retransmission request destination information 702 within the node information storage unit 408.

In Operation S404, the retransmission request unit 407 calculates a retransmission deadline to be set to the retransmission request packet 801 (i.e., the acquisition deadline Tstart and completion deadline Tend). Specifically, the retransmission request unit 407 calculates, as shown in Expression (7), the acquisition deadline Tstart by subtracting the RTT obtained in Operation S403 from the period Lstart calculated in Operation S402. Also, the retransmission request unit 407 calculates, as shown in Expression (8), the completion deadline Tend by subtracting the RTT obtained in Operation S403 from the period Lend calculated in Operation S402.

Tstart=Lstart−RTT (7)

Tend=Lend−RTT (8)

For example, let us say that Lstart=25 ms, Lend=40 ms, and RTT=6 ms, and the current point-in-time is 10:20:30.400. In this case, storing in the buffer unit 403 of the data packet of which the sequence number is No. (Qlast+1) has to be started until 10:20:30.425. Also, storing in the buffer unit 403 of the data packet of which the sequence number is No. (Q−1) has to be ended until 10:20:30.440.

On the other hand, the communication period from the communication device 400 to the retransmission request destination is 3 ms that is a half of the RTT, and accordingly, if we say that the retransmission request packet 801 is transmitted right now, it is 10:20:30.403 when the retransmission request packet 801 is arrived at the retransmission request destination. Also, according to Expressions (7) and (8), Tstart=25−=19 ms, and Tend=40−6=34 ms.

Now, let us say that the node of the retransmission request destination selects itself as a responsible node, and starts to transmit data packets after Tstart=19 ms elapses since reception of the retransmission request packet 801 (i.e., 10:20:30.422). In this case, it is after 3 ms (=RTT/2) thereof, i.e., 10:20:30.425 that the transmitted data packets are started to be received at the communication device 400. Accordingly, storing of the transmitted data packets is started before the data packets remaining in the buffer unit 403 are depleted.

Similarly, let us say that the node of the retransmission request destination selects itself as a responsible node, and completes transmission of data packets after Tend=34 ms elapses after reception of the retransmission request packet 801 (i.e., 10:20:30.437). In this case, it is after 3 ms (=RTT/2) thereof, i.e., 10:20:30.440 that reception of the transmitted data packets at the communication device 400 is completed. Accordingly, recovery according to retransmission is completed for a period within the allowable range.

The reason why subtraction of the RH is performed in Expressions (7) and (8) is as may be understood from the above specific numeric example, for example. Note that, in Expressions (7) and (8), subtraction of the RH is performed, but a suitable positive margin may further be subtracted in the light of the processing delay of the communication device 400 and so forth. After the acquisition deadline Tstart and completion deadline Tend are calculated as described above, the processing then proceeds to Operation in S307 in FIG. 11.

In Operation S307, the retransmission request unit 407 generates a retransmission request packet 801, and outputs to the transmission unit 402. The transmission unit 402 then transmits the retransmission request packet 801. Specifically, the retransmission request unit 407 generates the header of the retransmission request packet 801, sets the values obtained in Operations S305 and S306 as the retransmission deadline and retransmission range, respectively, and sets the IP address and port number of the communication device 400 itself as the retransmission destination.

Note that the retransmission request unit 407 may recognize the IP address of the communication device 400 itself by referencing the own node information within the node information storage unit 408. Also, a port number P to be set to the retransmission request packet 801 may be defined as a constant within the data distribution application, or may be set to the own node information as shown in FIG. 9, and in any way, the retransmission request unit 407 may recognize this port number P.

After transmission of the retransmission request packet 801 in Operation S307, or in the event that packet loss has not been detected in Operation S303, the processing in Operation S308 is performed. Specifically, the loss detecting unit 406 updates the latest received sequence number Qlast to the sequence number Q obtained in Operation S301. The processing then proceeds to Operation S309.

In Operation S309, the reception unit 401 stores the data packet received this time (i.e., the data packet of which the sequence number is No. Q) in the buffer unit 403.

Next, in Operation S310, the transfer processing unit 405 references the child node information within the node information storage unit 408, thereby determining whether or not there is a child node in the communication device 400. In the event that there is a child node, the processing proceeds to Operation S311. In the event that there is no child node, the processing in FIG. 11 is also ended.

In Operation S311, the transfer processing unit 405 transfers the data packet received this time (i.e., the data packet of which the sequence number is No. Q) to the child nodes that the child node information indicates, via the transmission unit 402. The processing in FIG. 11 is then ended.

Now, description will be made next regarding the processing for taking reception of a retransmission request packet as a trigger, with reference to FIG. 15 through FIG. 19.

FIG. 15 is a diagram schematically illustrating a specific example of the retransmission control according to the present embodiment. The overview of the retransmission control according to the present embodiment is as described along with FIG. 1. However, more specifically, a node which has received a retransmission request selects, while taking the transmittable total bandwidth of the child nodes, and the constraint condition relating to the retransmission deadline described along with FIG. 11 through FIG. 14 into consideration, a suitable child node as a responsible node, and determines the amount of the particular information to be assigned to the responsible nodes. FIG. 15 is a diagram exemplifying processing in a case where a node which has received a retransmission request leaves retransmission to a child node by transferring the retransmission request to the child node, and also the node itself takes charge of part of the retransmission processing.

The logical network 100b in FIG. 15 is an extraction of a portion of a certain logical network. The logical network 100b includes Nodes N₃₀ through N₃₅. Also, the Node N₃₁ is a child node of the Node N₃₀, and the Nodes N₃₃ through N₃₅ are child nodes of the Node N₃₂. Note that the Nodes N₃₁ and N₃₃ through N₃₅ may be leaf nodes or relay nodes.

As described along with FIG. 8 through FIG. 10, the Node N₃₃ transmits a notification 901 of the transmittable total bandwidth Total(N₃₃) of the Node N₃₃ to the parent Node N₃₂ at suitable timing. Similarly, the Node N₃₄ also transmits a notification 902 of the transmittable total bandwidth Total(N₃₄) of the Node N₃₄ to the parent Node N₃₂ at suitable timing. Also, the Node N₃₅ also transmits a notification 903 of the transmittable total bandwidth Total(N₃₅) of the Node N₃₅ to the parent Node N₃₂ at suitable timing.

Also, distribution of data packets is performed with the logical network 100b independent from transmission of the notifications 901 through 903 of the transmittable total bandwidth. FIG. 15 illustrates distribution of data packets 904 of which the sequence numbers are No. 41 through No. 49 of a series of data packets.

Specifically, the No. 41 through No. 49 data packets 904 are distributed within the logical network 100b and received at the Node N₃₀. In response to this, the Node N₃₀ transfers the No. 41 through No. 49 data packets 904 to the child Node N₃₁. However, with the example in FIG. 15, the No. 41 through No. 49 data packets 904 are eliminated on a communication path equivalent to an edge between the Nodes N₃₀ and N₃₁ due to a certain cause.

Also, the No. 41 through No. 49 data packets 904 are distributed within the logical network 100b and also received at the Node N₃₂. In response to this, the Node N₃₂ transfers the No. 41 through No. 49 data packets 904 to the child Nodes N₃₃ through N₃₅. With the example in FIG. 15, any of the Nodes N₃₃ through N₃₅ succeeds reception of the No. 41 through No. 49 data packets 904.

Incidentally, the Node N₃₁ receives No. 50 data packet next to a data packet of which the sequence number is No. 40. Accordingly, the Node N₃₁ detects, according to the processing in Operation S303 in FIG. 11, that the No. 41 through No. 49 data packets 904 have been eliminated (because Qlast=40 and also Q=50 in Operation S303). The Node N₃₁ then selects the Node N₃₂ as the retransmission request destination in Operation S304.

Further, the Node N₃₁ calculates the retransmission range as No. 41 through No. 49 in Operation S305. Also, the Node N₃₁ calculates the retransmission deadline in Operation S306, and transmits a retransmission request 905 that specifies the retransmission range and retransmission deadline in Operation S307. In FIG. 15, the retransmission range specified in the retransmission request 905 is represented as “#41-#49”.

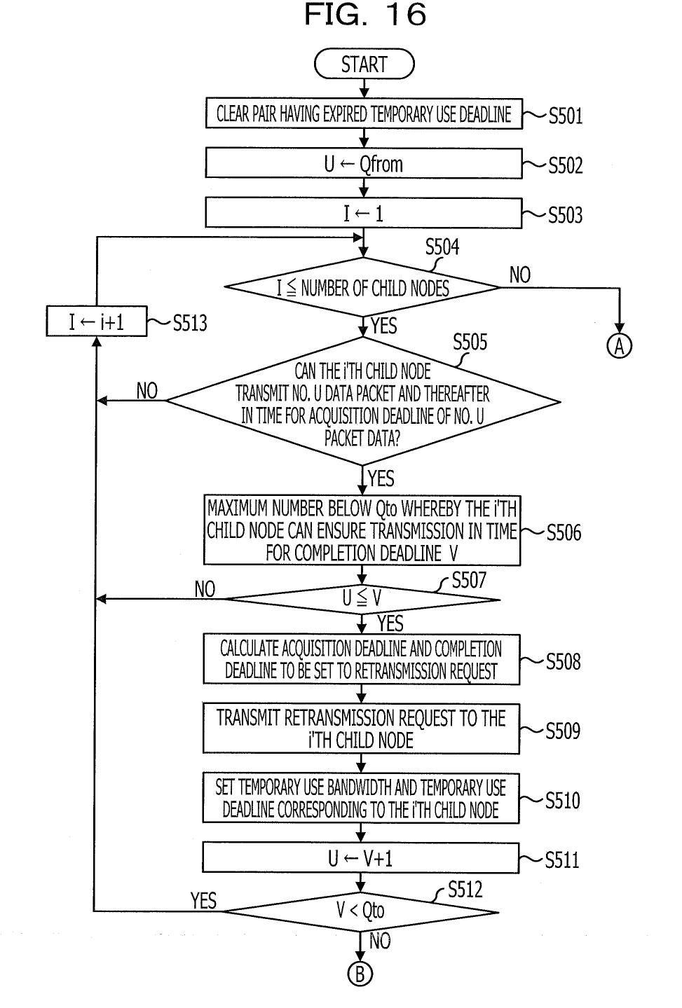

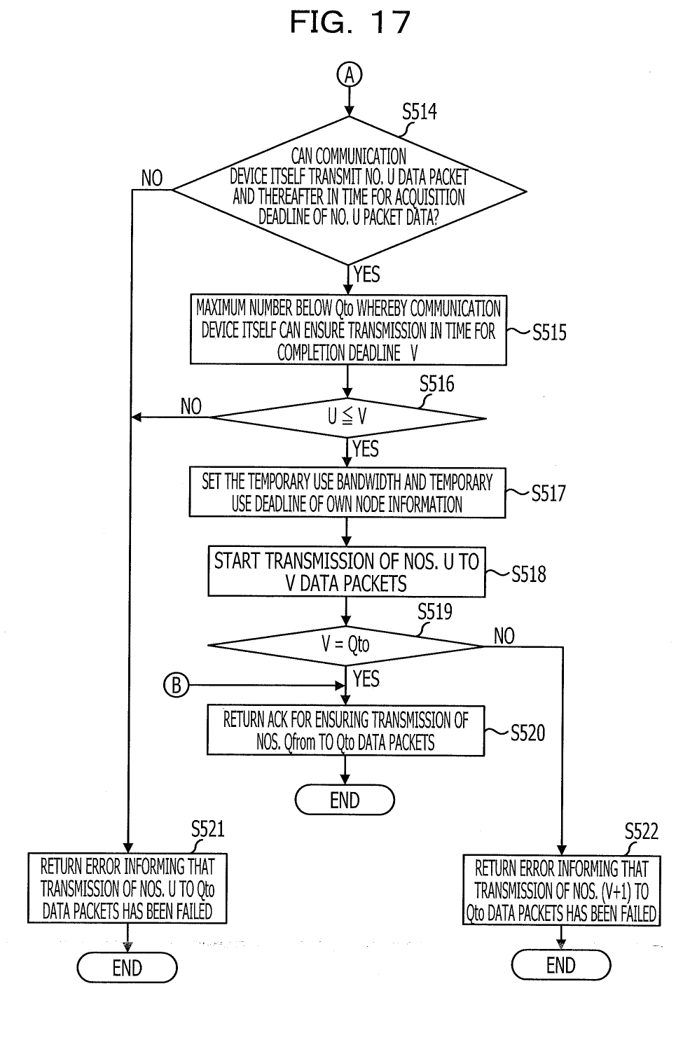

With the processing that the Node N₃₂ performs with reception of the retransmission request 905 as a trigger, the details will be described later along with FIG. 16 and FIG. 17, but the overview is as described regarding FIG. 1. Specifically, the Node N₃₂ selects a responsible node by prioritizing the child Nodes N₃₃ through N₃₅ over the Node N₃₂ itself.

At the time of selection of a responsible node, and assignment to the responsible nodes, the Node N₃₂ considers the retransmission deadline specified in the retransmission request 905, and the transmittable total bandwidth of the child nodes informed from the notifications 901 through 903 the child Nodes N₃₃ through N₃₅ respectively. Specifically, even in the event of having left retransmission to a child node, the Node N₃₂ distinguishes a child serving as a responsible node so as to satisfy a constraint condition regarding the retransmission deadline. Also, even in the event of having left retransmission to a child node, the Node N₃₂ determines a retransmission range to be assigned to a child node selected as a responsible node so as to satisfy a constraint condition regarding the retransmission deadline.

With the example in FIG. 15, the Node N₃₂ selects the Node N₃₃ as a responsible node, and also assigns the No. 41 through No. 43 data packets to the Node N₃₃. That is to say, the Node N₃₂ transmits a retransmission request 906 that specifies No. 41 through No. 43 as a retransmission range to the Node N₃₃. In other words, the Node N₃₂ transfers the received retransmission request to the Node N₃₃, but rewrites the received retransmission request 905 such as the retransmission request 906 at the time of transfer.

Also, the Node N₃₂ selects the Node N₃₄ as a responsible node, and also assigns the No. 44 trough No. 46 data packets to the Node N₃₄. That is to say, the Node N₃₂ transmits a retransmission request 907 that specifies No. 44 through No. 46 as a retransmission range to the Node N₃₄. In other words, the Node N₃₂ transfers the received retransmission request to the Node N₃₄, but rewrites the received retransmission request 905 such as the retransmission request 907 at the time of transfer.

Further, the Node N₃₂ selects the Node N₃₅ as a responsible node, and also assigns the No. 47 and No. 48 data packets to the Node N₃₅. That is to say, the Node N₃₂ transmits a retransmission request 908 that specifies No. 47 and No. 48 as a retransmission range to the Node N₃₅. In other words, the Node N₃₂ transfers the received retransmission request to the Node N₃₅, but rewrites the received retransmission request 905 such as the retransmission request 908 at the time of transfer.

With the example in FIG. 15, even if the Node N₃₂ preferentially selects a child node as a responsible node as described above, the No. 49 data packet is still remained. Therefore, the Node N₃₂ finally selects the Node N₃₂ itself as a responsible node, and assigns the remaining No. 49 data packet to the Node N₃₂ itself.

The Node N₃₃ which has received the retransmission request 906 may preferentially select, if this node has a child node, the child node as a responsible node, but with the example in FIG. 15, the Node N₃₃ itself transmits the No. 41 through No. 43 data packets 909 to the Node N₃₁. Similarly, the Node N₃₄ which has received the retransmission request 907 transmits the No. 44 through No. 46 data packets 910 to the Node N₃₁, and the Node N₃₅ which has received the retransmission request 908 transmits the No. 47 and No. 48 data packets 911 to the Node N₃₁. Also, the Node N₃₂ transmits the No. 49 data packet 912. As a result thereof, the Node N₃₁ receives the No. 41 through No. 49 data packets.

Next, the processing that the communication device 400 executes with reception of a retransmission request as a trigger will be described with reference to FIG. 16 and FIG. 17. Upon the reception unit 401 of the communication device 400 equivalent to the root node, a relay node, or a leaf node receiving the retransmission request packet 801 in FIG. 12, and outputting the retransmission request packet 801 to the load distribution processing unit 410, the load distribution processing unit 410 starts the processing in FIG. 16 and FIG. 17.

With the processing in FIG. 16 and FIG. 17, Operations S501 through S503 are operations for initialization. Also, Operations S504 through S513 are operations for selecting a responsible node out of child nodes, and correlating the selected responsible node with partial particular information that is a portion or all of the requested particular information. Operations S514 through S519 are operations for selecting the communication device 400 itself as a responsible node according to need, and correlating the communication device 400 itself selected as a responsible node with partial particular information that is a portion or all of the requested particular information. Operations S520 through S522 are operations for directly returning ACK or NACK to the node of the transmission source of the retransmission request packet 801.

In Operation S501, with the child node information stored in the node information storage unit 408, of pairs of the temporary use bandwidth and temporary use deadline, if there is a pair of which the temporary use deadline has been expired, the selecting unit 411 clears this pair. Similarly, with the own node information stored in the node information storage unit 408, of pairs of the temporary use bandwidth and temporary use deadline, if there is a pair of which the temporary use deadline has been expired, the selecting unit 411 clears this pair.

Next, in Operation S502, the selecting unit 411 reads the start number Qfrom specified in the retransmission request packet 801 received from the reception unit 401. The selecting unit 411 then initializes a variable U by substituting the value of the read start number Qfrom for the variable U. The variable U indicates the sequence number of the first data packet of which the responsible node has not been determined of the No. Qfrom through No. Qto data packets that have been requested for transmission.

Also, in the next Operation S503, the selecting unit 411 initializes to 1 a variable i indicating an index for selecting a responsible node.

In the next Operation S504, the selecting unit 411 determines whether or not the value of the variable i is equal to or smaller than the number of child nodes of the communication device 400 (i.e., the number of entries of the child node information).

In the event that the value of the variable i is equal to or smaller than the number of child nodes of the communication device 400, there is remained a child node which has not been focused yet as a responsible node candidate. Therefore, the processing proceeds to Operation S505.

Conversely, a case where the value of the variable i is greater than the number of child nodes of the communication device 400 is a case of the next (P-1) or (P-2). In the case of (P-1) or (P-2), in order to determine whether to select the communication device 400 itself as a responsible node, the processing proceeds to Operation S514 in FIG. 17.

(P-1) The communication device 400 does not have a child node at all.

(P-2) The communication device 400 has one or more child nodes. The selecting unit 411 has already focused on all of the child nodes of the communication device 400 as a responsible node candidate. However, of the No. Qfrom through No. Qto data packets that have been requested for transmission, there is one or more data packets that have remained without being assigned to a responsible node.

In Operations S505 through S507, the selecting unit 411 determines whether or not the i'th child node may be selected as a responsible node. Specifically, first in Operation S505, the selecting unit 411 determines whether or not the i'th child node may ensure to transmit the U'th data packet and thereafter in time for the acquisition deadline of the U'th data packet.

More specifically, the selecting unit 411 estimates delay (hereafter, referred to as “α”) using a suitable approximation model, and determines whether or not Expression (9) is satisfied using the estimated a.

Tstart+(Tend−Tstart)×(U−Qfrom)/(Qto−Qfrom+1)−α>0 (9)

Note that, in Expression (9), Tstart and Tend are, as shown in FIG. 12, the values of the acquisition deadline and completion deadline set to the retransmission request packet 801 received by the reception unit 401. Also, in Expression (9), Qfrom and Qto are the values of the start number and end number set to the retransmission request packet 801 received by the reception unit 401. Description will be made below regarding the meaning of Expression (9) by being divided into a case of a state in which the variable U has been initialized, and a case where the value of the variable U has been updated in later-described Operation S511.

In the event that Operation S505 has been executed in a state in which the variable U has been initialized in Operation S502, U=Qfrom holds. Accordingly, at the time of a state in which the variable U has been initialized, Expression (9) is rewritten such as Expression (10).

Tstart−α>0 (10)

Expression (10) indicates a constraint condition regarding whether or not there is no problem even if the communication device 400 leaves transmission of the first data packet (i.e., No. Qfrom data packet) requested by the retransmission request packet 801 received by the reception unit 401 is left to the i'th child node. Specifically, if the period that the acquisition deadline Tstart specified by the retransmission request packet 801 indicates is longer than the delay α predicted to occur in the event that the communication device 400 leaves transmission of the data packet to the i'th child node, transfer is acceptable. The delay α includes the following (Q-1) through (Q-4).

(Q-1) Delay due to the internal processing of the communication device 400 itself

(Q-2) Communication delay due to a notification for the communication device 400 leaving transmission of the data packet to the i'th child node (i.e., transmission of a new retransmission request packet 801)

(Q-3) Delay due to the internal processing of the i'th child node

(Q-4) Difference between communication delay to be taken in the event that the i'th child node transmits the data packet to a request node which has requested retransmission of the data packet, and communication delay to be taken in the event that the communication device 400 itself transmits the data packet to the request node

How to estimate the above (Q-1) through (Q-4) may vary according to embodiments. That is to say, the approximation model for estimating the delay α varies according to embodiments.

For example, the delay in (Q-1) depends on the capability of the CPU 301 of the computer 300 for realizing the communication device 400. Therefore, an arrangement may be made wherein the communication device 400 executes the processing in FIG. 16 and FIG. 17 beforehand using, for example, dummy node information and a dummy retransmission request packet, and measures the period taken for execution as the delay period in (Q-1).

Alternatively, depending on embodiments, according to preliminary experiments or the like, the delay in (Q-1) may be represented as a function of an index (e.g., clock frequency) indicating the capability of the CPU 301. In this case, the selecting unit 411 may calculate the delay in (Q-1) from the index representing the capability of the CPU 301 in accordance with this function.

Similarly, the delay in (Q-3) also depends on the capability of the CPU 301 of the computer 300 for realizing the i'th child node. Also, the delay in (Q-3) may also be obtained, according to the same method as with the delay in (Q-1), by the i'th child node measuring the delay beforehand, or calculating the delay from the function beforehand.

The i'th child node informs the delay in (Q-3) obtained by measurement or calculation to the communication device 400 which is the parent node beforehand, whereby the communication device 400 (the selecting unit 411 of the load distribution processing unit 410) may recognize the delay in (Q-3). Alternatively, the i'th child node may inform the index indicating the capability of the CPU 301 of the i'th child node to the communication device 400 which is the parent node.

Note that, in the event that the delay itself in (Q-3) is informed as well, and in the event that the index indicating the capability of the CPU 301 of the i'th child node is informed as well, the notification from the i'th child node may be included in the same control packet as with the notification of the transmittable total bandwidth described regarding FIG. 8 or FIG. 10, for example. The communication device 400 which has received the notification may record the contents informed from the i'th child node in the child node information within the node information storage unit 408. The selecting unit 411 may recognize the delay in (Q-3) by performing calculation according to need with reference to the child node information.

It goes without saying that the selecting unit 411 may recognize the delay in (Q-1) and (Q-3) in accordance with a more simple approximation model depending on embodiments. For example, an approximation model based on assumption to the effect that all of the nodes within the logical network 100 have the CPU 301 having a certain level of capability. The selecting unit 411 may regard a constant value assumed as internal delay due to the above certain level of CPU 301, as the delay in (Q-1) and (Q-3).

Also, it is reasonable to estimate the delay in (Q-2) to be a half of the RTT between the communication device 400 and the i'th child node. The RTT between the communication device 400 and the i'th child node is, as described regarding FIG. 9, recorded in the node information storage unit 408 as part of the child node information. Accordingly, the selecting unit 411 may recognize the delay in (Q-2) by referring the child node information.

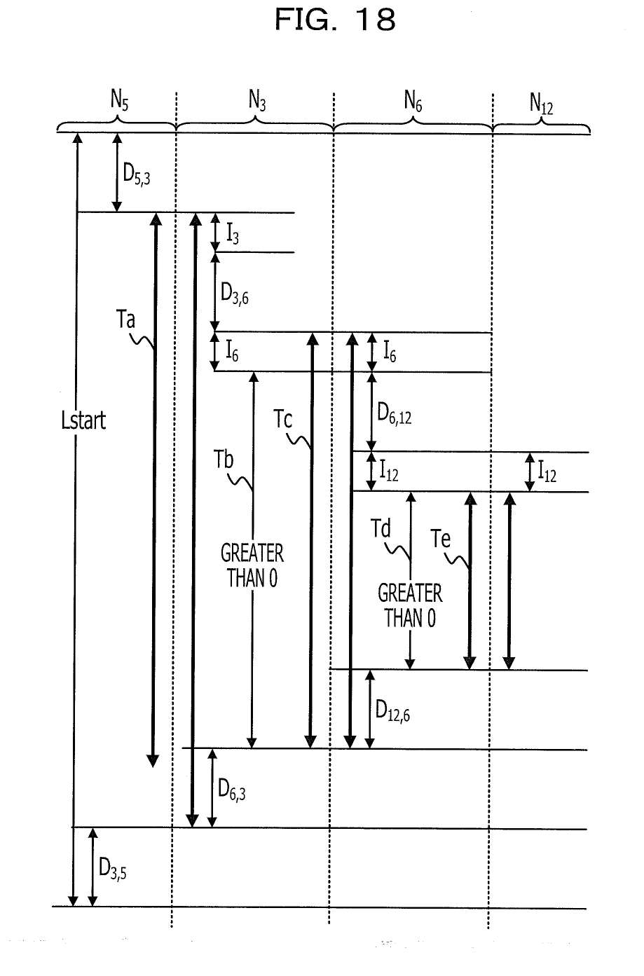

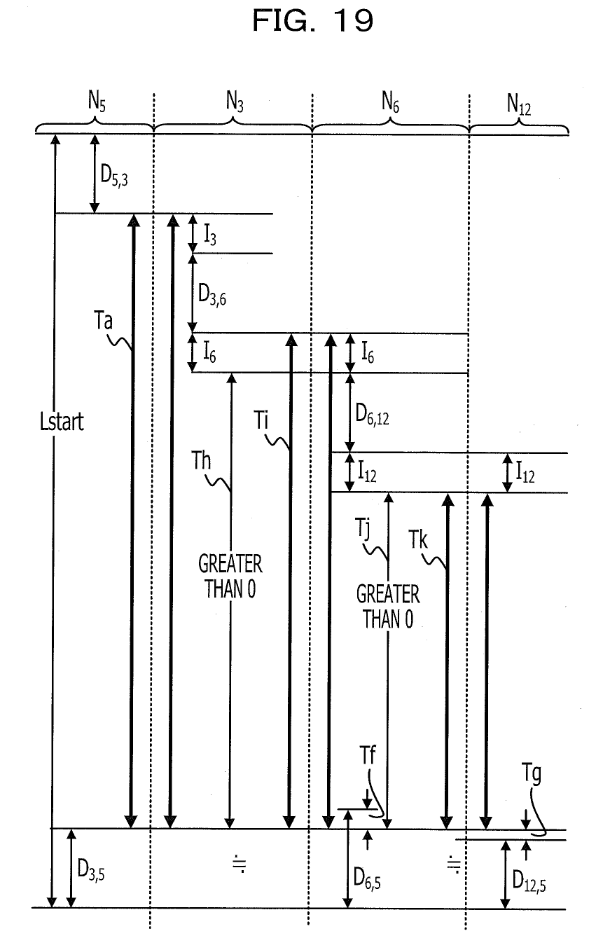

Incidentally, though the details will be described later, with regard to the length of the period in (Q-4), in the event that the topology of the logical network 100 has not been changed, and a retransmission request occurs from the same request node twice or more, estimation based on the actual measurement value may be made at the second retransmission and thereafter. However, at the time of the first retransmission request from a certain request node, there is no actual measurement value serving as the basis to estimate the length of the period in (Q-4) at the time of the first retransmission request from a certain request node, the length of the period in (Q-4) is estimated using a certain approximation model. Therefore, examples of two approximation models will be described with reference to FIG. 18 and FIG. 19.

FIG. 18 and FIG. 19 are diagrams for describing an example wherein whether or not a constraint condition regarding the acquisition deadline is satisfied is determined using first and second approximation models, respectively. Also, the determination in FIG. 18 and FIG. 19 is performed in the event that the Node N₅ first transmits a retransmission request to the Node N₃. Transfer from the Node N₃ to the Node N₆ indicates an example of transfer from the Node N₆ to the Node N₁₂.

Also, in FIG. 18 and FIG. 19, communication delay from the Node N; to Node Nₖ will be referred to as “D_{j, k}”. The communication delay D_{j, k} is regarded as a half of the RTT between the Node Nⱼ and the Node Nₖ (hereafter, referred to as “RTT_{j, k}”). Accordingly, with regard to j and k, D_{j, k}=D_{k, j}=RTT_{j, k}/2 holds. With any of the Node Nⱼ and Node Nₖ, the communication delay D_{j, k} (i.e., D_{k, j}) may be recognized before receiving a retransmission request by measuring RTT_{j, k} beforehand.

Also, in FIG. 18 and FIG. 19, delay due to the internal processing of the Node Nⱼ will be referred to as “Iⱼ”. The delay Iⱼ for the Node Nⱼ is the above delay in (Q-1). Also, when the parent node of the Node Nⱼ is the Node Nₖ, the delay Iⱼ for the Node Nₖ is the above delay in (Q-3). As described regarding (Q-1) and (Q-3), any of the Nodes Nⱼ and Nₖ may recognize the delay Iⱼ before receiving a retransmission request using a certain method.

Also, with the examples in FIGS. 1, 18, and 19, a request node for requesting retransmission with elimination of a data packet as a trigger is the Node N₅, and a retransmission request destination for the Node N₅ is the Node N₃. As described regarding Operation S404 in FIG. 14, a value which the Node N₅ sets to the retransmission request packet 801 as the acquisition deadline is a value obtained by subtracting RTT_{5, 3} from the period Lstart calculated by the retransmission request unit 407 of the Node N₅ in Operation S402.

In FIG. 18 and FIG. 19, the value to be set to the retransmission request packet 801 as the acquisition deadline by the Node N₅ is denoted as “Ta”. The value Ta of the acquisition deadline of the retransmission request packet 801 that the Node N₅ transmits in Operation S20 in FIG. 1 is represented as Expression (11) from Expression (7). Expression (11) is as represented in FIG. 18 and FIG. 19.

Ta=Lstart−RTT_{5, 3}=Lstart−(D₅, 3+D_{3, 5}) (11)

Accordingly, for the Node N₃ which has received the retransmission request packet 801 transmitted in Operation S20 in FIG. 1, the value of Tstart in Expression (9) used for determination in Operation S505 in FIG. 16 is the value Ta in FIGS. 18 and 19. As described above, with the initial state of U=Qfrom, Expression (9) has the same value as with Expression (10).

Also, the delay α in Expression (10) includes the above (Q-1) through (Q-4). For the Node N₃ which has received the retransmission request packet 801 transmitted in Operation S20 in FIG. 1, the delay in (Q-1) is the internal delay I₃ of the Node N₃ itself as shown in FIG. 18. Also, if we say that the Node N₃ has focused on the Node N₆ as the first child node in Operation S505 in FIG. 16, the delay in (Q-2) for the Node N₃ is, as shown in FIG. 18, delay D_{3, 6}, and the delay in (Q-3) for the Node N₃ is the internal delay I₆ of the child Node N₆.

The approximation model shown in FIG. 18 is a model for approximating communication delay from a first node to a second node using sum between communication delay from the first node to a third node, and communication delay from the third node to the second node. Specifically, according to the approximation model in FIG. 18, in the event of focusing on the child Node N₆ as a responsible node candidate, the Node N₃ approximates communication delay D_{6, 5} from the Node N₆ to a request Node N₅ such as Expression (12).

D_{6, 5}≈D_{6, 3}+D_{3, 5} (12)

The length of the period in (Q-4) for the selecting unit 411 of the Node N₃ which performs determination in Operation S505 in FIG. 16 is (D_{6, 5}+D_{3, 5}). Accordingly, under the approximation in Expression (12), the length of the period in (Q-4) for the selecting unit 411 of the Node N₃ is equal to the delay D_{6, 3}.

As described above, for the selecting unit 411 of the Node N₃, the delay α in Expression (10) is specifically as shown in Expression (13).

α=I₃+D_{3, 6}++D6_{6, 3} (13)

That is to say, for the selecting unit 411 of the Node N₃ which has received the retransmission request packet 801 from the request Node N₅, Expression (10) is as shown in Expression (14).

Ta−(I₃+D_{3, 6}+I₆+D6_{6, 3})>0 (14)

Note that, in FIG. 18, the value of the left side in Expression (14) is denoted as “Tb”. With an embodiment employing the approximation model in FIG. 18, in Operation S505 in FIG. 16, the selecting unit 411 of the Node N₃ specifically determines whether or not the value Tb is greater than 0.

Here, for convenience of description, let us say that Tb>0 as exemplified in FIG. 18. Also, let us say that a later-described condition in Operation S507 is also satisfied for convenience of description. Thus, though the details will be described later regarding Operations S508 and S509 in FIG. 16, the Node N₃ creates a new retransmission request 801 for leaving retransmission to the child Node N₆, and transmits the created retransmission request packet 801 to the child Node N₆.

A value that the Node N₃ sets as the acquisition deadline of a new retransmission request packet 801 to be created is a value shown as “Tc” in FIG. 18. The value Tc is specifically as shown in Expression (15).

Tc=Ta−(I₃+D_{3, 6}+D_{6, 3})=Tb+I₆ (15)

The load distribution processing unit 410 of the Node N₆ which has received the retransmission request packet 801 to which the value Tc is set as the acquisition deadline in Operation S30 in FIG. 1 then starts the processing in FIGS. 16 through 17. In this case, the value of the acquisition deadline Tstart in Expressions (9) and (10) for the selecting unit 411 of the Node N₆ is the value Tc in Expression (15). Also, with the Node N₆ as well, Expression (9) has the same value as with Expression (10) in the initial state of U=Qfrom.

For the Node N₆, the delay in (Q-1) is the internal delay I₆ of the Node N₆ itself. Also, let us say that the Node N₆ has focused on the Node N₁₂ as the first child node in Operation S505 in FIG. 16. Thus, as shown in FIG. 18, the communication delay in (Q-2) for the Node N₆ is delay D_{6, 12}, and the delay in (Q-3) for the Node N₆ is the internal delay I₁₂ of the child Node N₁₂.

According to the approximation model in FIG. 18, in the event of focusing on the child Node N₁₂ as a responsible node candidate, the Node N₆ approximates the communication delay D_{12, 5} from the Node N₁₂ to the request Node N₅ such as Expression (16).

D_{12, 5}≈D_{12, 6}+D_{6, 5} (16)

Also, The length of the period in (Q-4) for the selecting unit 411 of the Node N₆ which performs determination in Operation S505 in FIG. 16 is (D_{12, 5}+D_{6, 5}). Accordingly, under the approximation in Expression (16), the length of the period in (Q-4) for the selecting unit 411 of the Node N₆ is equal to the delay D_{12, 6}.

As described above, for the selecting unit 411 of the Node N₆, the delay α in Expression (10) is specifically as shown in Expression (17).

α=I₆+D_{6, 12}+I₁₂+D6_{12, 6})>0 (17)

That is to say, for the selecting unit 411 of the child Node N₆ which has received the retransmission request packet 801 from the request Node N₃, Expression (10) is as shown in Expression (18).

Tc−(I₆+D_{6, 12}+I₁₂+D6_{12, 6})>0 (18)

Note that, in FIG. 18, the value of the left side in Expression (17) is denoted as “Td”. With an embodiment employing the approximation model in FIG. 18, in Operation S505 in FIG. 16, the selecting unit 411 of the Node N₆ specifically determines whether or not the value Td is greater than 0.

Here, for convenience of description, let us say that Td>0 as exemplified in FIG. 18. Also, let us say that a later-described condition in Operation S507 is also satisfied for convenience of description. Thus, though the details will be described later regarding Operations S508 and S509 in FIG. 16, the Node N₆ creates a new retransmission request packet 801 for leaving retransmission to the child Node N₁₂, and transmits the created retransmission request packet 801 to the child Node N₁₂.

A value that the Node N₆ sets as the acquisition deadline of a new retransmission request packet 801 to be created is a value shown as “Te” in FIG. 18. The value Te is specifically as shown in Expression (19).

Te=Tc−(I₆+D_{6, 12}+D_{12, 6})=Td+I₁₂ (19)

The load distribution processing unit 410 of the Node N₁₂ which has received the retransmission request packet 801 to which the value Te is set as the acquisition deadline in Operation S33 in FIG. 1 then starts the processing in FIGS. 16 through 17.

As described above, the value of the acquisition deadline Tstart of the retransmission request packet 801 indicates a constraint condition that in the event of assuming that the node itself which has received the retransmission request packet 801 performs transmission of data packets, when this node has to start transmission by.

For example, as shown in FIG. 18, the retransmission request packet 801 to which the value Ta is set is received by the Node N₃. The value Ta indicates a constraint condition that In the event that the node N₃ transmits a data packet to the Node N₅, the Node N₃ has to start transmission within the period that the value Ta indicates.

Similarly, with the example in FIG. 18, the retransmission request packet 801 to which the value Tc is set is received by the Node N₆. The value Tc indicates a constraint condition that In the event that the node N₆ transmits a data packet to the Node N₅, the Node N₆ has to start transmission of the data packet within the period that the value Tc indicates.

Similarly, with the example in FIG. 18, the retransmission request packet 801 to which the value Te is set is received by the Node N₁₂. The value Te indicates a constraint condition that In the event that the node N₁₂ transmits a data packet to the Node N₅, the Node N₁₂ has to start transmission within the period that the value Te indicates.

As exemplified above, the value set to a certain retransmission request packet 801 as the acquisition deadline represents a constraint condition regarding a case where a node itself which receives this retransmission request packet 801 performs transmission of data packets. Certain delay occurs each time transfer of retransmission is performed. Accordingly, each time transfer of retransmission is performed, the value to be set to a new retransmission request packet 801 as the acquisition deadline is sequentially decremented based on the delay α estimated based on a suitable approximation model. For example, such as FIG. 18, the value to be set as the acquisition deadline is sequentially decremented such as from the value Ta to the value Tc, from the value Tc to the value Te, each time transfer of retransmission is performed.

Incidentally, an embodiment employing an approximation model different from the above approximation model in FIG. 18 may be realized. Specifically, the approximation model shown in FIG. 19 may be employed regarding the length of the period in (Q-4).

The approximation model shown in FIG. 19 is an approximation model wherein in the event that the distance between the first node and the second node over the physical network is relatively short, the communication delay from the first node to the third node, and the communication delay from the second node to the third node are regarded as the same. The approximation model in FIG. 19 is particularly suitable in a case described below.

With a certain kind of ALM system, when a new node attempts to participate in the distribution tree, a node closer to the new node over the physical network is preferentially selected as a parent node. Hereafter, for convenience of description, such a parent node selecting algorithm will be referred to as “physical distance precedence algorithm”. According to the physical distance precedence algorithm, shortening of distribution delay is expected.

For example, let us say that there is a distribution tree where the logical network 100 in FIG. 1 is built by the physical distance precedence algorithm. A probability that distance between the Nodes N₃ and N₆ over the physical network is short is high, and a probability that distance between the Nodes N₆ and N₁₂ over the physical network is short is also high. Note that the distance between two nodes over physical network may be defined as, for example, the number of routers existing between two nodes.

In the event that distance between a parent node and a child node over the physical network is short, communication delay from the parent node to a certain node, and communication delay from a child node to this certain node are estimated to be almost the same. That is to say, difference between the above two communication delays is but little.

Therefore, with the approximation model in FIG. 19, approximation is performed wherein the communication delay from the Nodes N₃ to the Node N₆, and the communication delay from the Nodes N₆ to the Node N₅ are regarded as the same in accordance with estimation that distance between the parent Node N₃ and the child Node N₆ over the physical network is short. Similarly, with the approximation model in FIG. 19, approximation is performed wherein the communication delay from the Nodes N₆ to the Node N₅, and the communication delay from the Nodes N₁₂ to the Node N₅ are regarded as the same in accordance with estimation that distance between the parent Node N₆ and the child Node N₁₂ over the physical network is short. Specifically, according to the approximation model in FIG. 19, communication delays are approximated such as Expression (20).

D_{3, 5}≈D_{6, 5}≈D_{12, 5} (20)

According to the approximation model exemplified in FIG. 19 and Expression (20), the length of the above period in (Q-4) is estimated to be zero. It goes without saying that, in reality, in many cases, difference Tf between the communication delay D_{6, 5} and the communication delay D_{3, 5} is not zero in a precise sense, and difference Tg between the communication delay D_{12, 5} and the communication delay D_{3, 5} is not zero in a precise sense. However, the absolute value of the difference Tf is estimated to be small, and the absolute value of the difference Tg is also estimated to be small. Accordingly, the length of the period in (Q-4) is estimated to be zero.

Accordingly, under the approximation model in FIG. 19, for the selecting unit 411 of the Node N₃ for performing the determination in Operation S505 in FIG. 16, the delay α in Expression (10) is specifically as shown in Expression (21).

α=I₃+D_{3, 6}+I₆ (21)

That is to say, for the selecting unit 411 of the Node N₃ which has received the retransmission request packet 801 from the request Node N₅, Expression (10) is as shown in Expression (22).

Ta−(I₃+D_{3, 6}+I₆)>0 (22)

Note that, in FIG. 19, the value of the left side in Expression (22) is denoted as “Th”. With an embodiment employing the approximation model in FIG. 19, in Operation S505 in FIG. 16 the selecting unit 411 of the Node N₃ specifically determines whether or not the value Th is greater than 0.

Here, for convenience of description, let us say that Th>0 as exemplified in FIG. 19. Also, for convenience of description, let us assume that a later-described condition in Operation S507 is also satisfied. In this case, though the details will be described later regarding Operations S508 and S509, the Node N₃ creates a new retransmission request packet 801 for leaving retransmission to the child Node N₆, and transmits the created retransmission request packet 801 to the child Node N₆.

A value that the Node N₃ sets as the acquisition deadline of a new retransmission request packet 801 to be created is a value denoted as “Ti” in FIG. 19. The value Ti is specifically as shown in Expression (23).

Ti=Ta−(I₃+D_{3, 6})=Th+I₆ (23)

The load distribution processing unit 410 of the Node N₆ which has received the retransmission request packet 801 to which the value Ti is set as the acquisition deadline in Operation S30 in FIG. 1 then starts the processing in FIGS. 16 through 17. In this case, the value of the acquisition deadline Tstart in Expressions (9) and (10) for the selecting unit 411 of the Node N₆ is the value Ti in Expression (23). Also, with the Node N₆ as well, Expression (9) has the same value as with Expression (10) in the initial state of U=Qfrom.

For the Node N₆, the delay in (Q-1) is the internal delay I₆ of the Node N₆ itself. Also, let us say that the Node N₆ has focused on the Node N₁₂ as the first child node in Operation S505 in FIG. 16. Thus, as shown in FIG. 19, the communication delay in (Q-2) for the Node N₆ is delay D_{6, 12}, and the delay in (Q-3) for the Node N₆ is the internal delay I₁₂ of the child Node N₁₂.

With the approximation model in FIG. 19, the length of the period in (Q-4) is estimated to be zero as described above. Accordingly, for the selecting unit 411 of the Node N₆, the delay α in Expression (10) is specifically as shown in Expression (24).

α=I₆+D_{6, 12}+I₁₂ (24)

That is to say, for the selecting unit 411 of the child Node N₆ which has received the retransmission request packet 801 from the parent Node N₃, Expression (10) is as shown in Expression (25).

Ti−(I₆+D_{6, 12}+I₁₂)>0 (25)

Note that, in FIG. 19, the value of the left side in Expression (25) is denoted as “Tj”. With an embodiment employing the approximation model in FIG. 19, in Operation S505 in FIG. 16 the selecting unit 411 of the Node N₆ specifically determines whether or not the value Tj is greater than 0.

Here, for convenience of description, let us say that Tj>0 as exemplified in FIG. 19. Also, for convenience of description, let us assume that a later-described condition in Operation S507 is also satisfied. In this case, though the details will be described later regarding Operations S508 and S509 in FIG. 16, the Node N₆ creates a new retransmission request packet 801 for leaving retransmission to the child Node N₁₂, and transmits the created retransmission request packet 801 to the child Node N₁₂.

A value that the Node N₆ sets as the acquisition deadline of a new retransmission request packet 801 to be created is a value denoted as “Tk” in FIG. 19. The value Tk is specifically as shown in Expression (26).

Tk=Ti−(I₆+D_{6, 12})=Tj+I₁₂ (26)

The load distribution processing unit 410 of the Node N₁₂ which has received the retransmission request packet 801 to which the value Tk is set as the acquisition deadline in Operation S33 in FIG. 1 then starts the processing in FIGS. 16 through 17.

As described above, even when employing any kind of approximation model, a value set to the retransmission request packet 801 as the acquisition deadline Tstart indicates a constraint condition regarding transmission start deadline in the case of a node itself which has received the retransmission request packet 801 performing transmission of data packets. Accordingly, when determining whether or not the i'th child node is selectable as a responsible node, the selecting unit 411 takes the internal processing delay of the i'th child node (i.e., a node that receives a new retransmission request packet 801 if selected as a responsible node) into consideration. On the other hand, with calculation of the acquisition deadline of a new retransmission request packet 801 to be transmitted to the i'th child node in the event that the i'th child node has actually been selected as a responsible node, the internal processing delay of the i'th child node is not subtracted. This is because wherein the internal processing delay of the i'th child node is delay that occurs after the i'th child node has received the new retransmission request packet 801.

Now, description will return to description of Operation S505 in FIG. 16. The examples in FIGS. 18 and 19 are examples of determination in Operation S505 in the initial state wherein U=Qfrom. However, the value of the variable U may be greater than the start number Qfrom by being updated in later-described Operation S511.

Also, at the time of U>Qfrom, as apparent from FIG. 13, the acquisition deadline of No. U data packet is delayed as compared to the acquisition deadline of No. Qfrom data packet. Difference between the acquisition deadlines of Nos. U and Qfrom data packets is a period taken for consumption of (U−Qfrom) data packets.

Here, difference between the completion deadline Tend and the acquisition deadline Tstart specified in the retransmission request packet 801 received by the reception unit 401 is, as may be understood from FIGS. 13 through 14, a period taken for consumption of (Qto−Qfrom+1) data packets. Accordingly, the period taken for consumption of (U−Qfrom) data packets is as shown in Expression (27).

(Tend—Tstart)×(U−Qfrom)/(Qto−Qfrom +1) (27)

That is to say, the acquisition deadline of No. U data packet is delayed by an amount equivalent to the period in Expression (27) as compared to the acquisition deadline of No. Qfrom data packet. Expression (9) is an expression where the difference between the acquisition deadlines of Nos. U and Qfrom data packets is taken into consideration such as described above, and is an expression that adds the period in Expression (27) to the left side of Expression (10).

For example, in the case of Qfrom=10, the acquisition deadline Tstart set to the retransmission request packet 801 received by the reception unit 401 more specifically indicates the acquisition deadline of No. 10 (=Qfrom) data packet. Also, for example, in the case of Qto=15, the completion deadline Tend set to the retransmission request packet 801 received by the reception unit 401 more specifically indicates the completion deadline of No. 15 (=Qto) data packet.

Also, in the case of the above Qfrom=10 and also Qto=15, and further let us assume that U=12, description will be made as follows regarding Expression (9) in the case of U>Qfrom.

In this case, the number of data packets that have been requested for transmission is 6 (=Qto−Qfrom+1), and Nos. 10 and 11 two (=U−Qfrom) data packets have already been assigned to any of the responsible nodes. Accordingly, the acquisition deadline of No. 12 (=U) data packet is delayed by the period in Expression (27) (i.e., (Tend−Tstart)×2/6) as compared to the acquisition deadline Tstart of No. 10 data packet.

As described above, Expression (9) is an expression generalized so as to be applicable regardless of the value of the variable U. Accordingly, the selecting unit 411 determines in Operation S505 whether or not Expression (9) is satisfied. The selecting unit 411 may determine using Expression (9) whether or not the i'th child node may ensure transmission of No. U data packet and thereafter so as to be in time for the acquisition deadline of No. U data packet.

In the event that Expression (9) is satisfied, in order to determine up to what number of data packet may be assigned to the i'th child node, the processing then proceeds to Operation S506.

Conversely, in the event that Expression (9) is unsatisfied, the selecting unit 411 determines that the i'th child node is not suitable as a responsible node. The selecting unit 411 then executes the processing in Operation S513 to focus on another child node as a responsible node candidate.

In Operation S506, the selecting unit 411 calculates the maximum number equal to or smaller than No. Qto, whereby the i'th child node may ensure transmission so as to be in time for the completion deadline. The selecting unit 411 substitutes the calculation result for the variable V.

Specifically, the selecting unit 411 calculates the maximum number V satisfying both of Expressions (28) and (29). Note that the number V is an integer.

α+(V−U+1)×pSize/B+β<Tend−(Tend−Tstart)×(Qto−V)/(Qto−Qfrom+1) (28)

V≦Qto (29)

Here, “α” in the left side of Expression (28) is the same as with Expression (9). That is to say, “α” represents delay in conjunction with transfer to the i'th child node.

Also, “B” in Expression (28) is remaining bandwidth obtained by subtracting the total of the temporary use bandwidth of the i'th child node from the transmittable total bandwidth of the i'th child node. That is to say, the bandwidth B is the sum of bandwidths that a node belonging to a subgraph with the i'th child node as the root node may currently use. The selecting unit 411 may obtain the value of “B” in Expression (28) by referencing the child node information of the node information storage unit 408.

Note that, as described with reference to FIG. 9, in a manner correlated with the i'th child node, no temporal bandwidth may be stored or one or more temporary use bandwidths may be stored. In the event that no temporary use bandwidth is stored, “B” in Expression (28) is equal to the transmittable total bandwidth of the i'th child node.

Further, as described above, with the present embodiment, the data packets have fixed length, and the lengths of the data packets are pSize. The number of Nos. U to V data packets is (V−U+1). Accordingly, the second term of the left side of Expression (28) (i.e., (V−U+1)×pSize/B) indicates a period taken for transmission in the event of assuming that all of the bandwidth B are occupied for transmitting Nos. U to V data packets.

The second term “β” of the left side of Expression (28) is a margin. The margin β may be zero, but it is desirable that this margin β has a suitable positive value according to embodiments. The reason for employing the margin β is as follows.

Even if the selecting unit 411 has selected the i'th child node as a responsible node, the i'th child node itself does not necessarily perform transmission of data packets. For example, with the example in FIG. 1, the Node N₆ selected as a responsible node by the Node N₃ does not perform transmission of data packets, and leaves transmission to the child Nodes N₁₂ and N₁₃.

If the Node N₆ further leaves transmission of data packets to other Nodes N₁₂ and N₁₃ as shown in FIG. 1, new delay in conjunction with retransfer occurs. However, if the Node N₃ leaving transmission of data packets to the Node N₆, the selecting unit 411 of the Node N₃ does not recognize whether or not the Node N₆ further leave transmission of data packets to another node. That is to say, the Node N₃ does not recognize whether or not new delay in conjunction with retransfer from the Node N₆ to the Node N₁₂ or N₁₃ occurs, and does not recognize the length of the new delay.

Also, in the event that the i'th child node is a relay node, the bandwidth B in Expression (28) regarding the i'th child node is the sum of a bandwidth that the i'th child node itself may use, and a bandwidth that a descendant of the i'th child node may use. Accordingly, the above assumption that all of the bandwidth B are occupied for transmission of Nos. U to V data packets includes an assumption that the i'th child node and all of the descendants thereof perform transmission of data packets at the same time. However, if retransfer from the i'th child node occurs, points in time when the i'th child node and descendants thereof start transmission of data packets respectively will mutually differ.

That is to say, the above included assumption does not always hold. Therefore, the second term in the left side of Expression (28) may include error somewhat in the event that retransfer occurs.

Therefore, in order to take probability of retransfer into consideration, the suitable margin β is used in Expression (28). The value of the margin β may be a constant obtained, for example, from preliminary experiments or the like.

Alternatively, the parent node may recognize whether or not there is a probability of retransfer by each of the individual nodes informing information indicating whether or not this individual node is a leaf node by being notified to that effect. The parent node can store the information informed from a child node in the node information storage unit 408 as part of the child node information.

For example, in the event that the i'th child node of the communication device 400 is a leaf node, the selecting unit 411 of the communication device 400 determines that retransfer from the i'th child node may not occur, and set the margin β to zero. Conversely, in the event that the i'th child node of the communication device 400 is a relay node, it is desirable for the selecting unit 411 of the communication device 400 to set the margin β to a positive value (e.g., a predetermined positive constant).

Also, the right side of Expression (28) indicates the completion deadline of No. V data packet. The completion deadline of No. V data packet is earlier than the completion deadline of No. Qto data packet by an amount equivalent to a period taken for consumption of (Qto−V) data packets. A period taken for consumption of (Qto−V) data packets is as shown in Expression (30) from the same reason as with description regarding Expression (27).

(Tend—Tstart)×(Qto−V)/(Qto−Qfrom+1) (30)

Accordingly, the right side of Expression (28) indicates difference obtained by subtracting the period in Expression (30) from the completion deadline of No. Qto data packet. Accordingly, with regard to V satisfying both of Expressions (28) and (29), even if a probability of retransfer is taken into consideration, it may be the that the i'th child node may ensure that transmission of up to No. V data packet is ended by the completion deadline of No. V data packet, in a generally sure manner.

As described above, in Operation S506, the selecting unit 411 calculates the maximum integer satisfying Expressions (28) and (29), and substitutes the calculation result for the variable V.

Next, in Operation S507, the selecting unit 411 determines whether or not U≦V holds.

When U≦V is satisfied, at least one data packet (specifically, (V−U+1) data packets) may be assigned to the i'th child node. That is to say, the i'th child node may be selected as a responsible node. Accordingly, the correlating unit 412 correlates (i.e., assigns) Nos. U to V data packets with the i'th child node. The processing then proceeds to Operation S508 for transfer to the i'th child node.

Conversely, when U≦V is not satisfied, the selecting unit 411 determines that the i'th child node is not suitable for a responsible node. The selecting unit 411 then executes the processing in Operation S513 to focus on another child node as a responsible node candidate.

In Operation S508, the request generating unit 413 calculates the acquisition deadline and completion deadline to be set to a new retransmission request packet 801 to be transmitted to the i'th child node.

Hereafter, for convenience of description, the acquisition deadline and completion deadline to be calculated in Operation S508 will be referred to as “Tstart2” and “Tend2”, respectively. Also, delay due to the internal processing of the i'th child node (i.e., the above delay in (Q-3)) will be referred to as “I”.

In Operation S508, the request generating unit 413 specifically calculates the acquisition deadline Tstart2 in accordance with Expression (31), and calculates the completion deadline Tend2 in accordance with Expression (32).

Tstart2=Tstart+(Tend−Tstart)×(U−Qfrom)/(Qto−Qfrom+1)−α+1 (31)

Tend2=Tend−(Tend−Tstart)×(Qto−V)/(Qto−Qfro+1)−α+1 (32)

The right side of Expression (31) is the sum of the left side of Expression (9) and the delay I. Meaning that the delay I is added in Expression (31) will be apparent from Expressions (15) and (19) for calculating the values Tc and Te in FIG. 18, and Expressions (23) and (26) for calculating the values Ti and Tk in FIG. 19.

Also, the right side of Expression (32) is obtained by subtracting the delay α from the right side of Expression (28), and adding the delay I due to the internal processing thereto in the same way as with Expression (31).

As shown in Expressions (31) and (32), the request generating unit 410 uses, at the time of calculating a constraint condition for a new retransmission request packet 801 to be transmitted to the responsible node, at least the communication period between the communication device 400 and the responsible child node (i.e., communication delay included in the delay α). Also, the request generating unit 413 takes, at the time of calculating a constraint condition for a new retransmission request packet 801, further which portion of the particular information the correlating unit 412 has been correlated with this responsible child node (i.e., range indicated by the variables U and V) into consideration.

Note that the margin 13 in Expression (28) is a term to be introduced for the selecting unit 411 which does not recognize whether or not retransfer from the i'th child node occurs estimating feasibility of transfer to the i'th child node in a more suitable manner. On the other hand, the completion deadline Tend2 is a value to be calculated for a notification as to the i'th child node. It goes without saying that the i'th child node itself which receives the retransmission request packet 801 to which the completion deadline Tend2 is set recognizes whether or not retransfer from the i'th child node occurs. Therefore, the margin β does not have to be subtracted from the right side in Expression (32).

Note that Expression (33) is obtained by subtracting Expression (31) from Expression (32). The right side of Expression (33) is a period taken for the playing processing unit 404 of the request node which has detected packet loss and requested retransmission playing (i.e., consuming) (V−U+1) data packets.

Tend2−Tstart2=(Tend−Tstart)×(V−U+1)/(Qto−Qfrom+1) (33)

That is to say, difference between the completion deadline and the acquisition deadline set to the retransmission request packet 801 with the present embodiment is a value uniquely determined according to difference between the end number and the start number set to the retransmission request packet 801. Accordingly, for example, the completion deadline may be calculated from the start number, end number, and acquisition deadline, and accordingly, the field for the completion deadline may be omitted from the retransmission request packet 801 depending on embodiments.

After calculating the acquisition deadline Tstart2 and completion deadline Tend2 as described above, in Operation S509 the request generating unit 413 subsequently generates a new retransmission request packet 801. The request generating unit 413 outputs the generated retransmission request packet 801 to the transmission unit 402, and the transmission unit 402 transmits the retransmission request packet 801 to the i'th child node.

Specifically, the request generating unit 413 sets the header of the new retransmission request packet 801 to a suitable value. The request generating unit 413 may obtain the transmission source IP address, transmission destination IP address, port number, and so forth to be set to the header of the retransmission request packet 801 with reference to the own node information and child node information within the node information storage unit 408.

Also, the request generating unit 413 sets the new retransmission request packet 801 to the acquisition deadline Tstart2 and completion deadline Tend2 calculated in Operation S508. Further, the request generating unit 413 copies the values of the retransmission destination IP address and port number of the retransmission request packet 801 to the fields of the retransmission destination IP address and port number of the retransmission request packet 801 received by the reception unit 401. The request generating unit 413 then sets the start number and end number of the new retransmission request packet 801 to the values of the variables U and V, respectively.

The new retransmission request packet 801 where values are set to the fields is transmitted from the transmission unit 402.

Also, in the next Operation S510, the correlating unit 412 sets the temporary use bandwidth and temporary use deadline corresponding to the i'th child node in the child node information within the node information storage unit 408. That is to say, the correlating unit 412 generates a new pair of the temporary use bandwidth and temporary use deadline, and registers the generated new pair to the entry corresponding to the i'th child node in the child node information.

Specifically, in the event that the maximum number V determined to satisfy Expression (28) in Operation S506 satisfies Expression (29) (hereafter, referred to as “first case” for convenience), the correlating unit 412 sets the temporary use bandwidth to the transmittable total bandwidth itself of the i'th child node.

Conversely, the maximum number V determined to satisfy Expression (28) in Operation S506 may be greater than the end sequence number Qto of the data packet that has been requested for retransmission (hereafter, referred to as “second case” for convenience). In the second case, in the same way as with the first case, the correlating unit 412 may set the temporary use bandwidth to the transmittable total bandwidth itself of the i'th child node. Alternatively, in the second case, the correlating unit 412 may calculate temporary use bandwidth tmpB, for example, in accordance with Expression (34).

tmpB=pSize×(V−U+1)/(Tend−α+1) (34)

Expression (34) is an expression for calculating temporary use bandwidth under assumption that the i'th child node transmits Nos. U to V data packets by devoting a period of (Tend−α+1). Note that “α” and “I” in Expression (34) are the same as with Expressions (31) and (32). Also, in the second case, the number V satisfying Expression (29) is selected, and accordingly, V=Qto holds. It is the period of (Tend−α+1) appearing as a divisor in Expression (34) that is obtained by substituting V=Qto for the right side of Expression (32).

Note that, with the present embodiment, the selecting unit 411 and correlating unit 412 sequentially assign many data packets to a child node in an assignable range as much as possible. Accordingly, there may be cases where only data packets of a number smaller than an assignable number of data packets are assigned to the final child node of child nodes to be selected as a responsible node.

That is to say, the above second case is a case where the i'th child node is the final child node of child nodes to be selected as a responsible node. Accordingly, in the second case, the i'th child node and descendent nodes thereof may end transmission of assigned data packets within the deadline even without using all of the transmittable total bandwidth of the i'th child node.

Therefore, in the second case, the correlating unit 412 may calculate the temporary use bandwidth tmpB following Expression (34) in accordance with assumption that a node which transmits assigned data packets transmits the data packets preferably at a low bit rate in time for the deadline. Note that this assumption is satisfied by the communication devices 400 which actually transmit data packets to a request node suitably adjusting the transmission interval of data packets in later-described processing in Operation S518.

Note that, in either case of the first case and the second case, the correlating unit 412 adds the completion deadline Tend set to the retransmission request packet 801 received by the reception unit 401 to the current point-in-time, and sets a new temporary use deadline regarding the i'th child node to the point-in-time obtained by addition. Alternatively, the correlating unit 412 may add a value adjusted from the completion deadline Tend based on the above delay in (Q-4) to the current point-in-time, and set the temporary use deadline of the i'th child node to the point-in-time obtained by addition.

After updating of the child node information is performed in Operation S510 as described above, in the next Operation S511 the selecting unit 411 substitutes V+1 for the variable U indicating the sequence number of a data packet to be assigned next.

Also, in the next Operation S512, the selecting unit 411 determines whether or not V<Qto holds.

If V<Qto holds, one or more data packets of which the assigned responsible nodes have not determined yet remain of the data packets requested for retransmission by the retransmission request packet 801 received by the reception unit 401. Accordingly, when V<Qto holds, the processing proceeds to Operation S513.

Conversely, in the event that the value of the variable V has already reached the specified end number Qto (i.e. if V=Qto holds), further selection of a responsible node does not have to be performed. Therefore, the processing proceeds to Operation S520 in FIG. 17.

In Operation S513, the selecting unit 411 increments the variable i indicating an index for selecting a responsible child node by one. The processing then returns to Operation S504.

Incidentally, in the event that in Operation S504 the value of the variable i is greater than the number of child nodes, the processing in Operation 5514 in FIG. 17 is performed. Specifically, in Operations S514 through S516 the selecting unit 411 determines whether or not the communication device 400 itself may be selected as a responsible node.

More specifically, in Operation S514 the selecting unit 411 determines whether or not the communication device 400 itself may transmit No. U data packet and thereafter in time for the acquisition deadline of No. U data packet. Here, for convenience of description, if we say that the internal processing delay of the communication device 400 itself shown in the above (Q-1) will be referred to as “IseIf”, in Operation S514 the selecting unit 411 determines whether or not Expression (35) holds.

Tstart+(Tend−Tstart)×(U−Qfrom)/(Qto−Qfrom+1)−Iself>0 (35)

Expression (35) is an expression obtained by replacing the delay α in Expression (9) using the internal processing delay IseIf. In the event that Expression (35) is satisfied, the selecting unit 411 determines that the communication device 400 itself may transmit No. data packet and thereafter in time for the acquisition deadline of No. U data packet, and the processing proceeds to Operation S515. Conversely, in the event that Expression (35) is not satisfied, the selecting unit 411 determines that the communication device 400 itself is not suitable as a responsible node, and the processing proceeds to Operation S521.

In Operation S515, the selecting unit 411 calculates the maximum number equal to or smaller than No. Qto that the communication device 400 itself may transmit in time for the completion deadline. The selecting unit 411 then substitutes the calculation result for the variable V.

Specifically, the selecting unit 411 calculates the maximum number V satisfying both of Expressions (36) and (37). Note that Expression (37) is the same as Expression (29).

Iself+(V−U+1)×pSize/Bself<Tend−(Tend−Tstart)×(Qto−V)/(Qto−Qfrom+1) (36)

V≦Qto (37)

Here, the right side of Expression (36) is the same as the right side of Expression (28) in Operation S06. Also, the left side of Expression (36) is obtained by replacing the sum (a+13) of the delay α and margin β in the left side of Expression (28) using the internal processing delay Iself of the communication device 400, and further replacing the bandwidth B using the bandwidth Bself. The bandwidth Bself in Expression (36) is remaining bandwidth obtained by subtracting the total of the temporary use bandwidth of the communication device 400 from the transmittable bandwidth of the communication device 400 itself. The selecting unit 411 may obtain the value of the bandwidth Bself in Expression (36) by referencing the own node information of the node information storage unit 408.

After calculation of the maximum integer satisfying Expressions (36) and (37), in the next Operation S516 the selecting unit 411 determines whether or not U≦V is satisfied.

When U≦V is satisfied, at least one data packet (specifically, (V−U+1) data packets) may be assigned to the communication device 400 itself. That is to say, the communication device 400 may be selected as a responsible node. Accordingly, the correlating unit 412 correlates (i.e., assigns) Nos. U to V data packets with the communication device 400 itself. The processing then proceeds to Operation S517.

Conversely, when U≦V is not satisfied, the selecting unit 411 determines that the communication device 400 itself is not suitable for a responsible node. The processing then proceeds to Operation S521.

Now, in Operation S517, the correlating unit 412 generates a new pair of the temporary use bandwidth and temporary use deadline, and registers the generated new pair in the own node information within the node information storage unit 408.

Specifically, in the event that the maximum number V determined to satisfy Expression (36) in Operation S515 satisfies Expression (37) (hereafter, referred to as “first case” for convenience), the correlating unit 412 sets the temporary use bandwidth to the transmittable total bandwidth itself of the communication device 400 itself.

Conversely, the maximum number V determined to satisfy Expression (36) in Operation S515 may be greater than the end sequence number Qto of the data packet that has been requested for retransmission (hereafter, referred to as “second case” for convenience). In the second case, in the same way as with the first case, the correlating unit 412 may set the temporary use bandwidth to the transmittable total bandwidth itself of the communication device 400 itself. Alternatively, in the second case, the correlating unit 412 may calculate temporary use bandwidth tmpB, for example, in accordance with Expression (38).

tmpB=pSize×(V−U+1)/(Tend−Iself) (38)

Expression (38) is an expression for calculating use bandwidth under assumption that the communication device 400 transmits Nos. U to V data packets by devoting a period of (Tend−Iself). Expression (38) is an expression obtained by replacing the divisor in Expression (34) using another divisor.

That is to say, Expression (38) is an expression in accordance with assumption that in the event the communication device 400 itself has been selected as a responsible node, the communication device 400 transmits data packets preferably at a lower bit rate in a range in time for the deadline.

Note that, in either case of the first case and second case, the correlating unit 412 adds the completion deadline Tend set to the retransmission request packet 801 received by the reception unit 401 to the current point-in-time, and sets the temporary use deadline to the point-in-time obtained by addition.

After updating of the own node information is performed in Operation S517 as described above, in the next Operation S518 the retransmission processing unit 414 starts transmission of Nos. U to V data packets. The processing for transmitting Nos. U to V data packets may be a child process of the processing in FIGS. 16 through 17, or may be a thread different from the processing in FIGS. 16 through 17.

Note that in Operation S517 the retransmission processing unit 414 performs processing for starting transmission of Nos. U to V data packets. The retransmission processing unit 414 performs transmission of actual data packets in parallel with the processing in Operation S519 and thereafter being performed.

Specifically, for example, in Operation S517 the retransmission processing unit 414 performs scheduling of the transmission of Nos. U to V data packets. The retransmission processing unit 414 controls the transmission of Nos. U to V data packets in accordance with the scheduling results. For example, the retransmission processing unit 414 may perform scheduling so as to immediately execute the transmission of No. U data packet, and also perform scheduling so as to transmit thereafter up to No. V data packet with an interval of (Tend−Iself)/(V−U+1).

As described above, in the event that the selecting unit 411 has selected the communication device 400 itself as a responsible node, the retransmission processing unit 414 controls the transmitting timing of data packets based on two values specified in the retransmission request packet 801 received by the reception unit 401 as the acquisition deadline and completion deadline.

Note that Nos. U to V data packets are transmitted as follows in accordance with a schedule. The retransmission processing unit 414 reads out the payload of the data packet to be transmitted, from the buffer unit 403, and generates a data packet addressed to the request node by adding a suitable header in front of the payload. The retransmission processing unit 414 may suitably set the header of a data packet by referencing the IP address A and port number P of the request source set to the retransmission request packet 801 received by the reception unit 401. The retransmission processing unit 414 then outputs the generated data packet to the transmission unit 402, and the transmission unit 402 transmits the data packet.

Well, in Operation S519 subsequently to Operation S518, the selecting unit 411 determines whether or not V=Qto is satisfied.

If V=Qto is satisfied, all of the data packets requested by the retransmission request packet 801 received by the reception unit 401 have been assigned to any of the responsible nodes. Accordingly, in order to inform that the communication device 400 has been able to handle the received retransmission request packet 801, the processing proceeds to Operation S520.

Conversely, if V=Qto is not satisfied (more specifically, if V<Qto), of the data packets requested for retransmission by the retransmission request packet 801 received by the reception unit 401, one or more data packets which have not determined an assigned responsible node remain. Accordingly, when V<Qto is satisfied, in order to inform that the communication device 400 has not been able to handle the received retransmission request packet 801, the processing proceeds to Operation S522.

Well, a case where Operation S520 is executed is a case where all of the data packets from Nos. Qfrom to Qto requested by the retransmission request packet 801 received by the reception unit 401 have already been assigned to any of the responsible nodes. Accordingly, in Operation S520, the load distribution processing unit 410 generates an ACK (ACKnowledgment) packet informing that transmission from Nos. Qfrom to Qto data packets are ensured. The load distribution processing unit 410 outputs the generated ACK packet to the transmission unit 402, and the transmission unit 402 transmits the ACK packet.

Note that the transmission destination of the ACK packet is not the request node which has requested retransmission of data packets but the direct transmission source node of the retransmission request packet 801 received by the reception unit 401. For example, with the Node N₆ which has received the retransmission request packet 801 from the Node N₃ in Operation S30 in FIG. 1, in Operation S520 the load distribution processing unit 410 generates an ACK packet not addressed to the request Node N₅ but addressed to the Node N₃.

After transmission of the ACK packet, the processing in FIGS. 16 through 17 is then ended.

Also, a case where Operation S521 is executed is a case where a suitable responsible node serving as an assignment destination of No. U data packet and thereafter has not been found. Therefore, in Operation S521, the load distribution processing unit 410 generates an error packet informing that of Nos. Qfrom to Qto data packets requested for transmission, Nos. U to Qto data packets have not been able to be transmitted. This error packet is, in other words, a NACK packet indicating that retransmission request is not acceptable.

The load distribution processing unit 410 outputs the generated error packet to the transmission unit 402, and the transmission unit 402 transmits the error packet. Note that the transmission destination of the error packet is also not the request node which has requested retransmission of data packets but the direct transmission source node of the retransmission request packet 801 received by the reception unit 401.

After transmission of the error packet, the processing in FIGS. 16 through 17 is then ended.

Also, a case where Operation S522 is executed is a case where a suitable responsible node serving as an assignment destination of No. (V+1) data packet and thereafter has not been found. Therefore, in Operation S522, the load distribution processing unit 410 generates an error packet informing that of Nos. Qfrom to Qto data packets requested for transmission, Nos. (V+1) to Qto data packets have not been able to be transmitted. The load distribution processing unit 410 outputs the generated error packet to the transmission unit 402, and the transmission unit 402 transmits the error packet.

The processing in Operation S522 is the same as with Operation S521 other than No. U is replaced with No. (V+1). After transmission of the error packet in Operation S522, the processing in FIGS. 16 through 17 ends.

Note that the operation of the node in the event of having received the error packet to be transmitted in Operation S521 or S522 may vary according to embodiments.

For example, the retransmission request destination information 702 in FIG. 9 includes only one entry, but the retransmission request destination information 702 may include multiple entries. Specifically, In Operation S106 in FIG. 6, the management server 204 may inform multiple retransmission request destination candidates, and the node information managing unit 409 may store the informed multiple retransmission request destination candidates in the retransmission request destination information 702 of the node information storage unit 408. The retransmission request unit 407 may select one of the multiple retransmission request destination candidates as a retransmission request destination in Operation S304 in FIG. 11.

With an embodiment wherein multiple retransmission request destination candidates are stored as described above, in the event of having received the error packet from the transmission destination node of the retransmission request packet 801, the request node which has detected packet loss and requested retransmission of data packets may select another retransmission request destination candidate again. For example, in the event that the request Node N₅ has selected the Node N₃ as a first retransmission request destination candidate as shown in FIG. 1, let us say that the Node N₃ has transmitted the error packet to the Node N₅. In this case, the Node N₃ may select a second retransmission request destination candidate, calculate the acquisition deadline and completion deadline again, and transmit a new retransmission request packet 801 to the selected second candidate.

Alternatively, depending on embodiments, in the event of having received the error packet from the retransmission request destination node, the request node may select the parent node as a new retransmission request destination, calculates the acquisition deadline and completion deadline again, and transmit a new retransmission request packet 801 to the parent node.

Also, a case may infrequently occur where a node which has selected a child node as a responsible node and left transmission of data packets to the child node receives an error packet from this responsible child node. For example, even a case may occurs where the Node N₃ which has transmitted the retransmission request packet 801 to the child Node N₆ in Operation S30 in FIG. 1 receives an error packet from the Node N₆.

In this case, the Node N₃ which has received the error packet from the Node N₆ may transfer the received error packet to the direct transmission source of the retransmission request packet 801 that the Node N₃ has received. Note that, with the example in FIG. 1, the direct transmission source of the retransmission request packet 801 that the Node N₃ has received is the Node N₅, and the Node N₅ also happens to serve as a request node.

Alternatively, the Node N₃ which has received the error packet from the Node N₆ may determine whether or not there is a node which has further leeway left to accept transmission of data packets out of the Node N₃ itself and the child nodes of the Node N₃. If one or more nodes which have leeway have been found, the load distribution processing unit 410 of the Node N₃ may assign a data packet of which the sequence number is specified in the error packet to the found one or more nodes. Conversely, in the event that any node having leeway has not been found, the Node N₃ may transfer the error packet to the direct transmission source of the retransmission request packet 801 that the Node N₃ has received.

Note that there may be a case where though nodes having leeway have been found, it is insufficient to assign all of the data packets specified in the error packet to the found nodes alone. In this case, the Node N₃ may generate a new error packet that specifies numbers of which the new assignment destinations have not been found of the data packets specified in the sequence numbers in the error packet received from the Node N₆. The Node N₃ may then assign transmission of data packets to the found nodes, and also transmit the generated new error packet to the direct transmission destination of the retransmission request packet 801 that the Node N₃ has received.

Incidentally, as briefly described regarding FIG. 12, parameters specified in a retransmission request vary depending on embodiments. Description will be made below regarding an embodiment wherein instead of the retransmission request packet 801 in FIG. 12, a retransmission request packet 802 including specification of a bit rate is used. Note that, with regard to points in common with the above embodiment, description thereof will be omitted as appropriate.

First, the format of the retransmission request packet 802 will be described with reference to FIG. 12.

The retransmission request packet 802 includes the same header and acquisition deadline Tstart as with the retransmission request packet 801. However, the retransmission request packet 802 does not include the completion deadline Tend such as the retransmission request packet 801, instead includes a bit rate Breq. The retransmission request packet 802 further includes the same IP address A and port number P of the retransmission destination as with the retransmission request packet 801.

Incidentally, with the retransmission request packet 801, a retransmission range is specified using a pair of the start number Qfrom and end number Qto. That is to say, in the event that there are multiple data packets requested by the retransmission request packet 801, the sequence numbers of these multiple data packets are continued. However, with the present embodiment, transmission of multiple data packets having an inconsecutive sequence number may be requested.

Therefore, the retransmission request packet 802 includes a list of the sequence numbers of data packets requested for transmission (hereafter, referred to as “retransmission list”) instead of the pair of the start number Qfrom and end number Qto. With the example in FIG. 12, the retransmission list of the retransmission request packet 802 includes M (1≦M) sequence numbers Q₁, . . . , Q_{M}.

As described below in detail, even in the event that a large amount of data packets have been eliminated, a degree where reception of data packets at the request node is temporally concentrated may be eased by employing the retransmission request packet 802 including specification of the bit rate Breq. That is to say, the present embodiment that will be described below is advantageous to preventing retransmission failure due to burst reception. In other words, the present embodiment has an advantage for preventing a vicious circle that a new retransmission request occurs again due to retransmission failure.

Upon a large amount of data packets being eliminated, a node which has detected packet loss requests retransmission of the eliminated large amount of data packets. One node may transmit all of the requested large amount of data packets depending on cases. However, for example, there may be a case where transfer as shown in FIG. 1 is performed once or more, and as a result thereof, each of multiple nodes transmits an assigned part out of the large amount of data packets.

In any case, in the event that a certain node transmits multiple data packets, it is undesirable to transmit these multiple data packets at an extremely high bit rate in a bust manner. This is because packet loss due to reception in a burst manner might occur at a request node (i.e., node which has detected packet loss), or at a router or the like existing over a route from this certain node to the request node over the physical network.

Also, in the event that each of the multiple nodes transmits only an assigned part of the large amount of data packets, even if each of the nodes does not transmit data packets at a too high bit rate, packet loss due to reception in a burst manner may occur. This is because the request node, a router closer to the request node on the physical network, or the like may receive data packets transmitted from multiple nodes in a burst manner generally at the same time.

Accordingly, it is desirable for each of the nodes which actually transmits a requested data packet to autonomously control transmission timing so as to ease burst reception at the request node. The bit rate Breq specified in the retransmission request packet 802 is used for multiple nodes within the logical network 100 realizing ease of burst reception in an autonomous distributed manner.

Now, with the present embodiment wherein the retransmission request packet 802 is used, the processing in FIG. 11 with reception of a data packet as a trigger will be transformed as follows.

Specifically, in Operation S306, the retransmission request unit 407 should calculate only the acquisition deadline Tstart, and does not have to calculate the completion deadline Tend. Instead, the retransmission request unit 407 determines the bit rate Breq to be set to the retransmission request packet 802 as appropriate. For example, it is desirable for the retransmission request unit 407 to set the retransmission request packet 802 to the buffer consumption rate cRate (see description regarding Expression (5)) as the bit rate Breq.

Also, in Operation S307, the retransmission request unit 407 generates a retransmission request packet 802 in stead of the retransmission request packet 801. Note that the retransmission request unit 407 sets the retransmission request packet 802 to a list including (Qto−Qfrom+1) sequence numbers of Nos. Qfrom (=Qlast+1) to Qto (=Q−1) as the retransmission list.

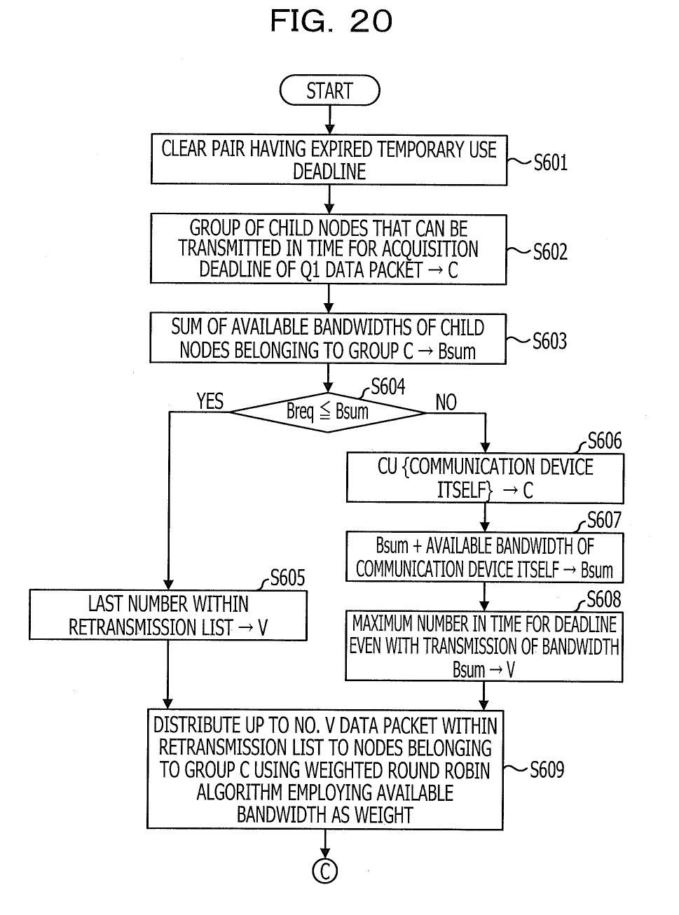

Further, with the present embodiment wherein the retransmission request packet 802 is used, the processing in FIGS. 16 through 17 will be transformed as FIGS. 20 through 21.

Description will be made below regarding the processing with reception of the retransmission request packet 802 as a trigger, with reference to the flowchart in FIGS. 20 through 21. Upon the reception unit 401 of the communication device 400 equivalent to the root node, a relay node, or a leaf node receiving the retransmission request packet 802 in FIG. 12, and outputting the retransmission request packet 802 to the load distribution processing unit 410, the load distribution processing unit 410 starts the processing in FIGS. 20 through 21.

With the processing in FIGS. 20 through 21, Operation S601 is an operation for initialization. Also, Operations S602 through S609 are operations for preferentially selecting a child node as a responsible node, and correlating part or all of partial particular information of the requested particular information with each of the responsible nodes. Operations S610 through S618 are operations for transmitting the retransmission request packet 802 to the responsible child nodes if there are responsible child nodes, and transmitting data packets if the communication device 400 itself is a responsible node. Operations S619 through S621 are operations for returning ACK or NACK to the direct transmission source node of the retransmission request packet 802.

Also, the sequence numbers included in the retransmission list of the retransmission request packet 802 in FIG. 12 may be arrayed in any order. However, for simplification of the processing, and for convenience of description, let us assume that the retransmission list has been sorted in the ascending order of sequence numbers. That is to say, with the example in FIG. 12, Q₁< . . . <Q_{M} holds.

In Operation S601, the selecting unit 411 performs the same processing as Operation S501. Specifically, with the child node information stored in the node information storage unit 408, of pairs of the temporary use bandwidth and the temporary use deadline, if there is a pair of which the temporary use deadline has been expired, the selecting unit 411 clears this pair. Similarly, with the own node information stored in the node information storage unit 408, of pairs of the temporary use bandwidth and the temporary use deadline, if there is a pair of which the temporary use deadline has been expired, the selecting unit 411 clears this pair.

In the next Operation S602, the selecting unit 411 obtains a group C of child nodes capable of performing transmission of data packets in time for the acquisition deadline of the data packet of the smallest sequence number (i.e., No. Q₁) within the retransmission list of the retransmission request packet 802. The group C is a group of responsible nodes.

Specifically, the selecting unit 411 obtains a group of child nodes where Expression (10) described again below holds.

Tstart−α>0 (10)

In the next Operation S603, the selecting unit 411 calculates the sum of the available bandwidth of a child node belonging to the group C (hereafter, referred to as “Bsum”). Specifically, the selecting unit 411 calculates, regarding each child node belonging to the group C, the available bandwidth of each child node by subtracting the sum of the temporary use bandwidth included in this entry from the transmittable total bandwidth of the entry of this node in the child node information. The selecting unit 411 calculates the summation of the available bandwidth calculated regarding each child node belonging to the group C. The summation thus obtained is the bandwidth Bsum.

Note that for later-described processing in Operation S609, the selecting unit 411 stores the value of the available bandwidth calculated regarding each child node. Also, as may be seen from the above definition, the available bandwidth of a certain child node is the summation of the current leeway that a node included in a subgraph with this certain child node as the root node in the topology of the logical network 100 may used for retransmission.

Next, in Operation S604, the selecting unit 411 compares the bit rate Breq specified in the retransmission request packet 802 received by the reception unit 401, and the calculated bandwidth Bsum. Note that as may be seen from the transmittable total bandwidth and temporary use bandwidth being indicated in increments of Mbps in FIG. 9, the bandwidth according to the present embodiment is a bit rate in other words. Accordingly, the bit rate Breq and the bandwidth Bsum may be compared.

In the case of Breq≦Bsum, transmission of a requested data packet may be handled by a child node alone, and accordingly, the communication device 400 itself does not have to be selected as a responsible node. Accordingly, the processing proceeds to Operation S605.

Conversely, in the case of Breq>Bsum, it is difficult for a child node alone to handle transmission of a requested data packet. Therefore, the selecting unit 411 also selects the communication device 400 itself as a responsible node, and accordingly, the processing proceeds to Operation S606. As described above, with the present embodiment, according to the determination in Operation S604, a child node is preferentially selected as a responsible node as compared to the communication device 400.

Incidentally, in the event that the retransmission list has been sorted as the above assumption, a range of data packets where the communication device 400 ensures transmission may be indicated using one certain sequence number within the retransmission list (hereafter, referred to as “V”). For example, if we say that the retransmission list is a list of (301, 304, 307, 310), and V=307, it is three data packets of which the sequence numbers are Nos. 301, 304, and 307 that the communication device 400 ensures transmission. The sequence number V will be set in Operation S605 or S608 as follows.

In Operation S605, the selecting unit 411 substitutes the final number Q_{M} within the retransmission list of the retransmission request packet 802 received by the reception unit 401 for the variable V. The processing then proceeds to Operation S609.

Also, in Operation S606, the selecting unit 411 adds the communication device 400 itself to the group C. That is to say, the selecting unit 411 selects the communication device 400 itself as a responsible node.

Further, in the next Operation S607, the selecting unit 411 references the own node information of the node information storage unit 408. The selecting unit 411 then calculates available bandwidth by subtracting the total of the temporary use bandwidth of the communication device 400 from the transmittable bandwidth of the communication device 400 itself (i.e., Bandwidth Bself in Expression (36)). The selecting unit 411 then increases the bandwidth Bsum by an amount equivalent to the calculated available bandwidth Bself of the communication device 400.

Also, in the next Operation S608, the selecting unit 411 calculates the maximum number in time for the deadline even with transmission of the bandwidth Bsum, and substitutes the calculation result for the variable V. Specifically, the selecting unit 411 calculates the maximum value satisfying Expression (39), and substitutes the calculation result for the variable V.

count(Q_{M})×pSize/Breq≧count(V)×pSize/Bsum (39)

Note that a function count(z) in Expression (39) is the number of No. z or smaller sequence numbers in the retransmission list of the retransmission request packet 802 received by the reception unit 401. For example, in the event that the retransmission list of the retransmission request packet 802 received by the reception unit 401 is a list of (102, 105, 108, 111), count(108)=3.

The left side of Expression (39) is a period taken for transmitting all of M data packets specified in the retransmission list of the retransmission request packet 802 received by the reception unit 401 at the specified bit rate Breq. Also, the right side of Expression (39) is a period taken for transmitting of the data packets specified in the retransmission list of the retransmission request packet 802 received by the reception unit 401, data packets having No. V or smaller sequence number at the bit rate of the available bandwidth Bsum. Accordingly, the maximum value satisfying Expression (39) is the maximum number in time for the deadline even with transmission at the bandwidth Bsum.

For example, let us say that count(Q_{M})=M=12, and also Bsum=0.7×Breq. In this case, the number V satisfying count(V)=8 is selected out of the retransmission list of the retransmission request packet 802 received by the reception unit 401. This is because, according to Expression (39), the number V is the maximum integer satisfying 12×0.7≧count(V).

Upon the range of data packets where the communication device 400 ensures transmission being determined in Operation S605 or S608, the processing subsequently proceeds to Operation S609. In Operation S609, the correlating unit 412 distributes up to No. V data packet within the retransmission list of the retransmission request packet 802 received by the reception unit 401 to nodes belonging to the group C using the weighted Round Robin algorithm using the available bandwidth as weight.

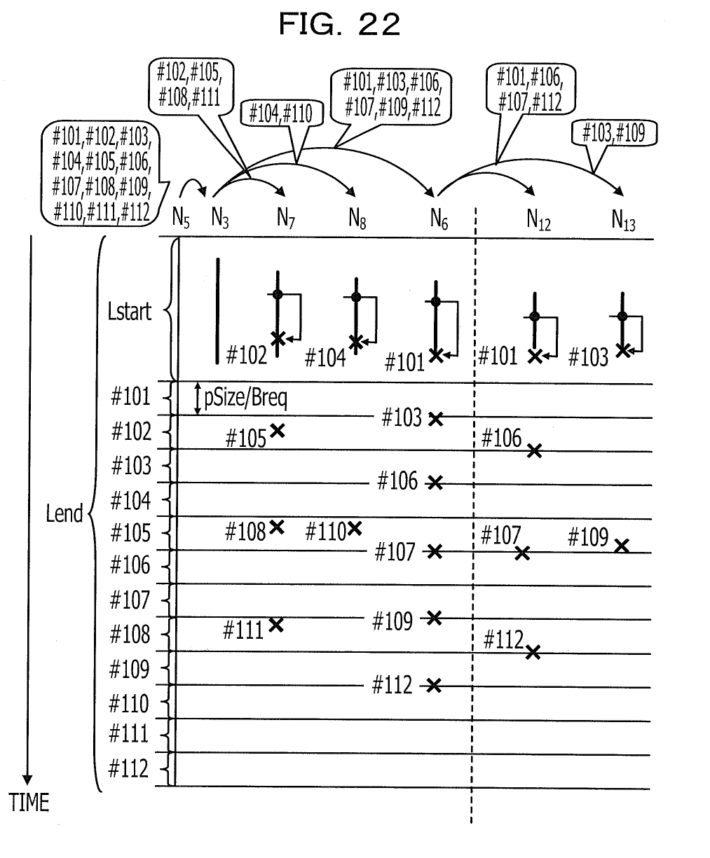

Now, a specific example of Operation S609 will be described with reference to FIG. 22. FIG. 22 is a diagram exemplifying transmission of data packets assigned according to a bit rate. In FIG. 22, the temporal axis toward from top to bottom is indicated with an arrow. Also, in FIG. 22, the retransmission list within the retransmission request packet 802 is indicated within a balloon. Other elements in FIG. 22 will be described later.

For example, with the example in FIG. 1, let us say that the retransmission list of the retransmission request packet 802 to be transmitted from the Node N₅ to the Node N₃ in Operation S20 includes 12 sequence numbers from No. 101 to No. 112. Let us say that the Node N₃ which has received the retransmission request packet 802 has started the processing in FIGS. 20 through 21, and the group C such as Expression (40) has been obtained.

C={N₆,N₇,N₈} (40)

Also, for convenience of description, let us say that the proportion of the available bandwidths of the Nodes N₆, N₇, N₈ is 3:2:1, respectively. In this case, in Operation S609, the correlating unit 412 of the Node N₃ assigns 6 (=12×3/(3+2+1)) data packets to the Node N₆, 4 (=12×2/(3+2+1)) data packets to the Node N₇, and 2 (=12×1/(3+2+1)) data packets to the Node N₈.

More specifically, in Operation S609, the correlating unit 412 sequentially assigns a number within the retransmission list of the retransmission request packet 802 received by the reception unit 401 to any node belonging to the group C using the weighted Round Robin algorithm. As a result thereof, for example, with the example in FIG. 22, Nos. 101 to 112 data packets are correlated with any one node such as the following (R-1) through (R-12).

(R-1) No. 101 data packet is correlated with the Node N₆.

(R-2) No. 102 data packet is correlated with the Node N₇.

(R-3) No. 103 data packet is correlated with the Node N₆.

(R-4) No. 104 data packet is correlated with the Node N₈.

(R-5) No. 105 data packet is correlated with the Node N₇.

(R-6) No. 106 data packet is correlated with the Node N₆.

(R-7) No. 107 data packet is correlated with the Node N₆.

(R-8) No. 108 data packet is correlated with the Node N₇.

(R-9) No. 109 data packet is correlated with the Node N₆.

(R-10) No. 110 data packet is correlated with the Node N₈.

(R-11) No. 111 data packet is correlated with the Node N₇.

(R-12) No. 112 data packet is correlated with the Node N₆.

The correlations shown in the above (R-1) through (R-12) are as shown in balloons in FIG. 22.

Also, the retransmission list of the retransmission request packet 802 that the Node N₃ transmits to the Node N₆ in Operation S30 in FIG. 1 is a list of (101, 103, 106, 107, 109, 112) in the example in FIG. 22. Now, let us assume that the Node N₆ which has received the retransmission request packet 802 has selected the child Nodes N₁₂ and N₁₃ as responsible nodes in the same way as with FIG. 1. That is, let us say that the selecting unit 411 of the Node N₆ which performs the processing in FIGS. 20 through 21 has obtained the group C such as Expression (41).

C={N₁₂,N₁₃} (41)

Also, let us say that the proportion of the available bandwidths of the Nodes N₁₂ and N₁₃ is 2:1. In this case, in Operation S609 the correlating unit 412 of the Node N₆ assigns 4 (=6×2/(2+1)) data packets to the Node N₁₂, and 2 (=6×1/(2+1)) data packets to the Node N₁₃.

More specifically, in Operation S609, the correlating unit 412 of the Node N₆ assigns a number within the retransmission list of the retransmission request packet 802 received by the reception unit 401 to the Node N₁₂ or N₁₃ using the weighted Round Robin algorithm. As a result thereof, for example, with the example in FIG. 22, the data packets of six sequence numbers specified in the retransmission list such as (101, 103, 106, 107, 109, 112) are correlated with the Node N₁₂ or N₁₃ such as the following (S-1) through (S-6).

(S-1) No. 101 data packet is correlated with the Node N₁₂.

(S-2) No. 103 data packet is correlated with the Node N₁₃.

(S-3) No. 106 data packet is correlated with the Node N₁₂.

(S-4) No. 107 data packet is correlated with the Node N₁₂.

(S-5) No. 109 data packet is correlated with the Node N₁₃.

(S-6) No. 112 data packet is correlated with the Node N₁₂.

The correlations shown in the above (S-1) through (S-6) are as shown in balloons in FIG. 22.

Note that FIG. 22 exemplifies, for simplification of description, a case where the proportion of available bandwidths of nodes belonging to the group C is a simple integer proportion. However, even in a case where the proportion of available bandwidths is not a simple integer proportion, it goes without saying that the correlating unit 412 may suitably perform assignment in Operation S609 using suitable rounding processing that may be used for the weighted Round Robin algorithm.

Now, description will return to description in FIGS. 20 through 21. After the correlating unit 412 correlates data packets with the responsible nodes as appropriate in Operation S609, the processing proceeds to Operation S610 in FIG. 21. In Operation S610, the load distribution processing unit 410 initializes an index i for sequentially focusing on a node within the group C to I.

Next, in Operation S611 the load distribution processing unit 410 determines whether or not i≦|C| holds (i.e., whether or not all of the nodes belonging to the group C have been focused on). Note that |C| is the number of elements of the group C.

If i≦|C| holds, a responsible node which the load distribution processing unit 410 has not focused on still remains. Therefore, the load distribution processing unit 410 focuses on the i'th node belonging to the group C. The processing then proceeds to Operation S612.

Conversely, if i>|C| holds, the load distribution processing unit 410 has already focused on all of the nodes of the group C. Therefore, the processing proceeds to Operation S619.

In Operation S612, the request generating unit 413 calculates the bit rate of the i'th node belonging to the group C. Now, for convenience of description, let us say that the number of elements of the retransmission list of the retransmission request packet 802 received by the reception unit 401 is M as shown in FIG. 12. Also, in Operation S609, the number of data packets that the correlating unit 412 has assigned to the i'th node within the group C will be referred to as “Xᵢ”. Thus, the calculation in Operation S612 is represented as Expression (42).

Breq2=Breq×Xᵢ/M (42)

Specifically, the request generating unit 413 proportionally distributes the bit rate Breq specified in the retransmission request packet 802 received by the reception unit 401 to the responsible nodes according to the number of data packets of which the transmission is ensured by the responsible nodes. For example, with the example in FIG. 22, the request generating unit 413 of the Node N₃ obtains 1/2 (=6/12) of the bit rate specified in the retransmission request packet 802 received from the Node N₅ as a bit rate for the Node N₆.

In the next Operation S613, the load distribution processing unit 410 determines whether or not the i'th node within the group C is the communication device 400 itself. In the event that the i'th node within the group C is the communication device 400 itself, the processing proceeds to Operation S614. Conversely, in the event that the i'th node within the group C is any child node of the communication device 400, the processing proceeds to Operation S615.

In Operation S614, the retransmission processing unit 414 starts transmission of the Xᵢ data packets that the correlating unit 412 has assigned to the communication device 400 itself. The processing for the retransmission processing unit 414 actually transmitting the Xᵢ data packets may be, for example, a child process of the processing in FIGS. 20 through 21, or may be a thread different from the processing in FIGS. 20 through 21.

Note that in Operation S614 the retransmission processing unit 414 performs processing for starting transmission of data packets. In parallel with the processing in the next Operation S617 and thereafter being performed, the retransmission processing unit 414 performs actual transmission of data packets.

Specifically, for example, in Operation S614, the retransmission processing unit 414 performs scheduling of transmission of the Xᵢ data packets that the correlating unit 412 has correlated with the communication device 400. The retransmission processing unit 414 then controls transmission of the Xᵢ data packets in accordance with the scheduling results.

For example, the retransmission processing unit 414 performs scheduling so as to immediately execute transmission of the first data packet assigned to the communication device 400, and also performs scheduling so as to hereafter transmit the remaining data packets with the transmission interval τ in Expression (43).

τ=pSize/Breq2=(pSize/Breq)×(M/Xᵢ) (43)

Incidentally, that data packets are transmitted at the bit rate Breq includes meanings specifically as the following (T-1) through (T-3).

(T-1) Transmission of data packets is intermittently performed with a certain transmission interval.

(T-2) As a result, the average bit rate of a certain length of time may be regarded as a quotient obtained by dividing the size per a data packet by a transmission interval.

(T-3) The above quotient is Breq.

Accordingly, the bit rate and transmission interval are inversely proportional. (pSize/Breq) in Expression (43) is a transmission interval when multiple data packets are transmitted at the bit rate Breq specified in the retransmission request packet 802 received by the reception unit 401. Accordingly, a transmission interval for realizing transmission at the bit rate Breq assigned as Expression (42) is as Expression (43).

Note that the retransmission processing unit 414 reads out the payload of a data packet to be transmitted from the buffer unit 403, and adds a suitable header in front of the payload, thereby generating a data packet addressed to a request node. The retransmission processing unit 414 may suitably set the header of a data packet by referencing the IP address A and port number P of a request source set to the retransmission request packet 802 received by the reception unit 401. The retransmission processing unit 414 then outputs the generated data packet to the transmission unit 402, and the transmission unit 402 transmits the data packet.

Note that after execution in Operation S614, the processing proceeds to Operation S617.

On the other hand, in Operation S615, the request generating unit 413 calculates an acquisition deadline to be set to a new retransmission request packet 802 for transmitting the i'th node within the group C. Specifically, the request generating unit 413 calculates an acquisition deadline Tstart2 in accordance with Expression (44).

Tstart2=Tstart−α+Iᵢ (44)

Note that the delay α in Expression (44) is the same as with Expression (10). Also, in Expression (44), the internal processing delay of the i'th node within the group C is referred to as “Iᵢ”. In Expression (44), the reason why the delay α is subtracted, and the internal processing delay Iᵢ is added is the same as the reason described regarding Expression (31) in Operation S508 in FIG. 16.

Also, in the next Operation S616, the request generating unit 413 generates a new retransmission request packet 802, and outputs to the transmission unit 402. The transmission unit 402 then transmits the retransmission request packet 802 to the i'th node within the group C.

Specifically, the request generating unit 413 sets the header of the new retransmission request packet 802 to a suitable value. The request generating unit 413 may obtain the transmission source IP address, transmission destination IP address, port number, and so forth to be set to the header of the retransmission request packet 801 with reference to the own node information and child node information within the node information storage unit 408.

Also, the request generating unit 413 sets the new retransmission request packet 802 to the acquisition deadline Tstart2 calculated in Operation S615, and the bit rate Breq2 calculated in Operation S612. Further, the request generating unit 413 copies the values of the IP address and port number of the retransmission destination of the retransmission request packet 802 received by the reception unit 401 to the fields of the IP address and port number of the retransmission destination of the new retransmission request packet 802. The request generating unit 413 sets the retransmission list of the new retransmission request packet 802 to a list of the X sequence numbers assigned to the i'th node within the group C by the correlating unit 412 in Operation S609.

In Operation S616, the new retransmission request packet 802 where values are set to the fields as described above is transmitted from the transmission unit 402. The processing then proceeds to Operation S617.

In Operation S617, the correlating unit 412 sets the temporary use bandwidth and temporary use deadline corresponding to the i'th node within the group C. Specifically, if the i'th node within the group C is the communication device 400, the correlating unit 412 adds a pair of the temporary use bandwidth and temporary use deadline to the own node information. Also, if the i'th node within the group C is any child node of the communication device 400, the correlating unit 412 adds a pair of the temporary use bandwidth and temporary use deadline to the entry of this child node within the child node information.

In any way, the correlating unit 412 sets the bit rate Breq2 that the request generating unit 413 has calculated in Operation S612 as the temporary use bandwidth. Also, the correlating unit 412 may set, for example, the point-in-time tmpT in Expression (45) as the temporary use deadline.

tempT=Now+(pSize×M/Breq)×(Xᵢ−1)/Xᵢ)+α (45)

Now in Expression (45) is the current point-in-time. Also, (pSize×M/Breq) in Expression (45) is a period taken for transmitting M data packets requested in the retransmission list of the retransmission request packet 802 received by the reception unit 401, at the specified bit rate Breq.

Also, the first data packet of the Xᵢ data packets assigned to the i'th node within the group C is predicted to be transmitted until the delay α in Expression (10) elapses. Accordingly, in the event that the Xᵢ data packets are transmitted with a certain interval, of the Xᵢ data packets assigned to the i'th node within the group C, predicted point-in-time when the final data packet is transmitted is point-in-time tmpT in Expression (45).

As described above with Operation S617, after the pair of the temporary use bandwidth and the temporary use deadline is added to the own node or child node information, the processing proceeds to Operation S618.

In Operation S618, the load distribution processing unit 410 then increments the index i by one. The processing returns to Operation S611.

Now, it is a case of |C|<i as described above in which the processing in Operation in S619 is executed. In Operation S619, the load distribution processing unit 410 determines whether or not the number V is the final number within the retransmission list of the retransmission request packet 802 received by the reception unit 401. In the event that the number V is the final number (i.e., in the case of V=Q_{M}), the processing proceeds to Operation S620. Conversely, in the event that the number V is not the final number (i.e., in the case of V<Q_{M}), the processing proceeds to Operation S621.

In Operation S620, the load distribution processing unit 410 generates an ACK packet for informing that transmission of all of the data packets specified in the retransmission list of the retransmission request packet 802 received by the reception unit 401 is ensured. The load distribution processing unit 410 then outputs the generated ACK packet to the transmission unit 402, and the transmission unit 402 transmits the ACK packet.

Note that, in the same way as with Operation S520 in FIG. 17, the transmission destination of the ACK packet is the direct transmission source node of the retransmission request packet 802 received by the reception unit 401. After transmission of the ACK packet, the processing in FIGS. 20 through 21 ends.

Also, in Operation S621, the load distribution processing unit 410 generates an error packet for informing that of the M data packets requested for transmission, a data packet of which the sequence number is greater than No. V is prevented from transmission. The load distribution processing unit 410 then outputs the generated error packet to the transmission unit 402, and the transmission unit 402 transmits the error packet.

Note that the transmission destination of the error packet is also the direct transmission source node of the retransmission request packet 802 received by the reception unit 401. After transmission of the error packet, the processing in FIGS. 20 through 21 ends.

Also, the operation of a node in the event of having received the error packet transmitted in Operation S621 may vary according to embodiments. The node which has received the error packet may, for example, perform processing similar to the processing described regarding the node which has received the error packet transmitted in Operation S521 or S522, and transmit a new retransmission request packet 802.

Next, the advantage of the retransmission control described with reference to FIGS. 20 through 21 will be described with reference to an example in FIG. 22 again.

In FIG. 22, with a column described as “N₅”, the period Lstart calculated in Operation S402 in FIG. 14 is indicated in the Node N₅ where elimination of data packets of which the sequence numbers are No. 101 through No. 112. Note that, with the present embodiment, the retransmission request unit 407 does not have to calculate the completion deadline Tend in Operation 306 in FIG. 11 as described above, and accordingly, the period Lend does not have to calculate the period Lend in Operation S402 in FIG. 14. However, for convenience of description, with the column described as N₅ in FIG. 22, the period Lend is also indicated. Period difference (lend−Lstart) is a period taken for the playing processing unit 404 of the Node N₅ consuming 12 data packets from No. 101 through No. 112.

Also, in FIG. 22, a period taken for consumption of individual data packets is also indicated by a lateral line. As described above, it is desirable that Breq=cRate, and accordingly, a case of Breq=cRate is exemplified in FIG. 22. Specifically, a period taken for consumption of one data packet is an interval between two lateral lines adjacent in FIG. 22, and length thereof is pSize/Breq (=pSize/cRate).

Also, the length of a heavy vertical line in FIG. 22 indicates the length of the acquisition deadline specified in the retransmission request packet 802. For example, the vertical line of the column described as “N₃” indicates the length of the acquisition deadline specified in the retransmission request packet 802 that the node N₃ receives from the Node N₅. The vertical lines of other columns are also the same. Also, the upper end position of each of the vertical lines corresponds to the reception point-in-time of the retransmission request packet 802.

Also, a small black circle overlapped on a vertical line indicates point-in-time when a node which has requested transmission of data packets actually starts transmission of the data packets. A node to be selected as a responsible node satisfies a constraint condition regarding the acquisition deadline, and accordingly, each circle in FIG. 22 is positioned between the upper end and the lower end of the vertical lines.

For example, transmission of Nos. 102, 105, 108, and 111 data packets is assigned to the Node N₇ as described above. A circle of a column described as “N₇” indicates point-in-time when the Node N₇ transmits the first (i.e., No. 102) data packet of the assigned data packets.

Note that a circle of a column described as “N₆” indicates point-in-time when the Node N₆ transmits No. 101 data packet in the event of assuming that the Node N₆ transmits data packets by itself without leaving transmission of data packets to the Nodes N₁₂ and N₁₃. Conversely, in the event of transmission of data packets having been left to the Nodes N₁₂ and N₁₃, the Node N₁₂ transmits No. 101 data packet at the point-in-time that a circle of a column of “N₁₂” indicates, and the Node N₁₂ transmits No. 103 data packet at the point-in-time that a circle of a column of “N₁₃” indicates.

Also, an X-mark in FIG. 22 indicates point-in-time when a transmitted data packet is received at the request Node N₅. An arrow directed from a circle to an X-mark indicates delay until the request Node N₅ receives the data packet.

For example, with a column described as “N₇”, four X-marks indicating points-in-time when Nos. 102, 105, 108, and 111 data packets transmitted from the Node N₇ are received at the Node N₅, are indicated respectively. Upon a data packet being transmitted in accordance with the scheduling described in connection with Operation S614 in FIG. 21, as shown in FIG. 22, regarding an arbitrary sequence number Q, No. Q data packet is received at the request node by the acquisition deadline of No. Q data packet.

Also, for example, four data packets are assigned to the Node N₇. Accordingly, the bit rate specified in the retransmission request packet 802 that the Node N₃ transmits to the Node N₇ is 4/12 of the bit rate specified in the retransmission request packet 802 that the Node N₅ transmits to the Node N₃. Accordingly, in FIG. 22, the four X-marks of the column described as “N₇” are arrayed with an interval (pSize/Breq)/(4/12). Similarly, the interval between the two X-marks of the column of the Node N₈ to which two data packets are assigned is (pSize/Breq)/(2/12).

Also, in the event that the Node N₆ transmits data packets by itself without leaving transmission of data packets to the Nodes N₁₂ and N₁₃, the Node N₆ consequently transmits six data packets. Accordingly, with the column of “N₆”, six X-marks arrayed with an interval of (pSize/Breq)/(6/12) are indicated.

Conversely, in the event of the Node N₆ leaving transmission of data packets to the Nodes N₁₂ and N₁₃, the Node N₁₂ transmits four data packets, and the Node N₁₃ transmits two data packets. Accordingly, with the column in “N₁₂”, the four X-marks arrayed with the interval (pSize/Breq)/(4/12) are indicated, and with the column in “N₁₃”, the two X-marks arrayed with the interval (pSize/Breq)/(2/12) are indicated.

As described above, in FIG. 22, for convenience of description, both of a case where the Node N₆ selects only the Node N₆ as a responsible node, and a case where the Node N₆ selects only two child Nodes N₁₂ and N₁₃ are illustrated. However, even in either case, the nodes transmit data packets with a suitable interval. As a result thereof, 12 data packets requested for transmission are received by the Node N₅ averagely at the bit rate Breq that the Node N₅ has first specified.

Accordingly, a situation does not readily occur wherein convergence occurs since No. 101 through 112 data packets are received in a burst manner and focused in a short time at the Node N₅ or a router closer to the Node N₅ over the physical network. That is to say, the bit rate is proportionally distributed according to the number of data packets specified in the retransmission list, and accordingly, burst reception is eased. As a result thereof, a situation may be avoided wherein a part or all of the retransmitted data packets are eliminated.

It goes without saying that, as exemplified in FIG. 22, a part (e.g., two through four data packets) of the 12 data packets requested for retransmission may be received at the Node N₅ at mutually approximated points-in-time. For example, in the event that the Node N₆ has selected the Nodes N₁₂ and N₁₃ as responsible nodes, the reception points-in-time of four data packets of Nos. 101 through 104 at the request Node N₅ are mutually approximated.

However, with the present embodiment, convergence does not readily occur. A reason thereof is that even if the reception points-in-time of certain multiple data packets are mutually approximated, a certain length of interval opens by reception of the next one or multiple data packet subsequently to reception of the certain multiple data packets.

For example, as shown in FIG. 22, even if the reception points-in-time of the four data packets of Nos. 101 through 104 at the request Node N₅ are extremely approximated, an interval of around (pSize/Breq)×3 opens by reception of the next No. 105 data packet, and accordingly, the request Node N₅ or a router closer to the Node N₅ over the physical network may finish processing regarding the four data packets of Nos. 101 through 104 arrived in a temporally concentrated manner by using this period of (pSize/Breq)×3. Accordingly, packet loss due to buffer overflow or the like does not readily occur at the request Node N₅ or a router closer to the Node N₅ over the physical network.

For example, as compared to a case where the nodes transmit data packets at the highest bit rate possible (i.e., a case where an interval by the next reception is extremely short), an advantage according to avoidance of convergence from the example in FIG. 22 (in other words, advantage for easing burst reception) is apparent.

As described above, reception of the 12 data packets at the Node N₅ is achieved averagely at the bit rate Breq as a whole. Control for holding the bit rates averaged as a whole for transmission of data packets from the multiple nodes to the bit rate Breq that the request Node N₅ has specified is realized in an autonomous distributed manner via the bit rate field of the retransmission request packet 802 as described above.

For example, let us say that four nodes of the Nodes N₇, N₈, N₁₂, and N₁₃ actually transmit data packets. In this case, each of the four nodes performs scheduling of transmission in an autonomous distributed manner in accordance with the received retransmission request packet 802, and accordingly, the averaged reception bit rate Breq at the request Node N₅ is realized.

Note that, in order to further ease burst reception, in Operation S615 in FIG. 21 the request generating unit 413 may calculate the acquisition deadline Tstart2 using Expression (46) instead of Expression (44). “Fᵢ” in Expression (46) is the sequence number of the first data packet of the Xᵢ data packets that the correlating unit 412 has correlated with the i'th node within the group C.

Tstart2=Tstart−α+Iᵢ+pSize/Breq×(Fᵢ−Q₁) (46)

For example, with the example in FIG. 22, in the event that the request generating unit 413 of the Node N₃ focuses on the Node N₈ as the i'th node within the group C, the sequence numbers of data packets correlated with the Node N₈ are Nos. 104 and 110, and accordingly, Fᵢ₌₁₀₄ holds. Also, the first sequence number of the retransmission list of the retransmission request packet 802 received by the Node N₃ is No. 101, and accordingly, Qᵢ=101 holds. Accordingly, the acquisition deadline Tstart2 calculated from Expression (46) is slower than the acquisition deadline Tstart2 calculated from Expression (44) by an amount equivalent to the consumption period of the three data packets (specifically, Nos. 101 through 103 data packets).

Even in the case that the request generating unit 413 calculates the acquisition deadline Tstart2 using Expression (46), as may be seen from FIG. 22, the data packets are received at the request node by the acquisition deadline at the request Node N₅. Also, the request generating unit 413 calculates the acquisition deadline Tstart2 using Expression (46), and accordingly, a degree where the reception points-in-time of multiple data packets are temporally concentrated at the request Node N₅ is further eased.

Further, the bit rate autonomous distribution control as described above is realized without sacrificing reception within the deadline. Specifically, according to the scheduling described in connection with Operation S614, the Node N₅ may receive the data packets at timing indicated by an X-mark in FIG. 22. The timing indicated with an X-mark in FIG. 22 apparently indicates that regarding an arbitrary sequence number Q, No. Q data packet is received at the request node by the acquisition deadline of No. Q data packet.

Now, the present invention is not restricted to the above embodiment, and the above embodiment may be modified in various manners. Several viewpoints for modifying the above embodiment will be exemplified below. For example, the above embodiment may be modified in various manners from the following viewpoints, the above exemplified several modifications and the following modifications may be optionally combined as long as these do not conflict with each other.

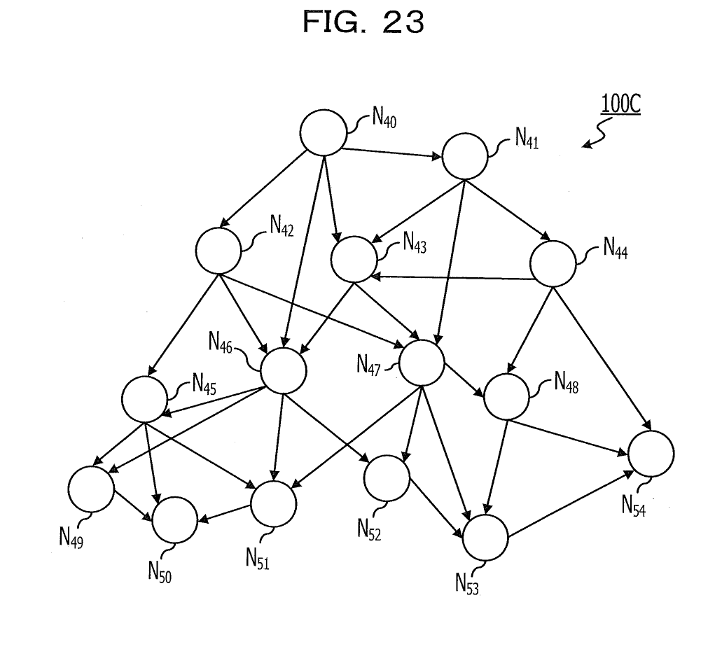

A first viewpoint for modification relates to the topology of the logical network. For example, the retransmission control according to the above embodiment may be applied to a data distribution system where data packets are distributed over a logical network of mesh-type topology instead of the logical network 100 of the tree-type topology as FIG. 2. FIG. 23 is a diagram illustrating an example of the logical network of the mesh-type topology.

For example, the logical network 100c in FIG. 23 is the logical network of the mesh-type topology including Nodes N₄₀ through N₅₄. The topology of the logical network 100c is represented with a directed acyclic graph (DAG) in FIG. 23.

Even in the event of a mesh-type logical network as the logical network 100c, if this network is a logical network capable of representing the topology using a directed graph, a parent node and a child node are definable. Specifically, over the logical network, when there is an edge from a certain Node Nⱼ to another Node Nₖ, the Node Nₖ is a child node of the Node Nⱼ, and the Node Nⱼ is the parent node of the Node Nₖ.

With the mesh-type logical network 100c, there is also a node having multiple parents. For example, the Node N₄₅ has three parent Nodes N₄₀, N₄₂, and N₄₃, and has four child Nodes N₄₅, N₄₉, N₅₁, and N₅₂. In the case of having multiple parent nodes, the parent node information of the node information storage unit 408 also includes multiple entries.

Also, the logical network of which the topology is represented with a DAG has no closed path, and accordingly, regarding an arbitrary Node Nⱼ, a subgraph with the Node Nⱼ as the root node may be defined based on the relationship between a parent node and a child node.

Specifically, in the event that the Node Nⱼ has no child node, a subgraph with the Node Nⱼ as the root node includes only the Node Nⱼ, and includes no edge. Conversely, in the event that the Node Nⱼ has a child Node Nₖ, all of the nodes belonging to a subgraph with the Node Nₖ as the root node, and the Node Nⱼ belong to the subgraph with the Node Nⱼ as the root node. Also, in the event that the Node Nⱼ has a child Node Nₖ, all of the edges belonging to a subgraph with the Node Nₖ as the root node, and an edge from the Node Nⱼ to the Node Nₖ belong to the subgraph with the Node Nⱼ as the root node.

Thus, with the mesh-type logical network 100c as well, regarding an arbitrary Node Nⱼ, the transmittable total bandwidth Total(Nᵢ) of the Node Nⱼ is definable. That is to say, the transmittable total bandwidth Total(Nⱼ) of the Node Nⱼ is the sum of the transmittable bandwidths of all of the nodes belonging to the subgraph with the Node Nⱼ as the root node.

However, with regard to a notification and recognition of the transmittable total bandwidth, there is the following difference between the mesh-type logical network 100c and the tree-type logical network.

With the tree-type logical network 100, all of the nodes other than the root node always have one parent node. Therefore, the nodes operate in accordance with the flowchart in FIG. 10, whereby the nodes may correctly recognize and store the transmittable total bandwidth.

On the other hand, if the nodes within the logical network 100c operate in accordance with the flowchart in FIG. 10, the value of the transmittable total bandwidth to be recorded in the own node information of the node information storage unit 408 of the Node Nⱼ is not necessarily Total(N) defined as described above.

For example, with the logical network 100c, the Node N₄₅ has child Nodes N₄₉, N₅₀, and N₅₁, the Node N₄₉ has the child Node N₅₀, the Node N₅₁ has the child Node N₅₀, and the Node N₅₀ has no child node. In other words, the Node N₅₀ has three parent Nodes N₄₅, N₄₉, and N₅₁, and of these, the two parent Nodes N₄₉ and N₅₁ happen to be an offspring node of the other parent Node N₄₅ of the Node N₅₀.

Accordingly, in the event that the nodes within the logical network 100c operate in accordance with the flowchart in FIG. 10, processing such the following (U-1) through (U-4) will be performed.

(U-1) The Node N₅₀ informs the transmittable bandwidth Reserved (N₅₀) of the Node N₅₀ to all of the three parent Nodes N₄₅, N₄₉, and N₅₀ as the transmittable total bandwidth of the Node N₅₀.

(U-2) The Node N₄₉ calculates the sum of the transmittable bandwidth Reserved (N₅₀) of the Node N₅₀ informed in (U-1), and the transmittable bandwidth Reserved (N₄₉) of the Node N₄₉. The Node N₄₉ then informs the calculation result to both of the two parent Nodes N₄₅ and N₄₆ as the transmittable total bandwidth of the Node N₄₉.

(U-3) The Node N₅₁ calculates the sum of the transmittable bandwidth Reserved (N₅₀) of the Node N₅₀ informed in (U-1), and the transmittable bandwidth Reserved (N₅₁) of the Node N₅₁. The Node N₅₁ then informs the calculation result to all of the three parent Nodes N₄₅, N₄₆, and N₄₇ as the transmittable total bandwidth of the Node N₅₁.

(U-4) The Node N₄₅ calculates the sum of the values informed in (U-1), (U-2) and (U-3), and the transmittable bandwidth Reserved (N₄₅) of the Node N₄₅. The Node N₄₅ then informs the calculation result to both of the two parent Nodes N₄₂ and N₄₆ as the transmittable total bandwidth of the Node N₄₅.

With the value that the Node N₄₅ informs the parent Nodes N₄₂ and N₄₆ in the above (U-4), the transmittable bandwidth Reserved (N₅₀) of the Node N₅₀ has triply been counted. Accordingly, the value informed from the Node N₄₅ in (U-4) is greater than the sum of the transmittable bandwidths of all of the nodes belonging to the subgraph with the Node N₄₅ as the root node. In other words, the value informed from the Node N₄₅ in (U-4) is not the exact value of the transmittable total bandwidth Total(N₄₅) according to the above definition.

Therefore, with an embodiment using the logical network of the mesh-type topology such as the logical network 100c, for example, the following two principles may be employed.

The first principle is a principle that duplicated count such as the above (U-4) is acceptable. In other words, the first principle depends on a position that with the processing according to the flowchart in FIG. 10, the nodes are not always able to recognize the exact transmittable total bandwidth, but the values to be informed are available as an estimated value of the transmittable total bandwidth.

According to the first principle, the processing in FIG. 10 does not basically have to be modified. That is to say, the first principle differs from the above embodiment in that the number of parent nodes that are notification destinations may be greater than one in Operation S211 in FIG. 10, but other points are the same. Therefore, according to the first principle, the calculation method in Operation S209 does not have to be changed, and the calculation result in Operation S209 is informed to the parent nodes without change in Operation S211.

Even in the event of the above first principle having been employed, as long as reselection of a responsible node is performed as appropriate according to the error packet transmitted in Operation S521, S522, or S621, no problem is caused in particular.

Also, duplicated count is not necessarily frequently caused such as the above (U-4) depending on the topology of a logical network. That is to say, error between the value to be informed in accordance with the flowchart in FIG. 10, and the correct transmittable total bandwidth in accordance with the definition may be small. If the error is small, the influence of the error may be ignored, and accordingly, the first principle is valid.

Also, the nodes within the logical network 100c do not recognize the topology of the entire logical network 100c. Accordingly, the nodes do not recognize whether or not duplicated count such as the above (U-4) occurs, neither. The first principle does not have to include additional processing for recognizing the topology serving as a cause of duplicated count such as the above (U-4), and accordingly, the first principle is suitable for a P2P system where the nodes do not recognize the topology of the entire logical network 100c.

Note that, in the event that the first principle is employed, in order to improve reliability that transmission of a requested data packet is ensured, a node which has received a retransmission request packet may perform additional processing. Specifically, in the event that a node having multiple parent nodes has received the retransmission request packet from one of the parent nodes, this node may transmit the same notification as with a later-described ninth viewpoint to all of the other parent nodes. Though the details will be described later along with the ninth viewpoint, bandwidth to be temporarily consumed according to the retransmission request packet from one of the parent nodes is formed to the other parent nodes, whereby occurrence of an error (i.e., NACK) may be prevented beforehand.

Now, the second principle is a principle that duplicated count such as the above (U-4) is avoided. Specifically, according to the second principle, the calculation method of the bandwidth to be informed in Operation S211 in FIG. 10 will be changed.

With the processing in FIG. 10, the value calculated in Operation S209 is informed in Operation S211. However, according to the processing modified in accordance with the second principle, a value obtained by dividing the value calculated in Operation S209 by the number of parent nodes is informed in Operation S211.

A second viewpoint of the modification relates to selection of a responsible node, and assignment of data packets in the event that there are multiple child nodes.

The processing in FIGS. 16 through 17 is processing for assigning, in order from an earlier found child node, as many data packets as possible to the found child node as long as a constraint condition regarding the retransmission deadline is satisfied. In other words, the processing in FIGS. 16 through 17 is processing based on a greedy algorithm, and has an advantage that the processing flow is simple. However, in order to further improve the fairness of load between nodes, the processing in FIGS. 16 through 17 may be modified.

For example, in the event that a certain node has five child nodes, and this “certain node” receives the retransmission request packet 801 any number of times, according to the processing in FIGS. 16 through 17, load may be biased as the tendency of a total of the multiple retransmission requests. Specifically, a node within the subgraph with the first child node of this “certain node” as the root node is frequently apt to actually take on transmission of data packets as compared to a node within the subgraph with the fifth child node of this “certain node” as the root node.

Therefore, in order to make the bias of load even as a total of multiple retransmission requests, the selecting unit 411 may focus on the multiple entries of the child node information in random order instead of a determined order (e.g., focusing in order from the first entry). Alternatively, instead of the processing according to the greedy method such as FIGS. 16 through 17, processing according to proportional distribution may be performed.

For example, the selecting unit 411 may temporarily select all of the child nodes of the communication device 400 as responsible nodes. The correlating unit 412 may calculate the currently available bandwidth (i.e., bandwidth B in Expression (28)) of each of the child nodes, and temporarily perform proportional distribution of requested (Qto−Qfrom+1) data packets as to all of the nodes based on the currently available bandwidth.

For example, let us say that in Operation S20 in FIG. 1, the Node N₃ has received the retransmission request packet 801 for requesting transmission of 8 data packets from No. 61 to No. 68. In response to this, the selecting unit 411 of the Node N₃ temporarily selects all of the three child Nodes N₆, N₇, and N₈ as responsible nodes. Also, if we say that the currently available bandwidth proportion of the Nodes N₆, N₇, and N₈ is 2:1:1, respectively, the correlating unit 412 of the Node N₃ temporarily assign by proportional distribution four data packets to the Node N₆, two data packets to the Node N₇, and two data packets to the Node N₈, respectively.

Thereafter, the correlating unit 412 checks whether or not the child nodes satisfy the constraint condition according to the retransmission deadline, and also ensure transmission of the number of data packets temporarily assigned with proportional distribution. If there is a child node which does not ensure transmission of the temporarily assigned number of data packets, the correlating unit 412 adjusts the temporarily assigned number of data packets.

With regard to transmission of data packets having the same sequence number, it is difficult for a child node having the great delay α in Expression (9) to satisfy the constraint condition as compared to a child node having the small delay α. Therefore, the correlating unit 412 may perform the above check processing, for example, in order from a child node having the small delay α (i.e., a child node having a high probability to satisfy the constraint condition).

For example, in the event that the number of data packets temporarily assigned to the Nodes N₆, N₇, and N₈ are 4, 2, and 2 data packets respectively as described above, let us say that the delay α of the Node N₈ is the minimum, the delay α of the Node N₆ is the second minimum, and the delay α of the Node N₇ is the maximum.

In this case, the correlating unit 412 of the Node N₃ first checks in order of the smaller delay α whether or not the Node N₈ with the minimum delay a may ensure transmission regarding two data packets of Nos. 61 and 62 while satisfying the constraint condition regarding the retransmission deadline. If “possible” is apparent as the check result, the correlating unit 412 actually correlates the two data packets of Nos. 61 and 62 with the Node N₈. Alternatively, if only No. 61 data packet may ensure transmission while satisfying the constraint condition as the check result for example, the correlating unit 412 actually correlates only No. 61 data packet to the Node N₈.

Next, the correlating unit 412 checks whether or not the Node N₆ with the second minimum delay α may ensure transmission regarding data packets having four sequence numbers immediately after being assigned to the Node N₈ while satisfying the constraint condition regarding the retransmission deadline. For example, in the event of having actually assigned Nos. 61 to 62 data packets to the Node N₈, the correlating unit 412 checks whether or not the Node N₆ may ensure transmission of four data packets of Nos. 63 to 66. Alternatively, in the event of having actually assigned No. 61 data packet alone to the Node N₈, the correlating unit 412 checks whether or not the Node N₆ may ensure transmission of four data packets of Nos. 62 to 65.

The correlating unit 412 then determines, according to the check result, the range of the sequence numbers of data packets to be actually assigned to the Node N₆. Also, the correlating unit 412 performs, in the same way as with the above, the check processing and actual assignment of data packets regarding the Node N₇ with the maximum delay α.

Also, the correlating unit 412 substitutes the sequence number of a data packet actually assigned to the Node N₇ with the maximum delay α for the variable V. In the case of V<Qto, the processing in Operation S514 and thereafter in FIG. 17 are subsequently performed, and in the case of V≧Qto, the processing in Operation S520 is subsequently performed.

For example, the processing in FIGS. 16 through 17 based on the greedy method may be modified to processing based on proportional distribution as described above.

A third viewpoint for modification relates to a resource other than the transmittable total bandwidth. As described above, the transmittable total bandwidth is also referenced at the time of the selecting unit 411 selecting a child node which may be selected as a responsible node, and also referenced at the time of the correlating unit 412 determining a data packet to be correlated with a responsible node.

However, the bandwidth is an example of a resource that the nodes use. The nodes additionally use a CPU resource and a memory resource. The amount of the CPU resources is measured, for example, by the clock frequency of the CPU 301. The amount of the memory resources is measured, for example, by the number of bytes of the RAM 302.

For example, in the event that there are two child nodes having the same available bandwidth, the correlating unit 412 may correlate many more data packets with a node having many more CPU resources, or may correlate many more data packets with a node having many more memory resources. The correlating unit 412 may determine the amount of data packets to be correlated with each responsible node in accordance with an evaluated value for totally evaluating the amount of multiple kinds of resources such as bandwidth, CPU resources, memory resources, and so forth.

Therefore, the nodes may inform, in the same way as with the transmittable total bandwidth, the amount of various resources that the correlating unit 412 references to a parent node. Also, the nodes may manage, in the same way as with the temporary use bandwidth, the amount of resources being temporarily used regarding the amount of various resources.

That is to say, the reception unit 401 may receive total resource information indicating the total amount of the resources of a node included in a subgraph with a child node of the communication device 400 as the root node in the topology of the logical network, from this child node.

The node information managing unit 409 may store the total resource information received by the reception unit 401 in the node information storage unit 408 as the child node information in a manner correlated with this child node. Also, the node information generating unit 409 may calculate a total of the amount of the resources of the communication device 400 itself, and the total amount that the total resource information received from the child nodes and stored indicates, as total resource information regarding the communication device 400 itself. As a result thereof, the transmission unit 402 may transmit new total resource information calculated by the node information managing unit 409 to the parent node of the communication device 400. The transmittable total bandwidth is an example of the total amount of resources that the above total resource information represents.

As described above, in the event that notification of the total resource information regarding a certain resource is performed regardless of bandwidth, the correlating unit 412 may obtain available total resource information corresponding to a responsible child node by referencing the node information storage unit 408. A specific example of the available total resource information is, for example, bandwidth obtained by subtracting the sum of temporary use bandwidths from the transmittable total bandwidth (e.g., bandwidth B in Expression (28)).

The available total resource information of a certain child node is, in other words, information indicating the total amount of the available resources of a node included in a subgraph with this child node as the root node. In order to enable recognition of the available total resource information, after correlating the partial particular information with a responsible node, the correlating unit 412 calculates the amount of resources to be consumed according to load placed on transmission of this correlated partial particular information. Further, the correlating unit 412 stores consumption resource information indicating the calculated amount in the node information storage unit 408 in a manner correlated with this responsible node and valid deadline.

The temporary use bandwidth in FIG. 9 is a specific example of the above consumption resource information, and the temporary use deadline in FIG. 9 is a specific example of the above valid deadline. As described above, the same management as with the bandwidth may be performed, and assignment according to the amount of available resources may be performed, regardless of the types of resources.

Also, the selecting unit 411 of a node which has received a retransmission request packet preferentially selects a child node as a responsible node as compared to this node itself, but the principle that a child node is prioritized is, in other words, as follows.

Specifically, in the event that the communication device 400 has one or more child nodes, the selecting unit 411 selects a child node as a responsible node by prioritizing the child node over the communication device 400 itself regardless of the amount of the resources of the communication device 400 itself. Even if the amount of resources that the communication device 400 itself may use is greater than the total resource amount of individual child nodes, the selecting unit 411 first focuses on a child node as a candidate of a responsible node. Thus, with a logical network used as a relay network for distribution of data packets, a probability that a node more distant (i.e., further downstream) from the root node will perform transmission of data packets increases.

It goes without saying that in the event that the communication device 400 has no child node, the selecting unit 411 may select the communication device 400 itself as a responsible node.

A fourth viewpoint of the modification relates to the retransmission deadline. With the above embodiment, the retransmission deadline is represented with a pair of the acquisition deadline and completion deadline, or a pair of the acquisition deadline and bit rate, and transfer to a child node, and transmission of actual data packets are performed so as to satisfy the restraint condition regarding the retransmission deadline. However, the payload of a data packet may be data having real time nature depending on applications of the logical network. With an embodiment where distribution of data of a kind having no real time constraint is performed, the retransmission deadline does not have to be taken into consideration.

That is to say, the acquisition deadline and completion deadline may be omitted from the retransmission request packet 801, and the acquisition deadline may be omitted from the retransmission request packet 802. However, in order to avoid burst reception, it is desirable that the bit rate field remains in the retransmission request packet 802 having the format from which the acquisition deadline is omitted, which is used for control of the transmission bit rate.

With an embodiment where the nodes do not take the retransmission deadline into consideration, the selecting unit 411 may simply select all of the child nodes as responsible nodes. The correlating unit 412 may proportionally distribute a data packet requested in the retransmission request packet received by the reception unit 401 according to the available total resource information such as the bandwidth B in Expression (28).

A fifth viewpoint for modification relate to estimation of the delay α. Contrary to the example shown in the forth viewpoint, in the event that the retransmission deadline is taken into consideration such as FIGS. 16 through 17, or FIGS. 20 through 21, the delay α is employed. The delay α includes the above (Q-1) through (Q-4), and as described above, the length of the period in (Q-4) is estimated in accordance with a suitable approximation model.

However, in the event that a retransmission request from the same request node occurs twice or more without change in the topology of the logical network 100, the length of the period in (Q-4) may be estimated based on an actual measurement value with the second retransmission and thereafter. That is to say, with the second retransmission and thereafter, the period in (Q-4) may be estimated using an approximation model in the same way as the first time, but the period in (Q-4) may be estimated based no an actual measurement value.

The estimation of the period in (Q-4) based on an actual measurement value may be performed by the a child node which has received a retransmission request packet from the parent node measuring RTT between this child node itself and the request node, and storing and informing the measurement result to the parent node.

For example, as shown in FIG. 1, let us assume that it has repeatedly been performed that the Node N₅ transmits a retransmission request to the Node N₃. Let us say that the first retransmission request has been transferred as shown in FIG. 1.

In response to this, the Node N₆ which has received the retransmission request from the parent Node N₃ measures RTT between the Node N₆ itself and the request Node N₅ specified in the retransmission request at optional timing (e.g., when network load is low, or the like). The Node N₆ then stores the measurement result in the node information storage unit 408, and also informs to the parent Node N₃.

Similarly, the Node N₇ measures RTT between the Node N₇ and the Node N₅, stores the measurement result, and also informs to the parent Node N₃. Also, the Node N₈ measures RTT between the Node N₈ and the Node N₅, stores the measurement result, and also informs to the parent Node N₃.

Further, similarly, the Node N₁₂ measures RTT between the Node N₁₂ and the Node N₅, stores the measurement result, and also informs to the parent Node N₆. Also, the Node N₁₃ measures RTT between the Node N₁₃ and the Node N₅, stores the measurement result, and also informs to the parent Node N₆.

Also, the Node N₃ which has received the retransmission request from the Node N₅ which is not the parent node measures RTT between the Node N₃ itself and the request Node N₅ which is the transmission source of the retransmission request at optional timing (e.g., when network load is low, or the like). The Node N₃ then stores the measurement result in the node information storage unit 408.

In the event that the Node N₅ has transmitted the retransmission request to the Node N₃ again, the Node N₃ may calculate the delay in (Q-4) regarding the child Node N₆ (i.e., D_{6, 5}−D_{3, 5}) from RTT_{6, 5} informed from the child Node N₆, and RTT_{3, 5} measured by the Node N₃ itself. Similarly, the Node N₃ may also calculate the delay in (Q-4) regarding the child Node N₇ from the actually measured RTT, and also calculate the delay in (Q-4) regarding the child Node N₈ from the actually measured RTT.

Further, let us assume that according to the second retransmission request from the Node N₅, the Node N₃ has selected the Node N₆ as a responsible node. The Node N₆ then receives the retransmission request packet from the Node N₃. In this case, the Node N₆ may calculate the delay in (Q-4) regarding the child Node N₁₂ (i.e., D_{12, 5}−D_{6, 5}) from RTT_{12, 5} informed from the child Node N₁₂, and RTT_{6, 5} measured by the Node N₆ itself. Similarly, the Node N₆ may also calculate the delay in (Q-4) regarding the child Node N₁₃ from the actually measured RTT,

In this way, with the second retransmission and thereafter, the period in (Q-4) may be estimated based on an actual measurement value. As a result thereof, the delay α is estimated in a more accurate manner, and more suitable assignment is realized.

A sixth viewpoint for modification relates to synchronization between nodes, and expression of a deadline. The logical network may be a synchronous system or asynchronous system depending on embodiments. Specifically, the built-in clocks of the nodes within the logical network may all be synchronized, or may not be synchronized.

For example, in the event that the communication device 400 which realizes the nodes within the logical network 100 is an STB (Set Top Box), the logical network 100 is synchronous system. This is because a point-in-time synchronizing signal is included in television broadcast waves.

Also, the data distribution application program may include the program code of point-in-time synchronizing processing according to the NTP (Network Time Protocol) or the like. In this case, the clocks of all of the nodes making up the logical network 100 which operate in accordance with this data distribution application program, and are synchronized.

Conversely, the data distribution application program may not include the program code of the point-in-time synchronizing processing. Moreover, the communication device 400 may be a device which is not always synchronized with standard point-in-time, for example, a personal user's PC, or the like. In this case, the logical network 100 is an asynchronous system.

When the logical network 100 is an asynchronous system, the retransmission deadline specified in the retransmission request packet 801 or 802 is represented with the length of a period. However, when the logical network 100 is a synchronous system, the retransmission deadline specified in the retransmission request packet 801 or 802 may be represented with the length of a period, or may be represented with absolute point-in-time.

Note that, with an embodiment where the retransmission deadline is represented with absolute point-in-time, the processes of several operations will be modified as follows.

First, in Operation S404 in FIG. 14, the retransmission request unit 407 calculates the acquisition deadline Tstart and completion deadline Tend in accordance with Expressions (47) and (48) instead of Expressions (7) and (8). “Now” in Expressions (47) and (48) is the current point-in-time at the time of Operation S404 being executed.

Tstart=Now+Lstart−RTT/2 (47)

Tend=Now+Lend−RTT/2 (48)

Note that while RTT is subtracted in Expressions (7) and (8), RTT/2 is subtracted in Expressions (47) and (48). The reason for this difference will be apparent from FIG. 18, for example.

Specifically, in the event that the acquisition deadline Tstart is represented with the length of a period, the length of a heavy arrow is set as the acquisition deadline Tstart such as the value Ta in FIG. 18. On the other hand, in the event that the acquisition deadline Tstart is represented with absolute point-in-time, the acquisition deadline Tstart is equivalent to the position of the lower end of the heavy arrow in FIG. 18. Accordingly, as may be seen from FIG. 18, in the event that the acquisition deadline Tstart is represented with absolute point-in-time, the acquisition deadline Tstart is obtained by Expression (47).

Also, in Operation S505 in FIG. 16, the selecting unit 411 determines whether or not Expression (49) is satisfied instead of whether or not Expression (9) is satisfied. “Now” in Expressions (49) is the current point-in-time at the time of Operation S505 being executed.

Tstart+(Tend−Tstart)×(U−Qfrom)/(Qto−Qfrom+1)−α>Now (49)

in Operation S506 in FIG. 16, the selecting unit 411 calculates the maximum number V satisfying both of Expressions (50) and (29) instead of the maximum number V satisfying both of Expressions (28) and (29). “Now” in Expressions (50) is the current point-in-time at the time of Operation S506 being executed.

Now+α+(V−U+1)×pSize/B+β<Tend+(Tend−Tstart)×(Qto−V)/(Qto−Qfrom+1) (50)

Also, in Operation S514 in FIG. 17, the selecting unit 411 determines whether or not Expression (51) is satisfied instead of whether or not Expression (35) is satisfied. “Now” in Expressions (51) is the current point-in-time at the time of Operation S514 being executed.

Tstart+(Tend−Tstart)×(U−Qfrom)/(Qto−Qfrom+1)−Iself>Now (51)

in Operation S515, the selecting unit 411 then calculates the maximum number V satisfying both of Expressions (52) and (37) instead of the maximum number V satisfying both of Expressions (36) and (37). “Now” in Expressions (52) is the current point-in-time at the time of Operation S515 being executed.

Now+Iself+(V−U+1)×pSize/Bself<Tend+(Tend−Tstart)×(Qto−V)/(Qto−Qfrom+1) (52)

Also, in Operation S602 in FIG. 20, the selecting unit 411 obtains a group of child nodes where Expression (53) holds instead of a group of child nodes where Expression (10) holds. “Now” in Expressions (53) is the current point-in-time at the time of Operation S602 being executed.

Tstart−α>Now (53)

As described above, the dead lines specified in the retransmission request packet 801 or 802 may be expressed with the length of a period, or may be expressed with absolute point-in-time. In any way, in the event that the reception unit 401 which has received a retransmission request includes dead line information that specifies the constraint condition regarding the deadline, if the selecting unit 411 has selected the communication device 400 itself as a responsible node, the communication device 400 transmits data packets at timing satisfying the constraint condition.

For example, a pair of the acquisition deadline Tstart and completion deadline Tend specified in the retransmission request packet 801 are an example of deadline information that specifies the constraint condition. Also, the acquisition deadline Tstart and bit rate Breq specified in the retransmission request packet 802 are also an example of the deadline information.

Note that the acquisition deadline Tstart specified in the retransmission request packet 801 or 802 directly indicates the first one acquisition deadline of one or multiple data packets that the retransmission request packet 801 or 802 requests. However, the acquisition deadline Tstart specified in the retransmission request packet 801 or 802 indirectly specifies the constraint condition regarding the acquisition deadline of each of the second data packet and thereafter that the retransmission request packet 801 or 802 requests.

Incidentally, even in the event that the retransmission deadline is expressed with absolute point-in-time, Operation S508 in FIG. 16 and Operation S615 in FIG. 21 do not have to be modified. In other words, new deadline information that specifies a new constraint condition to be set to a new retransmission request addressed to a responsible child node is calculated in the same way regardless of the expression format of the retransmission deadline.

Specifically, the request generating unit 413 calculates new deadline information using at least deadline information included in the retransmission request received by the reception unit 401, and a delay period taken for communication between the communication device 400 and a responsible child node. An example of the deadline information included in the retransmission request received by the reception unit 401 is, for example, the acquisition deadline Tstart. Also, the delay period taken for communication between the communication device 400 and a responsible child node is specifically communication delay in (Q-2) included in the delay α. It goes without saying that the request generating unit 413 may calculate new deadline information further using internal delay or the like as the above embodiment.

A seventh viewpoint for modification relates to whether or not there is the management server 204. The retransmission control according to the above embodiment may be applied to not only a hybrid P2P system including the management server 204 in FIG. 3 but also a pure P2P system having no management server 204. With the pure P2P system, a new node which attempts to newly participate in the logical network may search a candidate of the parent node by flooding the participation request packet.

Alternatively, the new node may transmit the participation request packet to the distribution server 203. In the event of having received the participation request packet, an existing node within the logical network including the distribution server 203 may select any one of the child nodes, and transfer the participation request packet to the selected child node. Alternatively, an existing node which has received the participation request packet may inform this existing node itself to the new node as the parent node of the new node.

Also, the transmission destination of an inquiry packet for querying the retransmission request destination may be, with the hybrid P2P system, the management server 204 as described above, but in the case of the pure P2P system, may be the parent node. It goes without saying that, with the hybrid P2P system as well, the transmission destination of the inquiry packet may be the parent node.

For example, with the logical network 100 of the topology such as FIG. 2, the Node N₈ may query the parent Node N₃ of the retransmission destination. In order to prevent occurrence of excessive load in the network by transfer of an inquiry packet being excessively repeated, TTL (Time To Live) is set to the inquiry packet.

For example, let us say that the Node N₈ transmits an inquiry packet of which the value of the TTL is set to 4 to the parent Node N₃.

The node which has received the inquiry packet (hereafter, referred to as “reception node”) may inform the reception node itself to the Node N₈ as the retransmission request destination regardless of the value of the TTL. In the event that the value of the TTL is 2 or mode, the reception node may select any one of nodes other than the transmission source of the inquiry packet of the parent node and child nodes of the reception node as appropriate, decrement the value of the TTL by one, and transfer the inquiry packet to the selected node. In the event that the value of the TTL is 1, the reception node informs the reception node itself to the Node N₈ as the retransmission request destination.

Note that how to select the transfer destination of the inquiry packet may be optional. For example, random selection may be performed.

In response to this, in the event that the Node N₈ has set the value of the TLL to 4, and transmitted the inquiry packet to the parent Node N₃, the inquiry packet may be transferred to, for example, the Node N₃, Node N₁, Node N₂, and Node N₅ in order, and the Node N₅ may become the retransmission request destination of the Node N₈. Alternatively, the inquiry packet may be transferred to, for example, the Node N₃, Node N₆, and Node N₁₂ in order, and the Node N₁₂ may become the retransmission request destination of the Node N₈.

Also, with selection of the transfer destination of the inquiry packet, the parent node may be excluded from candidates of the transfer destination, or a child node may preferentially be selected over the parent node. Consequently, a probability that a node more distant from the root node will be selected as the retransmission request destination increases. As a result thereof, a probability that a node of which the load within the logical network is relatively low will actually perform retransmission processing further increases in connection with the above mechanism for leaving retransmission to an offspring node, and load distribution within the logical network further advances.

An eight viewpoint for modification relates to additional error processing. Though description has been omitted above, the communication device 400 which has received the retransmission request may not hold the requested data packet in the buffer unit 403. Therefore, the processing in FIGs. 16 through 17 and the processing in FIGS. 20 through 21 may be modified so as to return an error in the event that the requested data packet is not included in the buffer unit 403.

For example, an arrangement may be made wherein a node of which the distance from the root node is short as the Node N₂ in FIG. 2 detects packet loss, the retransmission request is transferred within the logical network 100 one after another, a node of which the distance form the root node is long as the Node N₁₃ receives the retransmission request. In this case, the Node N₁₃ may have not received the requested data packet yet at the time of receiving the retransmission request.

Alternatively, for example, let us say that the Node N₂ in FIG. 2 requests retransmission of data packets of which the sequence numbers are Nos. 310 to 320 from the Node N₃, the Node N₃ selects the Node N₈ as a responsible node, and also assigns Nos. 315 to 320 data packets to the Node N₈. In this case, a part or all of Nos. 315 to 320 data packets may happen to be eliminated at the Node N₈.

Therefore, in order to ensure retransmission in a sure manner, the processing in FIGS. 16 through 17 and the processing in FIGS. 20 through 21 may be modified as follows. Specifically, before Operation S501 and before Operation S601, the load distribution processing unit 410 may perform the following processing.

The load distribution processing unit 410 determines whether or not all of the data packets requested in the retransmission request packet 801 or 802 received by the reception unit 401 are held in the buffer unit 403 with reference to the buffer unit 403. If all of the requested data packets are held in the buffer unit 403, the load distribution processing unit 410 starts the processing in Operation S501 or S601 and thereafter. Conversely, if there is a data packet not held in the buffer unit 403 of the requested data packets, the load distribution processing unit 410 returns an error packet to the transmission destination node of the retransmission request packet 801 or 802.

A ninth viewpoint for modification relate to management of dynamic change of available bandwidths. In order to ensure retransmission in a sure manner, the nodes may inform change in the transmittable total bandwidth to the parent node in the event of having received the retransmission request from a node other than the parent node.

In other words, the nodes may inform change in the transmittable total bandwidth to the parent node when the available bandwidth is temporarily changed as a result of responding to the retransmission request from a node other than the parent node. According to this notification, even in a situation wherein a retransmission request frequently occurs within the logical network, processing regarding multiple retransmission requests occur simultaneously, suitable assignment may be performed.

For example, with the example in FIG. 1, independent from the retransmission request from the Node N₅, the Node N₁₀ may transmit the retransmission request to the node N₇ due to packet loss on the edge E_{4, 10}. The transmittable bandwidth of the Node N₇ may be narrower than the total bandwidth to be consumed due to retransmission to the Node N₅ and retransmission to the Node N₁₀.

Therefore, for example, in the event that the Node N₇ has received the retransmission request from the Node N₁₀ before Operation S31, the Node N₇ may inform that the transmittable total bandwidth is temporarily decreased due to retransmission to the Node N₁₀, to the parent Node N₃. Specifically, the Node N₇ may inform the period up to the end planned point-in-time of transmission to the Node N₁₀, and a total value of the bandwidths for a node belonging to a subgraph with the Node N₇ as the root node (specifically, only the Node N₇) consuming for transmission to the Node N₁₀, to the parent Node N₃.

Specifically, the Node N₇ may inform the maximum value of temporary use deadlines calculated in Operations S510 and S517, or the maximum value of temporary use deadlines calculated Operation S617 repeated |C| times to the parent Node N₃. Alternatively, the Node N₇ may inform the total of temporary use bandwidths calculated in Operations S510 and S517, or the total of temporary use bandwidths calculated Operation S617 repeated |C| times to the parent Node N₃.

The Node N₃ which has received the notification adds a pair of the temporary use bandwidth and temporary use deadline to the entry of the Node N₇ of the child node information. Specifically, the Node N₃ may set the bandwidth informed from the Node N₇ as the temporary use bandwidth. Also, the Node N₃ may add the period informed from the Node N₇ to the current point-in-time, subtract a half of the RTT between the Nodes N₇ and N₃ from the point-in-time obtained as the addition result, and set the subtraction result as the temporary use deadline.

In the event of having received the retransmission request in Operation S20, the Node N₃ may exclude the Node N₇ from responsible nodes. Alternatively, even when the Node N₃ selects the Node N₇ as a responsible node, the Node N₃ may also reduce the amount to be assigned to the Node N₇.

A tenth viewpoint for modification relates to a hardware configuration. The communication device 400 in FIG. 5 may be realized by the general purpose computer 300 which executes a program such as FIG. 4. However, a part or all of the communication device 400 may be realized by a dedicated hardware circuit such as an ASIC (Application Specific Integrated Circuit) or the like depending on embodiments.

An eleventh viewpoint for modification relates to the kind of IP address. With the above description, for simplification of description, a global address has been exemplified as an IP address. However, even in the event that private addresses have been set to the terminal devices 205A through 205L, a data distribution system for performing the same retransmission control as with the above may be realized by employing a suitable NAT traversal (Network Address Translation traversal) technique.

Depending on the logical network, load caused due to some sort of processing is relatively apt to increase at a first node within the logical network, and is relatively apt to decrease at one or more second nodes which are offspring nodes of the first node. Under a situation wherein a greater load is placed on the first node as compared to the one or more second nodes, a certain request node may request transmission of particular information from the first node.

However, if the nodes within the logical network execute the above program, load due to transmission of the particular information is assigned so as to cancel out existing load bias. Accordingly, suitable load distribution within the logical network is realized.

Specifically, in the event that the first node has received a first request for requesting transmission of the particular information, the first node which is a computer for executing the above program selects a responsible node by prioritizing child nodes over the first node itself. The nodes within the logical network execute the above program, and accordingly, a child node of the first node preferentially takes on actual transmission of the particular information to the request node as compared to the first node, and an offspring node of the first node preferentially takes on actual transmission of the particular information to the request node as compared to child nodes of the first node.

As a result thereof, load due to transmission of the particular information is preferentially applied to an offspring node of which the load due to other processing is relatively apt to decrease as compared to an ancestor node of which the load due to other processing is relatively apt to increase. That is to say, according to the above program, deterioration in load bias may be avoided, and suitable load distribution at the entire logical network is realized.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable medium storing a program causing a computer to execute a process, the program comprising:
receiving a first request for requesting transmission of particular information from a request node belonging to a logical network to which the computer belongs, directly without depending on the topology of the logical network, or through one or more other nodes on a path that comes into a node equivalent to the computer in the topology of the logical network;
selecting one or more responsible nodes relating to transmission of the particular information by prioritizing out of one or more child nodes logically connected to the computer by an edge that comes out from the node equivalent to the computer in the topology of the logical network, and the computer, the one or more child nodes over the computer;
correlating partial particular information that is a portion or all portions of the particular information with each of the responsible nodes;
transmitting, in the event that the computer has been selected as the responsible node, the partial particular information correlated with the computer to the request node; and
transmitting, in the event that there is a responsible child node selected as the responsible node of the one or more child nodes, a second request for requesting transmission of the partial particular information correlated with the responsible child node to the request node, to the responsible child node.

2. The computer-readable recording medium according to claim 1, wherein processing for correlating the partial particular information with each of the responsible nodes is, in the event that there is the one or more responsible child nodes, regarding each of the responsible child nodes,
to reference available total resource information indicating the total amount of available resources of a node included in a subgraph with this responsible child node as the root node in the topology of the logical network, and
to correlate, of the particular information, a transmittable portion of resources equal to or smaller than the amount that the available total resource information indicates with this responsible child node.

3. The computer-readable recording medium according to claim 2, wherein the processing that the program causing the computer to execute is, regarding each of child nodes,
to receive total resource information indicating the total amount of resources of anode included in a subgraph with this child node as the root node in the topology of the logical network, from this child node, to store the received total resource information in a manner correlated with this child node,
to calculate total of the amount of resources of the computer, and the total amount that the total resource information received from each of the child nodes and stored indicates,
to transmit new total resource information indicating the calculated total to the parent node of the node equivalent to the computer in the topology of the logical network, and
to obtain, in the event that there is the one or more responsible child nodes, regarding each of the responsible child nodes, the available total resource information from the total resource information stored in a manner correlated with this responsible child node.

4. The computer-readable recording medium according to claim 2, wherein processing for selecting the one or more responsible nodes is,
to select, in the event that there is the one or more child nodes, regardless of the amount of resources of the computer, the one or more child nodes as the one or more responsible nodes by prioritizing the one or more child nodes over the computer, and
to select, in the event that there is no the one or more child nodes, the computer as the one or more responsible nodes.

5. The computer-readable recording medium according to claim 3, in the event that there is the responsible child node, the program causing the computer to execute the process, further comprising:
storing consumption resource information indicating the amount of resources to be consumed according to load placed on transmission of the partial particular information correlated with the responsible child node in a manner correlated with the responsible child node and valid deadline;
wherein, in the event that there is the one or more responsible child nodes, processing for correlating the partial particular information with each of the responsible nodes is, regarding each of the responsible child nodes,
to obtain the available total resource information regarding this responsible child node by subtracting the amount that the consumption resource information stored in a manner correlated with this responsible child node indicates from the total amount that the total resource information received from this responsible child node indicates in the event that there is the consumption resource information stored in a manner correlated with this responsible child node, of which the correlated valid deadline has not been expired yet, and
to obtain the total resource information received from this responsible child node as the available total resource information regarding this responsible child node in the event that there is no the consumption resource information stored in a manner correlated with this responsible child node, of which the correlated valid deadline has not been expired yet.

6. The computer-readable recording medium according to claim 1, wherein the first request includes first deadline information for specifying a first constraint condition regarding a deadline:
and wherein processing for transmitting the partial particular information correlated with the computer to the request node in the event that the computer has been selected as the responsible node is performed at timing satisfying the first constraint condition;
and wherein, in the event that there is the responsible child node, the processing that the program causes the computer to execute is further
to calculate a second constraint condition regarding a deadline using communication time used for communication between this responsible child node and the computer, and the first constraint condition, and
to include second deadline information for specifying the second constraint condition in the second request to be transmitted to this responsible child node.

7. The computer-readable recording medium according to claim 6, wherein the first deadline information includes a first value regarding a deadline for start of transmission, and a second value regarding a deadline for end of transmission;
and wherein the second deadline information includes a third value regarding a deadline for start of transmission, and a fourth value regarding a deadline for end of transmission;
and wherein processing for transmitting the partial particular information correlated with the computer to the request node in the event that the computer has been selected as the responsible node includes to control transmission timing based on the first value and the second value;
and wherein, with processing for calculating the second constraint condition according to each of individual responsible child nodes, the communication time and which portion of the particular information is correlated with this individual responsible child node as the partial particular information is used for calculation of the third value and the fourth value.

8. The computer-readable recording medium according to claim 6, wherein processing for selecting the one or more responsible nodes includes to narrow down candidates of the responsible nodes out of the one or more child nodes in accordance with the first constraint condition.

9. The computer-readable recording medium according to claim 1, wherein the first request includes first bit rate information for specifying a first bit rate;
and wherein the processing that the program causes the computer to execute is to assign at least a portion of a first bit rate to each of the responsible nodes;
and wherein processing for transmitting the partial particular information correlated with the computer to the request node in the event that the computer has been selected as the responsible node is performed with a bit rate assigned to the computer;
and wherein, in the event that there is the responsible child node, the processing that the program causes the computer to execute includes second bit rate information indicating a second bit rate assigned to this responsible child node in the second request to be transmitted to this responsible child node.

10. The computer-readable recording medium according to claim 1, wherein the particular information is, of distribution information to be distributed within the logical network, a portion that has not been able to be received at the request node owing to loss at the edge from the parent node of the request node to the request node.

11. A communication device comprising:
reception means configured to receive a first request for requesting transmission of particular information from a request node belonging to a logical network to which the communication device belongs, directly without depending on the topology of the logical network, or through one or more other nodes on a path that comes into a node equivalent to the communication device in the topology of the logical network;
selection means configured to select one or more responsible nodes relating to transmission of the particular information by prioritizing out of one or more child nodes logically connected to the communication device by an edge that comes out from the node equivalent to the communication device in the topology of the logical network, and the communication device, the one or more child nodes over the communication device;
correlation means configured to correlate partial particular information that is a portion or all portions of the particular information with each of the responsible nodes;
transmission means configured to transmit, in the event that the communication device has been selected by the selecting means as the responsible node, the partial particular information correlated with the communication device to the request node, and in the event that there is a responsible child node selected by the selection means as the responsible node of the one or more child nodes, to transmit a second request for requesting transmission of the partial particular information correlated with the responsible child node to the request node, to the responsible child node.

12. The communication device according to claim 11, wherein the correlation means are configured, in the event that there is the one or more responsible child nodes, regarding each of the responsible child nodes,
to reference available total resource information indicating the total amount of available resources of a node included in a subgraph with this responsible child node as the root node in the topology of the logical network, and
to correlate, of the particular information, a transmittable portion of resources equal to or smaller than the amount that the available total resource information indicates with this responsible child node.

13. The communication device according to claim 12, wherein the selection means select the one or more child nodes as the one or more responsible nodes by prioritizing over the communication device regardless of the amount of resources of the communication device, and
select, in the event that there is no the one or more child nodes, the communication device as the one or more responsible nodes.

14. The communication device according to claim 12, wherein the selection means narrow down candidates of the responsible nodes out of the one or more child nodes in accordance with the first constraint condition.

15. A method that a communication device executes, comprising:
receiving a first request for requesting transmission of particular information from a request node belonging to a logical network to which the communication device belongs, directly without depending on the topology of the logical network, or through one or more other nodes on a path that comes into a node equivalent to the communication device in the topology of the logical network;
selecting, by a processor, one or more responsible nodes relating to transmission of the particular information by prioritizing out of one or more child nodes logically connected to the communication device by an edge that comes out from the node equivalent to the communication device in the topology of the logical network, and the communication device, the one or more child nodes over the communication device;
correlating partial particular information that is a portion or all portions of the particular information with each of the responsible nodes;
transmitting, in the event that the communication device has been selected as the responsible node, the partial particular information correlated with the communication device to the request node; and
transmitting, in the event that there is a responsible child node selected as the responsible node of the one or more child nodes, a second request for requesting transmission of the partial particular information correlated with the responsible child node to the request node, to the responsible child node.
